(19) United States
(12) Patent Application Publication
(10) Pub. No.: US 2015/0309073 A1
(43) Pub. Date: Oct. 29, 2015

(54) MULTIFUNCTIONAL GRAPHENE COATED SCANNING TIPS

(71) Applicant: NORTHWESTERN UNIVERSITY, Evanston (IL)

(72) Inventors: Chad A. Mirkin, Wilmette, IL (US); Wooyoung Shim, Skokie, IL (US); Keith A. Brown, Evanston, IL (US); Boris Rasin, Evanston, IL (US); Xing Liao, Evanston, IL (US); Xiaozhu Zhou, Evanston, IL (US)

(73) Assignee: NORTHWESTERN UNIVERSITY, Evanston, IL (US)

(21) Appl. No.: 14/414,042

(22) PCT Filed: Jul. 12, 2013
(86) PCT No.: PCT/US2013/050195

§ 371 Date: Jan. 9, 2015

Related U.S. Application Data
(60) Provisional application No. 61/671,653, filed on Jul. 13, 2012.

(51) Int. Cl. G01Q 70/06; G01Q 70/16; G01Q 80/00; G01Q 70/14

(52) U.S. Cl. CPC G01Q 70/06; G01Q 70/14; G01Q 70/16; G01Q 80/00

(57) ABSTRACT

A coat micro tip can include a tip having a base and an oppositely disposed tip end having a radius of curvature of less than 1 μm and a graphene film conformally coated on the tip. A method of making a graphene coated tip can include immersing a tip in a fluid comprising a graphene film floating on a surface of the fluid over the tip, disposing the immersed tip at an angle relative to the graphene film floating on the surface of the fluid as measured from a plane parallel to the base of the tip, and coating the tip with the graphene film by gradually bringing the graphene film into contact with the tip while maintaining the relative angle between the floating portion of the film and the tip during coating

### CROSS-REFERENCE TO RELATED APPLICATION

The benefit under 35 U.S.C. §119(e) of U.S. Provisional Patent Application No. 61/671,653 filed Jul. 13, 2012 is hereby claimed and the disclosure is incorporated herein by reference in its entirety.

### STATEMENT OF GOVERNMENT SUPPORT

This invention was made with government support under Grant No. N66001-08-1-2044 awarded by the Department of Defense (DARPA), Grant No. FA 2386-10-1-4065 awarded by the Air Force Office of Scientific Research (AFOSR), Grant No. DMB-1124131 awarded by the National Science Foundation (NSF), Grant No. FA9550-12-1-0280 awarded by the Air Force Office of Scientific Research (AFOSR), Grant No. FA 9550-12-1-0141 awarded by the Air Force Office of Scientific Research, Grant No. DBI-1152139 awarded by the National Science Foundation (NSF), Grant No. U54CA151880 awarded by the National Institutes for Health, Grant No. N00244-09-1-0012 awarded by the Department of Defense (NSSEFF), and Grant No. N00244-09-1-0071 awarded by the Department of Defense (NSSEFF). The government has certain rights in the invention.

### BACKGROUND

1. Field of the Disclosure

This disclosure is directed to graphene coated tips and tip arrays, methods of making the same, and methods of patterning using the same.

2. Brief Description of Related Technology

Over the past two decades, scanning probe instruments have expanded beyond their traditional role as imaging or “reading” tools and are now routinely used for “writing.” Although a variety of scanning probe lithography (SPL) techniques are available, each one imposes different requirements on the type of probes that must be used. For example, dip-pen nanolithography (DPN) requires tips with controlled hydrophobicity (1-3), anodic oxidation requires electrically conductive tips (4, 5), mechanical scratching or nanographting requires rigid wear-resistant tips (6-8), and thermal scanning probe lithography requires tips with integrated heaters (9, 10). Additionally, throughput is a major concern for serial writing techniques. Thus, there is a need in the art for scanning probe lithography techniques with a reasonable path towards a scalable architecture.

Understanding the tradeoffs inherent in utilizing specialized SPL probes is important especially when considering high throughput SPL techniques. A challenge common to all SPL techniques is to pattern with high throughput despite the serial nature of probe-based lithography. This has been addressed by the development of specialized systems, for example, one- and two-dimensional cantilever arrays (11, 12). The recent developments of cantilever-free arrays provides a low cost alternative to cantilever arrays for parallel SPL (13, 14). For example, hard-tip soft-spring lithography (HSL) (also referred to as silicon pen), polymer pen lithography, and gel pen lithography techniques can be used to pattern sub-50 nm features over centimeter scales (15) by utilizing an array of polymer or silicon tips resting on a compliant layer, for example polydimethylsiloxane (PDMS). These arrays are well suited for printing organic and inorganic structures in a high throughput and combinatorial fashion, but the versatility of these arrays is limited by the low electrical and thermal conductivities of the compliant layer such as PDMS. There is a need in the art for the adaptation of the cantilever-free architecture to additional SPL modalities.

Considerable research has focused on improving the capabilities of conventional SPL tips through thin-film coating, but these modifications can blunt the tips significantly (16). Furthermore, metal coatings that are conventionally used to improve the electrical conductivity of tips (17) are opaque and susceptible to tip wear, while wear-resistant coatings such as diamond are electrically insulating (16).

Recently, metal-coated probes have been used for the catalytic growth of graphene for applications in molecular electronics (19), but this technique requires a thick metal coating on the probes prior to application of the graphene. Additionally, this technique requires annealing at 950° C., which would be detrimental for polymer-based tip arrays. Further, the technique does not result in uniform probe coating and, thus, does not result in a conformal coating of the tips.

### SUMMARY

In accordance with one embodiment of the disclosure, provided is a tip and/or tip array coated with multilayer graphene to generate tips that are highly wear resistant and electrically and thermally conducting. The graphene coating can be applied such that optical transparency of a tip and tip array can be preserved. Additionally, the sharpness of the tips is substantially preserved after coating with the graphene. Graphene has high electrical and thermal conductivities, optical transparency, low friction, and mechanical strength. Tip arrays having such graphene coatings can similarly demonstrate such advantageous properties.

In accordance with an embodiment of the disclosure, a coated micro tip comprises a micro tip having a base and an oppositely disposed tip end. The tip end has a radius of curvature of less than about 1 μm. The coated micro tip further includes a graphene film coated on the tip. In various embodiments, the graphene film conformally coats the tip.

In accordance with a further embodiment of the disclosure, the coated micro tip is disposed on a micro cantilever arm.

In accordance with another embodiment of the disclosure, a tip array micro probe includes a tip substrate layer having first surface and an oppositely disposed second surface, the tip substrate layer comprising an elastomer. A plurality of coated micro tips according to embodiments of the disclosure are fixed to the first surface, the tips each comprising a tip end disposed opposite the first surface. The tip array micro probe further includes a graphene film coated on the tips and the first surface.

The tip array micro probe can further include a radiation blocking layer comprising a radiation opaque material disposed on the tips. The radiation blocking layer can be disposed on the tips and the graphene film can be disposed on the radiation blocking layer. Alternatively, the radiation blocking layer can be disposed on the graphene film. In either embodiment, the blocking layer includes an aperture defined at the tip end.

In accordance with yet another embodiment of the disclosure, a method of electrochemically patterning using a coated tip or micro probe having a coated tip can include applying a voltage across the graphene coating and contacting an electrochemically sensitive substrate with the tip to electrochemically desorb the contacted portion of the electrochemically sensitive substrate.

In accordance with another embodiment of the disclosure, a method of thermal patterning using a coated tip or micro probe having a coated tip can include applying an electrical current across the graphene coating to resistively heat the tip and thereby heat a patterning composition disposed on the at least on tip. The method further includes contacting a substrate with the heated tip to apply the patterning composition to the substrate.

In accordance with an embodiment of the disclosure, a method of making a graphene coated tip or micro probe comprising a coated tip includes immersing one or more tips of a tip or micro probe in a fluid comprising a graphene film floating on a surface of the fluid over the one or more tips, disposing the immersed tips at an angle of at least 10° relative to the graphene film floating on the surface of the fluid as measured from a plane parallel to the base of the tip, and coating the one or more tips with the graphene film by gradually bringing the graphene film into contact with the one or more tips while maintaining the relative angle between the floating portion of the film and the one or more tips during coating.

In a further embodiment, the fluid is evaporated to gradually lower the graphene film onto the one or more tips.

In any of the preceding embodiments, the graphene film can be chemically modified and can include multiple layers.

In any of the preceding embodiments, the micro probe comprising the coated tip can be a cantilever-based micro probe, such as a dip pen nanolithography micro probe, or a cantilever-free micro probe, such as a polymer pen micro probe, a gel pen micro probe, a beam pen micro probe, and a hard tip spring lithography micro probe.

### BRIEF DESCRIPTION OF THE DRAWING FIGURES

FIG. 1A is a schematic illustration of a Polymer Pen Lithography set up;

FIG. 1B is a photograph of a 11 million pen array;

FIG. 1C is a scanning electron microscopy (SEM) image of the polymer pen array of FIG. 1B;

FIG. 2 is a schematic illustration of a polymer pen array fabrication;

FIG. 3 is a graph illustrating feature size as a function of relative z-piezo extension, demonstrating the pressure dependence of feature size when patterning with polymer pen or gel pen or beam pen lithography;

FIG. 4 is a schematic illustration of a beam pen array and a beam pen lithography method;

FIG. 5 is an SEM image of a beam pen tip array, with the inset showing an aperture formed in a tip end;

FIGS. 6A and 6B are schematic illustrations of methods of making a beam pen tip array;

FIG. 7A is a schematic illustration of a hard tip spring lithography tip array;

FIG. 7B is a schematic illustration of a method of making a hard tip spring lithography tip array;

FIG. 8A is an SEM image of Si pen array after KOH etching (40 wt %, 75° C. for 65 min) with isopropyl alcohol, Si substrate attached directly to PDMS without SiO₂ passivation layer resulted in Si pens falling from PDMS surface during etching; the welling of PDMS in solution at relatively high temperatures may cause the interfacial stress that weakens the adhesion of Si to PDMS; employing a SiO₂ passivation layer was found to significantly improve the stability of Si pen on a surface during etching;

FIG. 8B-8D show magnified images of different regions of 8A;

FIG. 8E-8i show fabricated Si pen arrays on SiO₂/PDMS/glass: e, Si wafer (2×2 cm) on a cured PDMS surface on a glass slide before etching and f, an actual pen array after etching in KOH. g, a SEM image of the Si pen array on SiO₂/PDMS/glass with 160 μm in pitch that are uniform with bottom width 30±0.6 μm corresponding to about 47±0.9 μm in pen height; the pen height may vary up to 10% in optimized condition, since the original wafer itself used as a starting material in this experiment has a variation of 10% in thickness; the inset shows the array in a large area that shows the homogeneity of the pens; h, (311) planes were introduced during the wet etching with <110> oriented masks on a (100) Si surface. The measured surface intersection angles, α₁ and α₂, as defined in this figure were 126.9° and 143.1° that correspond to the tip defining planes of (311); rotation of the intersection of planes to <100>, φ, was 18.4°, and also showed that the tip plane is (311); i, the tip radius of curvature was 22±3 nm.

FIGS. 9A and 9B are schematic illustrations of a hard tip spring lithography tip array coated with a graphene film in accordance with embodiments of the disclosure herein;

FIG. 10A is a schematic illustration of a method of coating a graphene film on a tip array;

FIG. 10B is photographs of the method of FIG. 10A, illustrating (left photograph) PMMA/graphene film floating on water before coating, and (right photograph) submersion of the tip array in the fluid at an angle to coat the tips with the PMMA/graphene film;

FIG. 10C is a photograph of PMMA/graphene separated from the Ni substrate by removing the Ni layer in an aqueous 1 M FeCl₃ solution;

FIGS. 11A and 11B are images demonstrating the transparency of a graphene coated tip array as compared to an uncoated tip array. In FIG. 11A, the underlying image of the Chicago skyline is visible through both the uncoated and coated tip arrays and in FIG. 11B the image of the Northwestern University logo remains visible under both the uncoated and the coated tip arrays;

FIG. 12 is a schematic image illustrating tiling of the tip in a fluid in accordance with an embodiment of the disclosure;

FIGS. 13A and 13B are images illustrating the tenting phenomenon and the effective elimination of tenting using a fluid having a reduced surface tension;

FIGS. 14A and 14B are modeling of graphene sagging using a beam bending model;

FIG. 15A is an SEM image of an HSL tip array before graphene coating;

FIG. 15B is an SEM image of the HSL tip array of FIG. 15A after graphene/PMMA coating;

FIG. 15C is an SEM image of the HSL tip array of FIG. 15B after removal of the PMMA; 20 μm

FIG. 15D is a top view optical image of graphene folds between tips before and after removal of the PMMA. After PMMA was removed, the existence of graphene folds was confirmed by a topographical image taken by atomic force microscopy;

FIG. 15E is a Raman mapping image of the SiO band (400 to 546 cm⁻¹, top) and the graphene G-band (1569 to 1614 cm⁻¹, bottom). The overlap of these maps confirms coverage of the silicon tip with graphene;

FIG. 15F is a Raman spectra (excitation wavelength λ=532 nm) for graphene layers on a Si tip shown in FIG. 15E;

FIG. 16A is a schematic diagram of an LED circuit used to test the electrical properties of a graphene coated tip;

FIG. 16B is optical image of non-contact and contact of the tip with a highly doped Si surface and corresponding LED operation;

FIG. 16C is the electrical response of the tip-surface circuit of FIG. 16A;

FIG. 17 is an atomic force microscopy (AFM) topographical image of a multilayer graphene (10-20 layers) and bare Si surface;

FIG. 18A is an optical image of a graphene-coated HSL array that has been electrically contacted on two sides of the array;

FIG. 18B is a schematic illustration of the selective electrochemical desorption of 16-mercaptohexadecanoic acid (MHA) features by coming into contact with a surface while maintaining a voltage bias with respect to a surface using a graphene-coated tip array followed by Au removal by wet etching;

FIG. 18C is an SEM image of a pattern of etched Au holes of different sizes created by varying the bias voltage from −7 to −18 V while patterning spots for 10 s using a graphene-coated tip array;

FIG. 18D is an SEM image of a pattern of etched AU holes with a contact time of 5 s and at a reductive potential of −5 V using a graphene-coated tip array;

FIG. 18E is an SEM image of large-scale arbitrary Au hole patterns, arrays of a cluster of constellations in the northern hemisphere including Draco, Orion, Ursa Major, written with a bias voltage of −10V, a contact time of 10 s, and a relative humidity of 30% using a graphene-coated tip array; the right image shows a magnified image of pattern written by a single probe with guide lines depicting the constellations; the inset shows a magnified SEM image of a highlighted area (dotted circle);

FIG. 19 is a graph of feature diameter variation as a function of the reduction potential using a graphene-coated tip array;

FIG. 20A is a large scale SEM image of Au holes written at a bias voltage of −10 V with a contact time of 10 s and a humidity of 30% using a graphene-coated tip array;

FIG. 20B is a magnified portion of FIG. 20A;

FIG. 21A is a schematic illustration of the selective deposition of photoresist by resistive heating a graphene-coated HSL tip array followed by SiO₂ removal by wet etching;

FIG. 21B is a schematic illustration of the heated tip array used in FIG. 19A;

FIG. 21C is a dark filed optical image of square arrays of photoresist dots patterned on an SiO₂/Si surface created by heating the graphene-coated tip array with 15 mW; The bottom image is an SEM image of a dot array;

FIG. 21D is a dark field optical image of a 100×100 μm² patterned dot pattern consisting of 1,088 dots corresponding to a section of the star field; these patterns were generated with an applied power of 23 mW, a dwell time of 1 s and patterning at 30% RH using a graphene-coated tip array; the inset shows a magnified dark field optical image compared to a section of the source pattern (top right) and the topological AFM image at the same area (bottom right);

FIG. 22 is a graph of the electrical resistance variation of a graphene-coated HSL tip array as a function of (A) applied power and (B) temperature; the graphene resistor is Ohmic and its resistance decreases with increasing temperature, which corresponds to negative TCR; additionally, the resistance of the graphene-coated HSL tip array decreases as the power applied increases, as expected for resistive self-heating;

FIG. 23 is a dot matrix map of constellations consisting of 1,088 dots formed by thermal deposition;

FIG. 24 is a low-magnification SEM image of (A) a bare Si tip and cantilever and (B) a graphene-coated Si tip and cantilever;

FIG. 25A is a lateral force and topography (middle section) graph measured for an uncoated Si tip (top graph) and a Si tip coated in graphene (bottom graph), as the tip is scanned across a Si surface consisting of a flat (100) and two sloped (111) facets;

FIG. 25B and FIG. 25C are the lateral force measurements of an uncoated Si tip (B) and a graphene coated Si tip (C) under an applied load increase from about 100 nN to about 300 nN;

FIGS. 25D and 25E are SEM images of an uncoated Si tip (D) and a graphene-coated Si tip (E) under the same loading conditions as in FIGS. 25B and 25C after 500 μm of scanning in contact on a Si surface with an applied load of 50 nN; the insets show the tips as imaged before the wear experiments at the same scale; and

FIG. 26 is a graph of the coefficient of friction for Si tips and few layer graphene-coated Si tips measured by the wedge calibration method.

### DETAILED DESCRIPTION

Disclosed herein are micro probes having at least one tip coated with a graphene film and methods of coating micro probes with graphene. The micro probes generally include at least one tip having a radius of curvature of less than 1 μm. A variety of micro probes having such tips are known in the art and can be suitable used in the coated micro probes and coated by the methods disclosed herein. The graphene coating can advantageously allow a variety of types of tip arrays to be multifunctional and impart improved wear resistance to the tips. For example, the micro probe can be a cantilever-based micro probe, such as a dip-pen nanolithography micro probe. The micro probe can be a cantilever-free micro probe, such as polymer pen tip array, a gel pen tip array, a beam pen tip array, or a silicon pen tip array.

The graphene coating imparts electrically conductive characteristics to the micro probes, which can advantageously allow the micro probes to perform electrochemical desportion and thermal-based patterning methods. Thus, the graphene-coated micro probes in accordance with embodiments of the disclosure can be multifunctional, allowing for patterning in a direct-write mode in which an ink is applied to the substrate, thermal depositions, and electrochemical desportion. In one embodiment, the graphene-coated micro probes are graphene-coated beam pen micro probes and can additionally be used for photolithography to pattern a photosensitive substrate. Due to the insulating characteristics of the polymer backing layer of conventional cantilever-free tip arrays, such tip arrays could not conventionally perform electrochemical desorption and thermal-based patterning methods. Furthermore, such multifunctionality can be more simply imparted to a wide range of micro probe devices without the need for difficult and costly manufacturing techniques conventionally used to integrate electrical contacts and resistive heaters into micro probes.

The graphene coating disclosed herein can also reduce tip-substrate friction, which can substantially decrease wear on the tip. For example, as compared to tip-substrate friction between a silicon tip and a substrate, a graphene coated silicon tip demonstrated a 40% reduction in the tip-substrate friction.

As noted above, the uncoated tips can be associated with a variety of probes-types, including both cantilever and cantilever-free systems. In general, micro probes include at least one tip having a base and an oppositely disposed tip end having a radius of curvature of less than 1 μm. Cantilever-based micro probes typically include a tip disposed on a micro cantilever. In such probes, the base of the tip is generally disposed on the cantilever arm. Such micro probes are described in U.S. Pat. No. 6,635,311, the disclosure of which is incorporated herein by reference in its entirety. Cantilever-free systems include, for example, polymer pen tip arrays, gel pen tip arrays, silicon pen tip arrays, and beam pen tip arrays. In such probes, the bases of the tips are generally disposed on a common tip substrate layer. These uncoated tip arrays will be described in detail below. Description of these tip arrays can also be found in U.S. Patent Application Publication Nos. 2011/0305996, 2011/0165341, 2011/0132220, and 2012/0305996, the respective disclosures of which are each incorporated herein by reference.

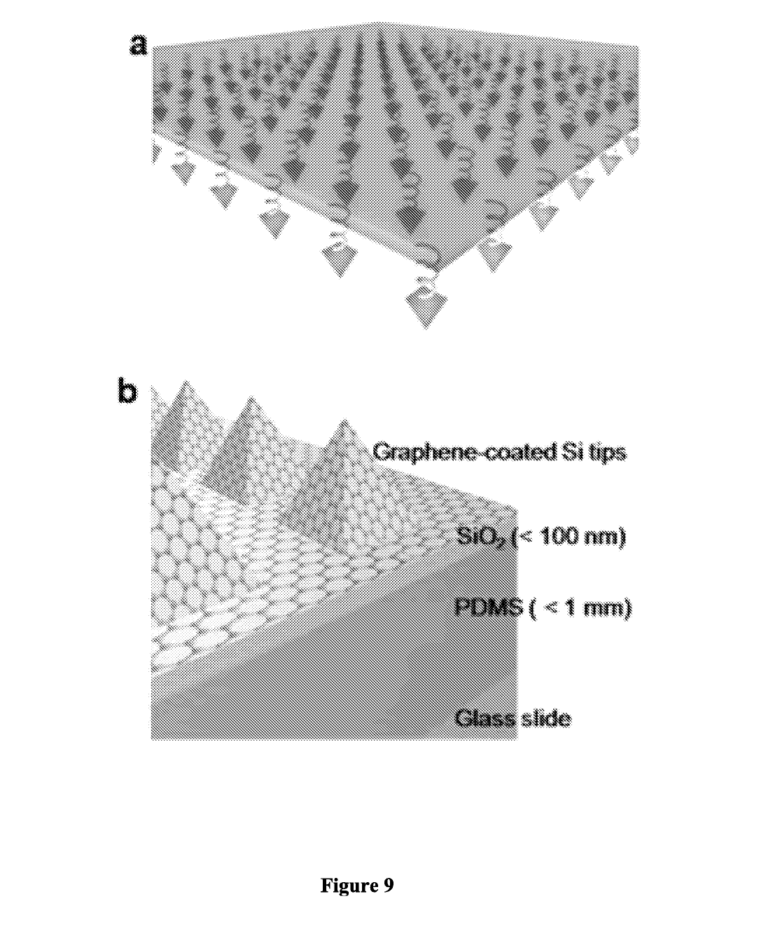

Micro probes in accordance with embodiments of the disclosure include at least one tip having a graphene film coated on the at least one tip. In some embodiments, each tip of the micro probe can be coated with the graphene film. For example, FIG. 9 illustrates a hard tip spring lithography tip array having a graphene film coating on each of the tips. Advantageously, the methods of coating the tips in accordance with embodiments of the disclosure can result in a conformal coating of the tips with the graphene. The graphene film can have a thickness, for example, in a range of about 1 nm to about 500 nm, about 10 nm to about 400 nm, about 50 nm to about 300 nm, about 70 nm to about 250 nm, about 100 nm to about 500 nm, about 200 nm to about 400 nm, about 2 nm to about 18 nm, about 4 nm to about 16 nm, about 6 nm to about 14 nm, about 8 nm to about 12 nm, or about 8 nm to about 10 nm. Other suitable film thicknesses include, for example, about 1, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, 100, 150, 200, 250, 300, 350, 400, 450, or 500 nm. The graphene film can include any suitable number of layers, for example in a range of about 1 to about 500 layers, about 100 to about 500 layers, about 150 to about 500 layers, about 250 to about 500 layers, about 1 to about 400 layers, about 20 to about 300 layers, about 50 to about 200 layers, about 10 to about 90 layers, about 20 to about 80 layers, about 30 to about 70 layers, about 40 to about 60 layers, or about 10 to about 20 layers. Other suitable numbers of layers include, for example, about 1, 2, 3, 4, 5 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, 100, 150, 200, 250, 300, 350, 400, 450, or 500 layers. The diameter of a tip coated with the graphene film can be increase relative to the diameter of the tip prior to coating. This increase is generally commensurate with the thickness of the applied graphene coating.

### Cantilever-Based Micro Probes

Cantilever-based tip devices generally include a micro cantilever arm having at least one tip disposed thereon. In some embodiments, the micro probe includes a single tip disposed on a micro cantilever arm. In other embodiments, the micro probe includes two or more tips disposed on a single micro cantilever arm. In yet other embodiments, the micro probe can include an array of cantilevers, each cantilever having at least one tip.

The tips are generally scanning probe microscope (SPM) tips. As used herein, the phrases “scanning probe microscope tip” and “SPM tip” refer to tips used in atomic scale imaging, including atomic force microscope (AFM) tips, near field scanning optical microscope (NSOM) tips, scanning tunneling microscope (STM) tips, and devices having similar properties. Any AFM tip can be used. Suitable AFM tips include those that are available commercially from, e.g., Park Scientific, Digital Instruments and Molecular Imaging. Also suitable for use as the tip are NSOM tips. These tips are hollow, and the patterning compounds accumulate in the hollows of the NSOM tips which serve as reservoirs of the patterning compound to produce a type of “fountain pen” for use in DPN. Suitable NSOM tips are available from Nanonics Ltd. and Topometrix.

### Polymer Pen and Gel Pen Tip Arrays

Polymer Pen Lithography is a direct-write method that delivers collections of molecules in a positive printing mode. Polymer Pen Lithography utilizes elastomeric tips without cantilevers as the ink delivery tool. The tips are preferably made of polydimethylsiloxane, PDMS or agarose gel. As used herein, “Gel Polymer Pen Lithography” and “Gel Pen Lithography” refer to Polymer Pen Lithography utilizing elastomeric gel polymer tips. Reference to Polymer Pen Lithography or polymer pen tip arrays herein should be understood to include Gel Pen Lithography and Gel Pen tip arrays. As used herein, references to polymers, polymer pens, and polymer pen arrays include gel polymer types, unless indicated otherwise in context.

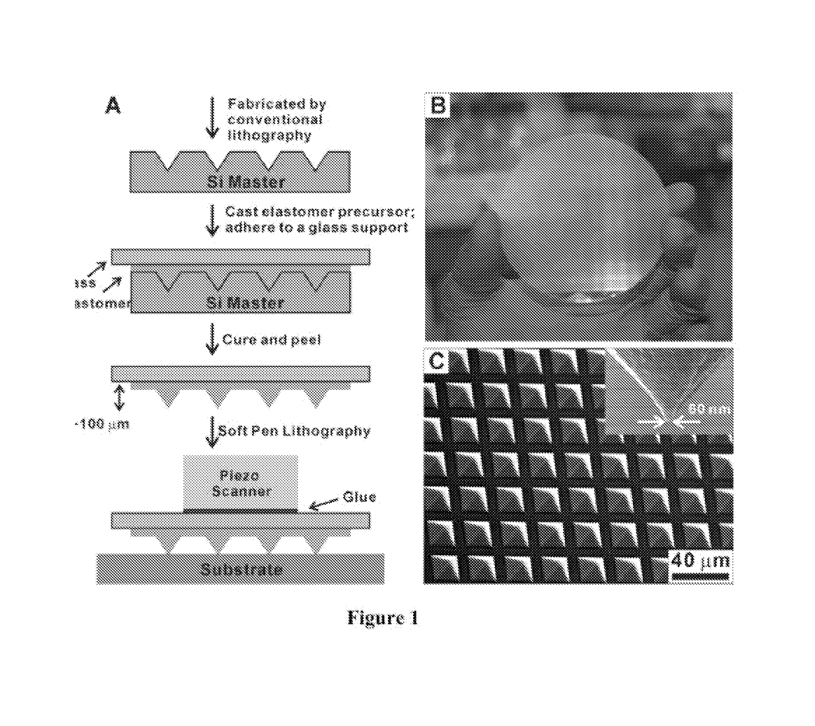

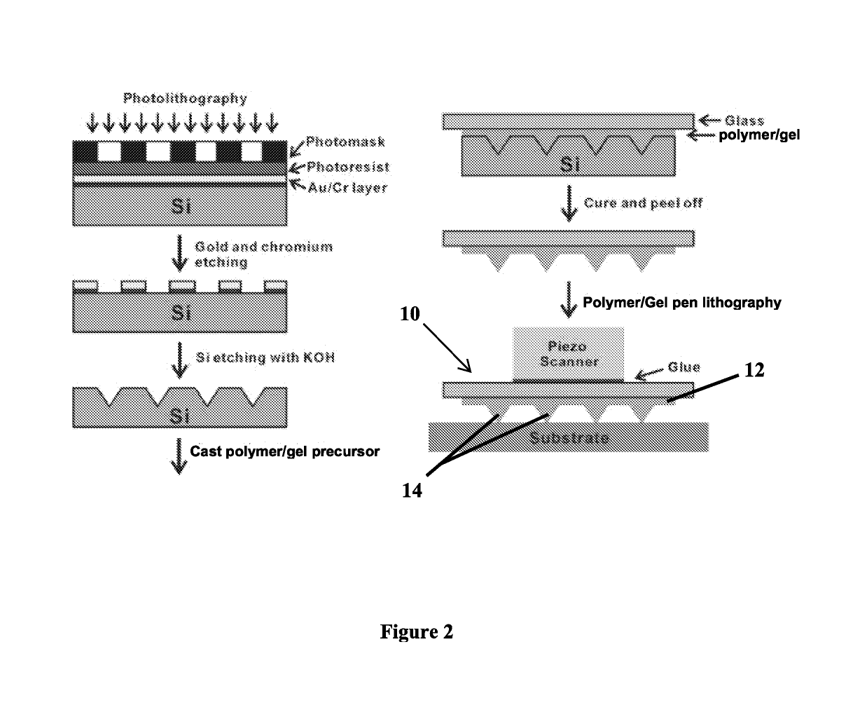

A preferred polymer pen array (FIG. 1) contains thousands of tips, preferably having a pyramidal shape, which can be made with a master prepared by conventional photolithography and subsequent wet chemical etching (FIGS. 1A and 2). The tips preferably are connected by a common substrate which includes a thin polymer backing layer (50-100 μm thick), which preferably is adhered to a rigid support (e.g., a glass, silicon, quartz, ceramic, polymer, or any combination thereof), e.g. prior to or via curing of the polymer. The rigid support is preferably highly rigid and has a highly planar surface upon which to mount the array (e.g., silica glass, quartz, and the like). The rigid support and thin backing layer significantly improve the uniformity of the polymer pen array over large areas, such as three inch wafer surface (FIG. 1B), and make possible the leveling and uniform, controlled use of the array. When the sharp tips of the polymer pens are brought in contact with a substrate, ink is delivered at the points of contact (FIGS. 1A and 2). Gel pen lithography is a direct-write method that delivers collections of molecules in a positive printing mode. A gel polymer can be selected (e.g. a polysaccharide gel, e.g. agarose gel) such that the ink solution is absorbed into the gel matrix of a gel pen array.

The amount of light reflected from the internal surfaces of the tips increases significantly when the tips make contact with the substrate. Therefore, a translucent or transparent elastomer polymer pen array allows one to visually determine when all of the tips are in contact with an underlying substrate, permitting one to address the otherwise daunting task of leveling the array in an experimentally straightforward manner. Thus, preferably one or more of the array tips, backing layer, and rigid support are at least translucent, and preferably transparent.

Polymer pen or gel pen lithography can be performed, for example, with an Nscroptor™ system (NanoInk Inc., IL).

Referring to FIG. 2, an embodiment of a tip array 10 includes a tip substrate layer 12 and a plurality of tips 14 fixed to the tip substrate layer 12. The tip substrate layer 12 and the plurality of tips 14 are formed of a polymer and one or both can be formed of a transparent polymer. The tip substrate layer 12 and the tips 14 can be formed of the same polymer or can be formed of different polymers.

The tip substrate layer 12 can have any suitable thickness, for example in a range of about 50 μm to about 5 mm, about 50 μm to about 100 μm, or about 1 mm to about 5 mm. For example, the tip substrate layer 12 can have a minimum thickness of about 50, 100, 200, 300, 400, 500, 600, 700, 800, 900, 1000, 2000, 3000, 4000, or 5000 μm. For example, the tip substrate layer 12 can have a maximum thickness of about 50, 100, 200, 300, 400, 500, 600, 700, 800, 900, 1000, 2000, 3000, 4000, or 5000 μm. The thickness of the tip substrate layer can be decreased as the rigidity of the polymer used to form the tip substrate layer increases. For example, for a gel polymer (e.g., agarose), the tip substrate layer can have a thickness in a range of about 1 mm to about 5 mm. For other, more rigid, polymers (e.g., PDMS) the tip substrate layer can have a thickness in a range of about 50 μm to about 100 μm, for example. The combined thickness of the tip substrate layer 12 and the tips 14 can be in range of about 50 μm to about 5 mm. For example, for a gel polymer (e.g., agarose), the combined thickness can be up to about 5 mm. For example, for other polymers (e.g., PDMS) the combined thickness can be less than about 200 μm, preferably less than about 150 μm, or more preferably about 100 μm.

The tip substrate layer 12 can be attached to a transparent rigid support, for example, formed from glass, silicon, quartz, ceramic, polymer, or any combination thereof. The rigid support is preferably highly rigid and has a highly planar surface upon which to mount the tip array 10.

The tip arrays are non-cantilevered and comprise tips 14 which can be designed to have any shape or spacing (pitch) between them, as needed. The shape of each tip can be the same or different from other tips 14 of the array, and preferably the tips 14 have a common shape. Contemplated tip shapes include spheroid, hemispheroid, toroid, polyhedron, cone, cylinder, and pyramid (trigonal or square). The tips 14 have a base portion fixed to the tip substrate layer 12. The base portion preferably is larger than the tip end portion. The base portion can have an edge length in a range of about 1 μm to about 50 μm, or about 5 μm to about 50 μm. For example, the minimum edge length can be about 1, 2, 3, 4, 5, 6, 7, 8, 9, 10, 11, 12, 13, 14, 15, 16, 17, 18, 19, 20 22, 24, 26, 28, 30, 32, 34, 36, 38, 40, 42, 44, 46, 48, or 50 μm. For example, the maximum edge length can be about 1, 2, 3, 4, 5, 6, 7, 8, 9, 10, 11, 12, 13, 14, 15, 16, 17, 18, 19, 20, 22, 24, 26, 28, 30, 32, 34, 36, 38, 40, 42, 44, 46, 48, or 50 μm.

A preferred tip array 10 contains thousands of tips 14, preferably having a pyramidal shape. The substrate-contacting (tip end) portions of the tips 14 each can have a diameter in a range of about 50 nm to about 1 μm before coating with the graphene film. For example, the minimum diameter can be about 50, 55, 60, 65, 70, 75, 80, 85, 90, 95, 100, 150, 200, 250, 300, 350, 400, 450, 500, 550, 600, 650, 700, 750, 800, 850, 900, 950, or 1000 nm. For example, the minimum diameter can be about 50, 55, 60, 65, 70, 75, 80, 85, 90, 95, 100, 150, 200, 250, 300, 350, 400, 450, 500, 550, 600, 650, 700, 750, 800, 850, 900, 950, or 1000 nm. The substrate-contacting portions of the tips 14 are preferably sharp, so that each is suitable for forming submicron patterns, e.g., less than about 500 nm. The sharpness of the tip is measured by its radius of curvature. The tips 14 can have a radius of curvature before coating with the graphene film, for example, of below about 1 μm, and can be less than about 0.9 μm, less than about 0.8 μm, less than about 0.7 μm, less than about 0.6 μm, less than about 0.5 μm, less than about 0.4 μm, less than about 0.3 μm, less than about 0.2 μm, less than about 0.1 μm, less than about 90 nm, less than about 80 nm, less than about 70 nm, less than about 60 nm, or less than about 50 nm.

The tip-to-tip spacing between adjacent tips 14 (tip pitch) can be in a range of about 1 μm to about over 10 mm, or about 20 μm to about 1 mm. For example, the minimum tip-to-tip spacing can be about 1 μm, 2 μm, 3 μm, 4 μm, 5 μm, 6 μm, 7 μm, 8 μm, 9 μm, 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 100 μm, 200 μm, 300 μm, 400 μm, 500 μm, 600 μm, 700 μm, 800 μm, 900 μm, 1 mm, 2 mm, 3 mm, 4 mm, 5 mm, 6 mm, 7 mm, 8 mm, 9 mm, or 10 mm. For example, the maximum tip-to-tip spacing can be about 1 μm, 2 μm, 3 μm, 4 μm, 5 μm, 6 μm, 7 μm, 8 μm, 9 μm, 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 100 μm, 200 μm, 300 μm, 400 μm, 500 μm, 600 μm, 700 μm, 800 μm, 900 μm, 1 mm, 2 mm, 3 mm, 4 mm, 5 mm, 6 mm, 7 mm, 8 mm, 9 mm, or 10 mm.

The tips 14 of the tip array 10 can be designed to have any desired thickness, for example in a range of about 50 nm to about 50 μm, about 50 nm to about 1 μm, about 10 μm to about 50 μm, about 50 nm to about 500 nm, about 50 nm to about 400 nm, about 50 nm to about 300 nm, about 50 nm to about 200 nm, or about 50 nm to about 100 nm. For example, the minimum thickness can be about 50 nm, 60 nm, 70 nm, 80 nm, 90 nm, 100 nm, 200 nm, 300 nm, 400 nm, 500 nm, 600 nm, 700 nm, 800 nm, 900 nm, 1 μm, 5 μm, 10 μm, 15 μm, 20 μm, 25 μm, 30 μm, 35 μm, 40 μm, 45 μm, or 50 μm. For example, the maximum thickness can be about 50 nm, 60 nm, 70 nm, 80 nm, 90 nm, 100 nm, 200 nm, 300 nm, 400 nm, 500 nm, 600 nm, 700 nm, 800 nm, 900 nm, 1 μm, 5 μm, 10 μm, 15 μm, 20 μm, 25 μm, 30 μm, 35 μm, 40 μm, 45 μm, or 50 μm. The thickness of the tip array 10 can be decreased as the rigidity of the polymer used to form the tip substrate layer increases. For example, for a gel polymer (e.g., agarose), the tip array 10 can have a thickness in a range of about 10 μm to about 50 μm. For other polymers (e.g., PDMS), for example, the tip array 10 can have a thickness of about 50 nm to about 1 μm. As used herein, the thickness of the tip array 10 refers to the distance from the tip end to the base end of a tip. The tips 14 can be arranged randomly or in a regular periodic pattern (e.g., in columns and rows, in a circular pattern, or the like).

Polymeric materials suitable for use in the tip array 10 can have linear or branched backbones, and can be crosslinked or non-crosslinked, depending upon the particular polymer and the degree of compressibility desired for the tip. Cross-linkers refer to multi-functional monomers capable of forming two or more covalent bonds between polymer molecules. Non-limiting examples of cross-linkers include such as trimethylolpropane trimethacrylate (TMPTMA), divinylbenzene, di-epoxies, tri-epoxies, tetra-epoxies, di-vinyl ethers, tri-vinyl ethers, tetra-vinyl ethers, and combinations thereof.

Thermoplastic or thermosetting polymers can be used, as can crosslinked elastomers. In general, the polymers can be porous and/or amorphous. A variety of elastomeric polymeric materials are contemplated, including polymers of the general classes of silicone polymers and epoxy polymers. Polymers having low glass transition temperatures such as, for example, below 25° C. or more preferably below −50° C., can be used. Diglycidyl ethers of bisphenol A can be used, in addition to compounds based on aromatic amine, triazine, and cycloaliphatic backbones. Another example includes Novolac polymers. Other contemplated elastomeric polymers include methylchlorosilanes, ethylchlorosilanes, and phenylchlorosilanes, polydimethylsiloxane (PDMS). Other materials include polyethylene, polystyrene, polybutadiene, polyurethane, polyisoprene, polyacrylic rubber, fluorosilicone rubber, and fluoroelastomers.

Further examples of suitable polymers that may be used to form a tip can be found in U.S. Pat. No. 5,776,748; U.S. Pat. No. 6,596,346; and U.S. Pat. No. 6,500,549, each of which is hereby incorporated by reference in its entirety. Other suitable polymers include those disclosed by He et al., Langmuir 2003, 19, 6982-6986; Donzel et al., Adv. Mater. 2001, 13, 1164-1167; and Martin et al., Langmuir, 1998, 14-15, 3791-3795. Hydrophobic polymers such as polydimethylsiloxane can be modified either chemically or physically by, for example, exposure to a solution of a strong oxidizer or to an oxygen plasma.

The polymer of the tip array 10 can be a polymer gel. The gel polymer can comprise any suitable gel, including hydrogels and organogels. For example, the polymer gel can be a silicon hydrogel, a branched polysaccharide gel, an unbranched polysaccharide gel, a polyacrylamide gel, a polyethylene oxide gel, a cross-linked polyethylene oxide gel, a poly(2-acrylamido-2-methyl-1-propanesulfonic acid) (polyAMPS) gel, a polyvinylpyrrolidone gel, a cross-linked polyvinylpyrrolidone gel, a methylcellulose gel, a hyaluronan gel, and combinations thereof. For example, the polymer gel can be an agarose gel. By weight, gels are mostly liquid, for example the gel can be greater than 95% liquid, yet behave like a solid due to the presence of a cross-linked network within the liquid.

The material used to form the tip array 10 has a suitable compression modulus and surface hardness to prevent collapse of the tip during contact with the surface, but too high a modulus and too great a surface hardness can lead to a brittle material that cannot adapt and conform to a substrate surface during exposure. As disclosed in Schmid, et al., Macromolecules, 33:3042 (2000), vinyl and hydrosilane prepolymers can be tailored to provide polymers of different modulus and surface hardness. Thus, in another type of embodiment, the polymer can be a mixture of vinyl and hydrosilane prepolymers, wherein the weight ratio of vinyl prepolymer to hydrosilane crosslinker is about 5:1 to about 20:1, about 7:1 to about 15:1, or about 8:1 to about 12:1.

The material used to form the tip array 10 can have a surface hardness of about 0.2% to about 3.5% of glass, as measured by resistance of a surface to penetration by a hard sphere with a diameter of 1 mm, compared to the resistance of a glass surface (as described in Schmid, et al., Macromolecules, 33:3042 (2000) at p 3044). The surface hardness optionally can be about 0.3% to about 3.3%, about 0.4% to about 3.2%, about 0.5% to about 3.0%, or about 0.7% to about 2.7% of glass. The polymers of the tip array 10 can have a compression modulus of about 10 MPa to about 300 MPa. The tip array 10 preferably comprises a compressible polymer which is Hookean under pressures of about 10 MPa to about 300 MPa. The linear relationship between pressure exerted on the tip array 10 and the feature size allows for control of the near field and feature size using the disclosed methods and tip arrays (see FIG. 2B).

A Polymer Pen Lithography tip array can comprise a polymer that has adsorption and/or absorption properties for the patterning composition, such that the tip array acts as its own patterning composition reservoir. For example, PDMS is known to adsorb patterning inks. See e.g., U.S. Patent Publication No 2004/22962, Zhang et al., Nano Lett. 4, 1649 (2004), and Wang et al., Langmuir 19, 8951 (2003).

Polymer Pen Lithography tip arrays can be made with a master prepared by conventional photolithography and subsequent wet chemical etching. The mold can be engineered to contain as many tips arrayed in any fashion desired. The tips of the tip array can be any number desired, and contemplated numbers of tips 14 include about 1000 tips 14 to about 15 million tips, or greater. The number of tips 14 of the tip array 10 can be greater than about 1 million, greater than about 2 million, greater than about 3 million, greater than about 4 million, greater than 5 million tips 14, greater than 6 million, greater than 7 million, greater than 8 million, greater than 9 million, greater than 10 million, greater than 11 million, greater than 12 million, greater than 13 million, greater than 14 million, or greater than 15 million tips.

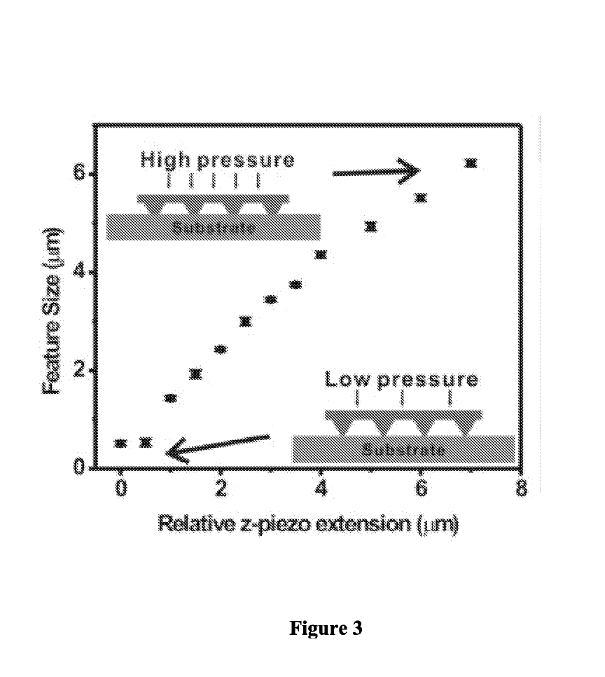

Polymer Pen Lithography exhibits both time- and pressure-dependent ink transport. Polymer Pen Lithography probes having a graphene film coated thereon also exhibit both time- and pressure-dependent ink transport. This property of Polymer Pen Lithography, which is a result of the diffusive characteristics of the ink and the small size of the delivery tips, allows one to pattern sub-micron features with high precision and reproducibility (variation of feature size is less than 10% under the same experimental conditions). The pressure dependence of Polymer Pen Lithography derives from the compressible nature of the elastomer pyramid array and is not inhibited by the graphene film. Indeed, the microscopic, preferably pyramidal, tips can be made to deform with successively increasing amounts of applied pressure, which can be controlled by simply extending the piezo in the vertical direction (z-piezo). The controlled deformation can be used as an adjustable variable, allowing one to control tip-substrate contact area and resulting feature size. Within the pressure range allowed by z-piezo extension of about 5 to about 25 μm, one can observe a near linear relationship between piezo extension and feature size at a fixed contact time of 1 s (FIG. 3). Interestingly, at the point of initial contact and up to a relative extension 0.5 μm, the sizes of the MHA dots do not significantly differ and are both about 500 nm, indicating that the backing elastomer layer, which connects all of the pyramids, deforms before the pyramid-shaped tips do. This type of buffering is fortuitous and essential for leveling because it provides extra tolerance in bringing all of the tips in contact with the surface without tip deformation and significantly changing the intended feature size. When the z-piezo extends 1 μm or more, the tips exhibit a significant and controllable deformation (FIG. 3). With the pressure dependency of Polymer Pen Lithography, one does not have to rely on the time-consuming, meniscus-mediated ink diffusion process to generate large features. Indeed, one can generate either nanometer or micrometer sized features in only one printing cycle by simply adjusting the degree of tip deformation.

Polymer Pen Lithography allows for the combinatorial patterning of molecule-based and solid-state features with dynamic control over features size, spacing, and shape. The maskless nature of Polymer Pen Lithography allows one to arbitrarily make many types of structures without the hurdle of designing a new master via a throughput-impeded serial process. In addition, Polymer Pen Lithography can be used with sub-100 nm resolution with the registration capabilities of a closed-loop scanner.

### Beam Pen Lithography

The tips 14 of a Beam Pen Lithography tip array can be used to both channel the radiation to a surface in a massively parallel scanning probe lithographic process and to control one or more parameters such as the distance between the tip and the substrate, and the degree of tip deformation. Control of such parameters can allow one to take advantage of near-field effects. In one embodiment, the tips 14 are elastomeric and reversibly deformable, which can allow the tip array 10 to be brought in contact with the substrate without damage to the substrate or the tip array 10. This contact can ensure the generation of near-field effects.

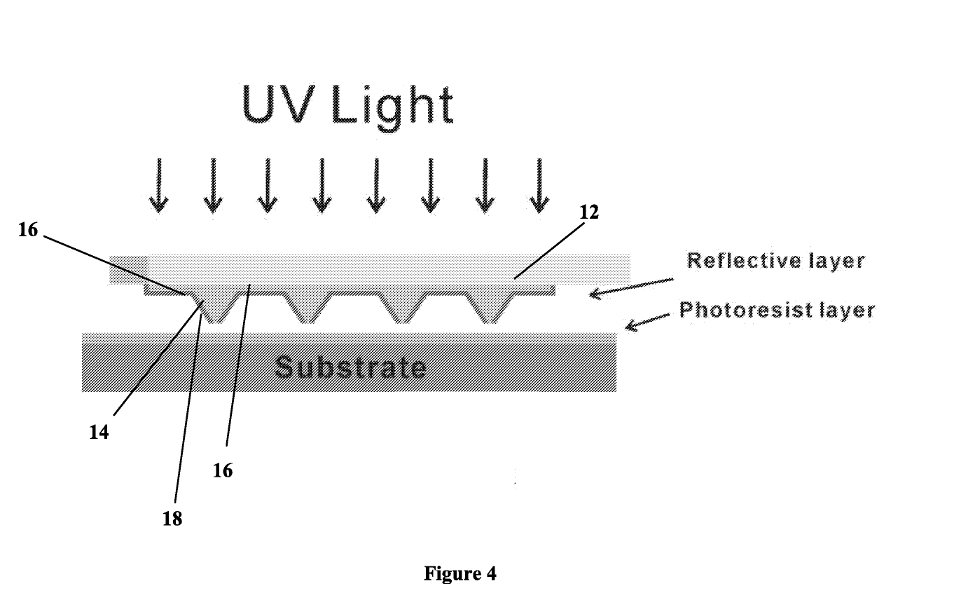

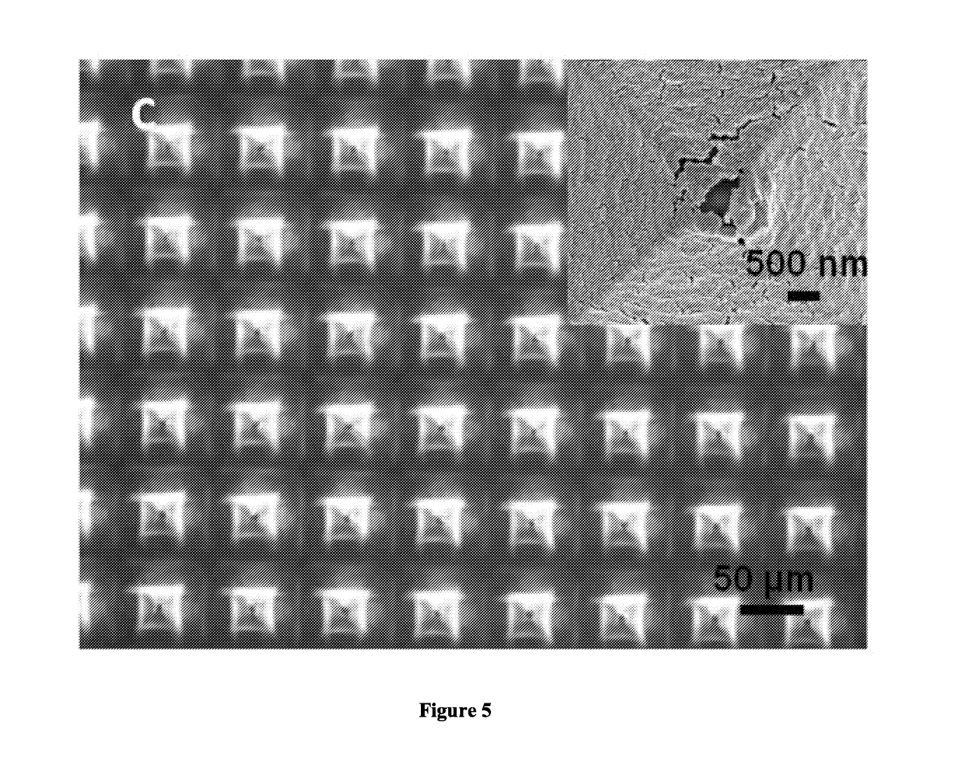

Referring to FIG. 4, an embodiment of a Beam Pen Lithography tip array 10 includes a tip substrate layer 12 and a plurality of tips 14 fixed to the tip substrate layer 12. The tip substrate layer 12 and the plurality of tips 14 are formed of a transparent polymer. The tip substrate layer 12 and the tips 14 can be formed of the same polymer or can be formed of different polymers. Details regarding the tips and tip arrays, including, for example, the tip and tip substrate dimensions, shape, spacing, materials, and number of tips, are provided above.

A Beam Pen Lithograph tip array 10 further includes a blocking layer 16 coated on the sidewalls of the tips 14 and on the portions of the tip substrate layer 12 between adjacent tips 14. Referring to FIGS. 2B and 2C, an aperture 18 is defined in the blocking layer 16 at the tip end (e.g., the photosensitive layer-contacting end of each of the tips 14), such that the transparent polymer tip end is exposed through the aperture 18. The tips 14 are formed from a material which is at least translucent to the wavelength of radiation intended for use in patterning, e.g. in a range of 300 nm to 600 nm, and preferably the tips 14 are transparent to such light. Each tip can have a blocking layer 16 disposed thereon, with an aperture 18 defined in the blocking layer 16 and exposing the tip end. The blocking layer 16 serves as a radiation blocking layer 16, channeling the radiation through the material of the tip and out the exposed tip end.

The blocking layer 16 on the polymer tip sidewalls serves as a radiation blocking layer 16, allowing the radiation illuminated on a surface of the substrate layer opposite the surface to which the tips 14 are fixed to be emitted only through the tip end exposed by the aperture 18 defined in the blocking layer 16. As shown in FIG. 1A, the exposure of a substrate pre-coated with a resist layer 20 with the radiation channeled through the tip ends 18 of the tip array 10 can allow for the formation of a single dot per tip for each exposure. The blocking layer 16 can be formed of any material suitable for blocking (e.g., reflecting) a type of radiation used in the lithography process. For example, the blocking layer 16 can be a metal, such as gold, when used with UV light. Other suitable blocking layers include, but are not limited to, gold, chromium, titanium, silver, copper, nickel, silicon, aluminum, opaque organic molecules and polymers, and combinations thereof. The blocking layer 16 can have any suitable thickness, for example in a range of about 40 nm to about 500 nm. For example, the minimum thickness can be about 40, 45, 50, 55, 60, 65, 70, 75, 80, 85, 90, 95, 100, 150, 200, 250, 300, 350, 400, 450, or 500 nm. For example, the maximum thickness can be about 40, 45, 50, 55, 60, 65, 70, 75, 80, 85, 90, 95, 100, 150, 200, 250, 300, 350, 400, 450, or 500 nm.

The pressure dependence exhibited by polymer pen lithography tip arrays and described above is similarly exhibited by beam pen lithography tip arrays. As noted above, the graphene film does not inhibit or otherwise adversely affect the pressure dependent properties of beam pen lithography.

As described above, the tip portion of the tip arrays can be made with a master prepared by conventional photolithography and subsequent wet chemical etching. The mold can be engineered to contain as many tips 14 arrayed in any fashion desired. The tips of the tip array can be any number desired, and contemplated numbers of tips 14 include about 1000 tips 14 to about 15 million tips, or greater. The number of tips 14 of the tip array 10 can be greater than about 1 million, greater than about 2 million, greater than about 3 million, greater than about 4 million, greater than 5 million tips 14, greater than 6 million, greater than 7 million, greater than 8 million, greater than 9 million, greater than 10 million, greater than 11 million, greater than 12 million, greater than 13 million, greater than 14 million, or greater than 15 million tips.

Optionally, the tips 14 can be cleaned, for example, using oxygen plasma, prior to coating with the blocking layer 16. The blocking layer 16 can be disposed on the tips 14 by any suitable process, including coating, for example, spin-coating, the tips 14 with the blocking layer 16.

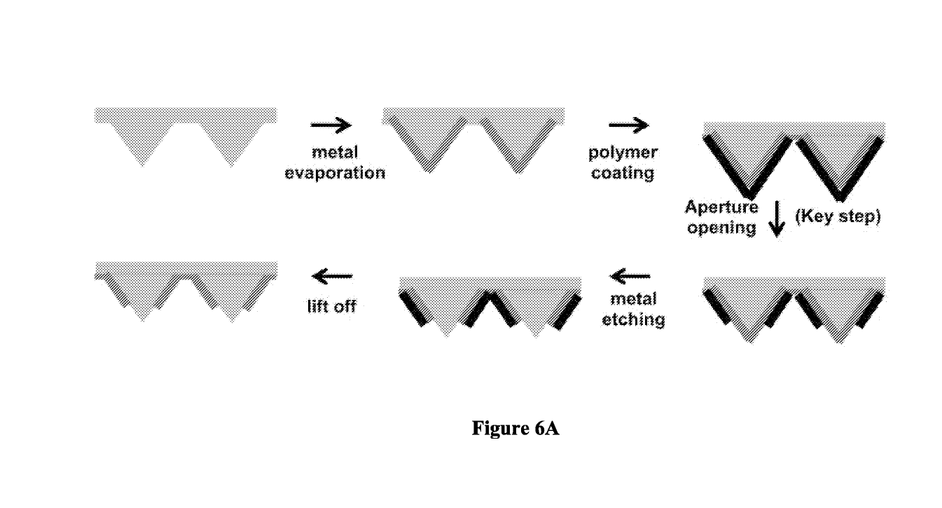

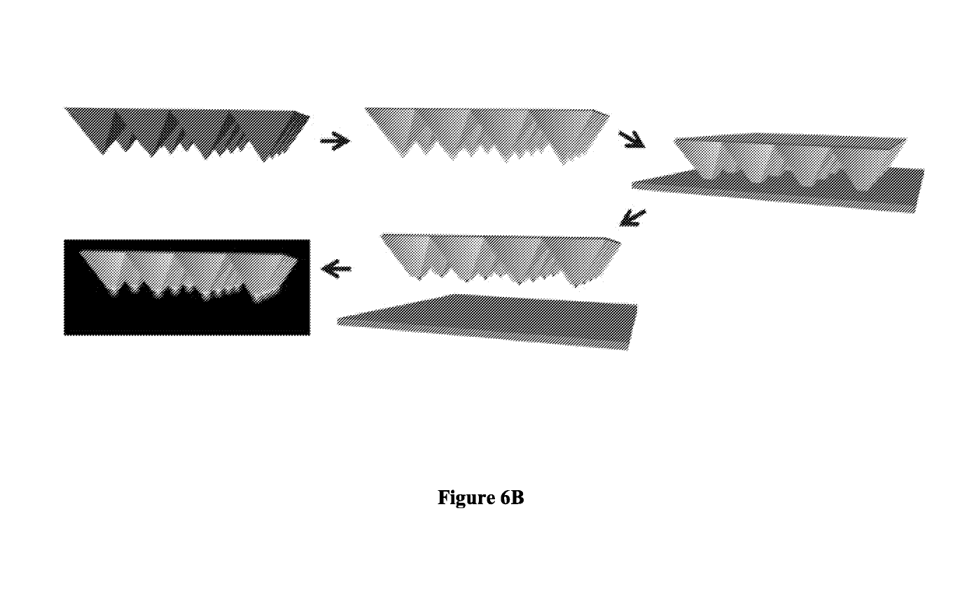

An aperture 18 in the blocking layer 16 can be formed by any suitable method, including, for example, focused ion beam (FIB) methods or using a lift-off method. The lift-off method can be a dry lift off method. Referring to FIG. 6A, one suitable approach includes applying an adhesive 22, such as poly(methyl methacrylate) (PMMA) on top of the blocking layer 16 of the tip array 10, and removing a portion of the adhesive 22 material disposed at the substrate contacting end of the tips 14 by contacting the tip array 10 to a clean and flat surface, for example a glass surface. The tips 14 can then be immersed in an etching solution to remove the exposed portion of the blocking layer 16 to form the aperture 18 and expose the material of the tip, e.g. the transparent polymer. The remaining adhesive 22 material protects the covered surfaces of the blocking layer 16 from being etched during the etching step. The adhesive can be, for example, PMMA, poly(ethylene glycol) (PEG), polyacrylonitrile, and combinations thereof.

Referring to FIG. 6B, alternatively, a simple contact approach can be used in which a tip array 10 having the blocking layer 16 is brought in contact with a glass slide or other surface coated with an adhesive 22 material, such as PMMA. Other suitable adhesive 22 materials include, for example, PMMA, PEG, polyacrylonitrile, and combinations thereof. Upon removal of the pen tip from surface coated with the adhesive 22 material, the adhesive 22 material removes the contacted portion of the blocking layer 16, thereby defining an aperture 18 and exposing the tip material, e.g. the transparent polymer.

Both of the above-described approaches can be utilized when forming a blocking layer on a tip having a graphene film coated thereon.

In either of the above described aperture 18 forming methods, the size of the aperture 18 formed can be controlled by applying different external forces on the backside of the BPL tip array 10. As a result of the flexibility of elastomeric tips 14, the application of force on the backside of the BPL tip array 10 can be used to control the contact area between the tips 14 and adhesive 22 material surface. The BPL tip array 10 can include pyramidal tips 14, with each pyramid-shaped tip being covered by a gold blocking layer 16 having a small aperture 18 defined in the blocking layer 16 at the very end of the tip. The size of the aperture 18 does not significantly change from tip to tip. For example, the size of the aperture 18 can vary less than about 10% from tip to tip. The size of the aperture 18 can be tailored over the 200 nm to 1 to 10 μm ranges, for example, by controlling contact force. For example, the aperture 18 can have a diameter in a range of about 5 nm to about 5 μm, about 30 nm to about 500 nm, or about 200 nm to about 5 μm. For example, the minimum aperture 18 diameter can be about 5, 10, 15, 20, 25, 30, 35, 40, 45, 50, 55, 60, 65, 70, 75, 80, 85, 90, 95, 100, 200, 300, 400, 500, 600, 700, 800, 900 1000, 1500, 2000, 2500, 3000, 3500, 4000, 4500, or 5000 nm. For example, the maximum aperture 18 diameter can be about 5, 10, 15, 20, 25, 30, 35, 40, 45, 50, 55, 60, 65, 70, 75, 80, 85, 90, 95, 100, 200, 300, 400, 500, 600, 700, 800, 900 1000, 1500, 2000, 2500, 3000, 3500, 4000, 4500, or 5000 nm. The contact force optionally can be in a range of about 0.002 N to about 0.2N for a 1 cm² pen array.

For example, a PDMS array of pyramid-shape tips 14 can be fabricated by known methods. (17, 20). For example, each pyramid tip can have a square base with a several tens of μm edge length and can come to a tip that has tip diameter of about 100 nm. The entire array, including tips 14, can then be cleaned, for example, by oxygen plasma and covered with a blocking layer 16 (e.g. gold), by a thermal evaporation method, for example. The coating can include, for example, a layer of gold that is about 80 nm thick with an about 5 nm thick Ti adhesion layer. The tip array 10 is then brought in contact with a glass slide coated with PMMA, an adhesive 22 material, which subsequently removes the Au/Ti layer from the PDMS tips 14 and exposes the underlying transparent PDMS.

In one class of embodiments, the graphene film is coated on the tips prior to forming the blocking layer. In such embodiments, the graphene film is transparent and therefore can remain on the tip end without inhibiting the photolithography performance of the beam pen array. In another class of embodiments, the blocking layer is formed on the tips and the graphene film is coated on the blocking layer. In such embodiments, the aperture can be formed prior to forming the graphene film and the graphene film can be coated over the blocking layer and the aperture.

### Hard Spring Lithography

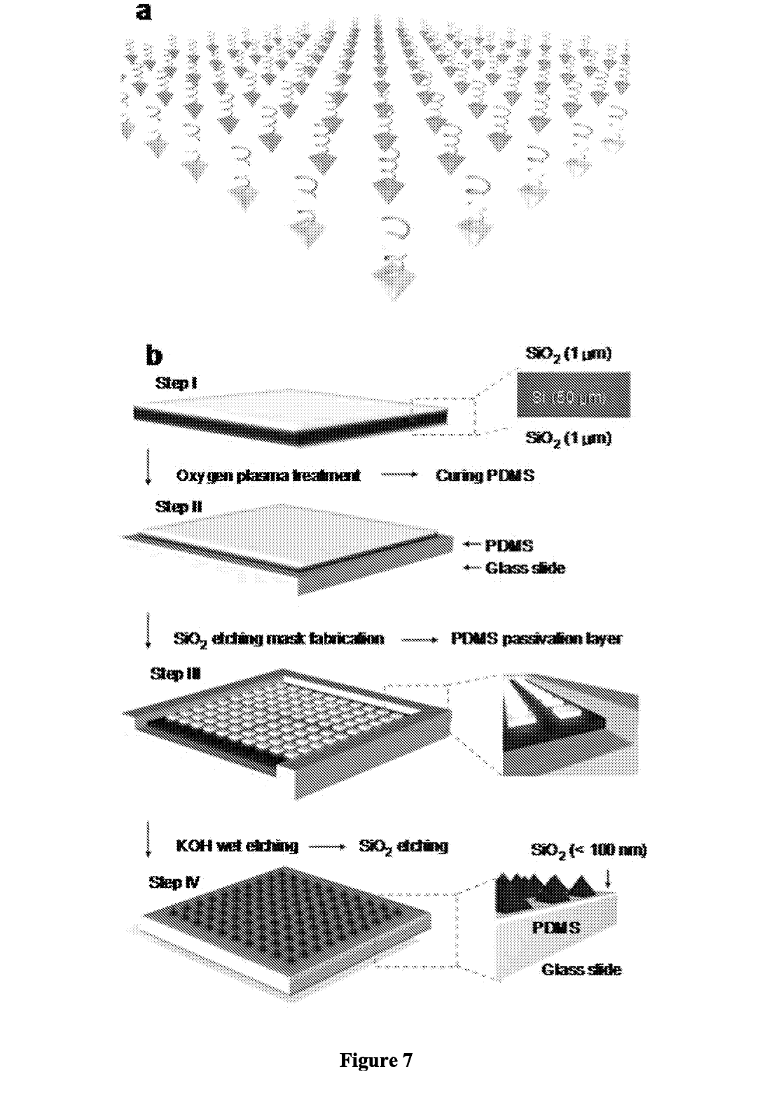

Referring to FIG. 7, hard Spring Lithography is a massively parallel, hybrid tip-based molecular printing method. When silicon is used for the tip material, Hard Spring Lithography is also referred to as Silicon Pen Lithography. The method and apparatus employs an array of tips, e.g. Si tips, mounted onto a backing layer to create patterns of molecules on surfaces with features as small as 30 nm in diameter over large area. While the tips described herein are described in the context of silicon or silicon-containing tips, the tips can also comprise a metal, metalloid, a semi-conducing material, and/or combinations thereof. For example, silicon nitride AFM probes, metal carbide coated AFM probes, plasma treated AFM probes, silanized AFM probes, diamond AFM probes, gallium containing materials (e.g., gallium nitride, gallium sulfide, gallium arsenide), and other semi-conducting materials are known in the art. The tips can have an average radius of curvature of, e.g., down to 22 nm or even less. Hard Spring Lithography tips arrays demonstrate time-dependent feature size that is analogous to DPN, but there is no relation between the force and the feature size, which is distinct from polymer pen lithography. Hard Spring Lithography tips can write features as small as 34 nm, and can transfer energy to the surface to form a pattern.

The tip arrays disclosed herein comprise a plurality of tips (e.g., silicon or silicon-containing) fixed to an elastomeric backing layer. The backing layer can be at least translucent, or preferably substantially transparent. The backing layer can have any suitable thickness, for example in a range of about 50 μm to about 1000 μm, about 50 μm to about 500 μm, about 50 μm to about 250 μm, or about 50 μm to about 200 μm, or about 50 μm to about 100 μm.

The elastomeric backing layer comprises an elastomeric polymeric material. Polymeric materials suitable for use in the backing layer can have linear or branched backbones, and can be crosslinked or non-crosslinked. Cross-linkers refer to multi-functional monomers capable of forming two or more covalent bonds between polymer molecules. Non-limiting examples of cross-linkers include such as trimethylolpropane trimethacrylate (TMPTMA), divinylbenzene, di-epoxies, tri-epoxies, tetra-epoxies, di-vinyl ethers, tri-vinyl ethers, tetra-vinyl ethers, and combinations thereof.

Thermoplastic or thermosetting polymers can be used, as can crosslinked elastomers. In general, the polymers can be porous and/or amorphous. A variety of elastomeric polymeric materials are contemplated, including polymers of the general classes of silicone polymers and epoxy polymers. Polymers having low glass transition temperatures such as, for example, below 25° C. or more preferably below −50° C., can be used. Diglycidyl ethers of bisphenol A can be used, in addition to compounds based on aromatic amine, triazine, and cycloaliphatic backbones. Another example includes Novolac polymers. Other contemplated elastomeric polymers include methylchlorosilanes, ethylchlorosilanes, and phenylchlorosilanes, polydimethylsiloxane (PDMS). Other materials include polyethylene, polystyrene, polybutadiene, polyurethane, polyisoprene, polyacrylic rubber, fluorosilicone rubber, and fluoroelastomers.

Further examples of suitable polymers that may be used in the backing layer can be found in U.S. Pat. No. 5,776,748; U.S. Pat. No. 6,596,346; and U.S. Pat No. 6,500,549, each of which is hereby incorporated by reference in its entirety. Other suitable polymers include those disclosed by He et al., Langmuir 2003, 19, 6982-6986; Donzel et al., Adv. Mater. 2001, 13, 1164-1167; and Martin et al., Langmuir, 1998, 14-15, 3791-3795. Hydrophobic polymers such as polydimethylsiloxane can be modified either chemically or physically by, for example, exposure to a solution of a strong oxidizer or to an oxygen plasma. In some cases, the elastomeric polymer is a mixture of vinyl and hydrosilane prepolymers, where the weight ratio of vinyl prepolymer to hydrosilane crosslinker is about 5:1 to about 20:1, about 7:1 to about 15:1, or about 8:1 to about 12:1.

The tips of the tip array can be any number desired, and contemplated numbers of tips include about 100 tips to about 15 million tips, or greater. The number of tips of the tip array can be greater than about 1 million, greater than about 2 million, greater than about 3 million, greater than about 4 million, greater than 5 million tips, greater than 6 million, greater than 7 million, greater than 8 million, greater than 9 million, greater than 10 million, greater than 11 million, greater than 12 million, greater than 13 million, greater than 14 million, or greater than 15 million tips.

The tip array comprising tips and backing layer can have any suitable thickness, for example in a range of about 50 μm to about 5 mm, about 50 μm to about 100 μm, or about 1 mm to about 5 mm. For example, the tip array can have a minimum thickness of about 50, 100, 200, 300, 400, 500, 600, 700, 800, 900, 1000, 2000, 3000, 4000, or 5000 μm. For example, the backing layer can have a maximum thickness of about 50, 100, 200, 300, 400, 500, 600, 700, 800, 900, 1000, 2000, 3000, 4000, or 5000 μm.

The tip array can be attached to a rigid support. The rigid support, when present, is disposed opposite the tips of the tip array and parallel to the backing layer. In some cases, the rigid support is at least translucent, or is substantially transparent. In some cases, the backing layer and rigid support together are at least translucent or are substantially transparent. Non-limiting examples of rigid supports include formed from glass, silicon, quartz, ceramic, polymer, or any combination thereof. The rigid support is preferably highly rigid and has a highly planar surface upon which to mount the tip array. The combined thickness of the tip array and optional rigid support can be of any desired thickness, for example in range of about 50 μm to about 5 mm. The combined thickness can be less than about 5 mm, less than 1 mm, less than about 750 μm, or less than about 500 μm, for example.

The tip arrays are non-cantilevered and comprise tips (e.g. silicon or silicon-containing) which can be designed to have any shape or spacing (pitch) between them, as needed. The shape of each tip can be the same or different from other tips of the array, and preferably the tips have a common shape. Contemplated tip shapes include spheroid, hemispheroid, toroid, polyhedron, cone, cylinder, and pyramid (e.g., trigonal or square or octagonal). The tips can be arranged randomly or preferably in a regular periodic pattern (e.g., in columns and rows, in a circular pattern, or the like).

The tips have a base portion fixed to the backing layer. The base portion preferably is larger than the tip end portion. The base portion of the tips can have diameter of any suitable dimension, for example in a range of about 1 μm to about 50 μm, or about 5 μm to about 50 μm, or less than 100 μm, or less than 50 μm. For example, the minimum diameter of the base of the tips can be about 1, 2, 3, 4, 5, 6, 7, 8, 9, 10, 11, 12, 13, 14, 15, 16, 17, 18, 19, 20 22, 24, 26, 28, 30, 32, 34, 36, 38, 40, 42, 44, 46, 48, or 50 μm. For example, the maximum diameter of the base of the tips can be about 1, 2, 3, 4, 5, 6, 7, 8, 9, 10, 11, 12, 13, 14, 15, 16, 17, 18, 19, 20, 22, 24, 26, 28, 30, 32, 34, 36, 38, 40, 42, 44, 46, 48, or 50 μm.

A preferred shape of the tips is pyramidal, more preferably octagonal pyramidal. The substrate-contacting (tip end) portions of the tips each can have a radius of curvature of any suitable dimension, for example in a range of about 5 nm to about 1 μm. For example, the minimum radius of curvature can be about 5, 10, 15, 20, 21, 22, 23, 24, 25, 26, 27, 28, 29, 30, 35, 40, 45, 50, 55, 60, 65, 70, 75, 80, 85, 90, 95, 100, 150, 200, 250, 300, 350, 400, 450, 500, 550, 600, 650, 700, 750, 800, 850, 900, 950, or 1000 nm. The substrate-contacting portions of the tips are preferably sharp, so that each is suitable for forming submicron patterns, e.g., a radius of curvature of less than about 500 nm, less than 100 nm, less than 50 nm, or less than 25 nm.

The tip-to-tip spacing between adjacent tips (tip pitch) can be of any desired dimension, for example in a range of about 1 μm to about over 10 mm, or about 20 μm to about 1 mm. For example, the minimum tip-to-tip spacing can be about 1 μm, 2 μm, 3 μm, 4 μm, 5 μm, 6 μm, 7 μm, 8 μm, 9 μm, 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 100 μm, 200 μm, 300 μm, 400 μm, 500 μm, 600 μm, 700 μm, 800 μm, 900 μm, 1 mm, 2 mm, 3 mm, 4 mm, 5 mm, 6 mm, 7 mm, 8 mm, 9 mm, or 10 mm. For example, the maximum tip-to-tip spacing can be about 1 μm, 2 μm, 3 μm, 4 μm, 5 μm, 6 μm, 7 μm, 8 μm, 9 μm, 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 100 μm, 200 μm, 300 μm, 400 μm, 500 μm, 600 μm, 700 μm, 800 μm, 900 μm, 1 mm, 2 mm, 3 mm, 4 mm, 5 mm, 6 mm, 7 mm, 8 mm, 9 mm, or 10 mm.

The tips of the tip array can be designed to have any desired height, for example in a range of about 50 nm to less than 100 μm, about 50 nm to about 90 μm, about 50 nm to about 80 μm, about 50 nm to about 70 μm, about 50 nm to about 60 μm, about 10 μm to about 50 μm, about 50 nm to about 40 μm, about 50 nm to about 30 μm, about 50 nm to about 20 μm, about 50 nm to about 500 nm, about 50 nm to about 400 nm, about 50 nm to about 300 nm, about 50 nm to about 200 nm, or about 50 nm to about 100 nm. For example, the minimum height can be about 50 nm, 60 nm, 70 nm, 80 nm, 90 nm, 100 nm, 200 nm, 300 nm, 400 nm, 500 nm, 600 nm, 700 nm, 800 nm, 900 nm, 1 μm, 5 μm, 10 μm, 15 μm, 20 μm, 25 μm, 30 μm, 35 μm, 40 μm, 45 μm, or 50 μm. For example, the maximum height can be about 50 nm, 60 nm, 70 nm, 80 nm, 90 nm, 100 nm, 200 nm, 300 nm, 400 nm, 500 nm, 600 nm, 700 nm, 800 nm, 900 nm, 1 μm, 5 μm, 10 μm, 15 μm, 20 μm, 25 μm, 30 μm, 35 μm, 40 μm, 45 μm, or 100 μm.

The tip array can optionally include an adhesion-enhancing layer between the tips and the backing layer. This layer can increase the stability of the tip-backing layer adhesion and/or increase the facility with which the tips and backing layer are adhered. The adhesion-enhancing layer can be disposed over the entire elastomeric backing layer, or optionally only in selected regions (e.g. between each tip and the elastomeric backing layer). One non-limiting example of an adhesion-enhancing layer is a silicon dioxide layer. Other examples include epoxy resins or other adhesive materials.

The tip array can optionally include a coating disposed on the exposed surfaces of the tips and further optionally also over the surfaces of the backing layer adjacent to the tips. This coating can comprise a conductive material (e.g., a material capable of conducting electrical energy), for example. Non-limiting examples of a conductive coating include gold, silver, titanium, nickel, copper, conductive metals, conductive metal alloys, or combinations thereof.

The Si tips, prepared by a self-sharpening wet etching protocol, can have a radius of curvature of about 22 nm, thereby enabling the easy preparation of sub-50 nm features in a pattern. Because the tip arrays can be prepared on a glass slide, these arrays can be easily mounted onto the piezoelectric actuators of a conventional AFM, which provides the precise tip positioning and registration that are hallmarks of scanning probe lithographies. Both the elastomer and glass onto which the arrays are mounted can be selected to be transparent, which enables the compression of the elastomer that occurs when the tips touch the surface of a substrate to be observed visually, thereby enabling a straightforward, optical method for leveling the plane of the tip array with respect to the substrate surface, when desired.

The preferred tip-array fabrication protocol described herein involves two major steps, photolithography and a self-sharpening etching step (7b). Importantly, no micromachining steps are required, thereby reducing significantly the manufacturing costs to about $10 for a 1×1 cm pen array, whereas a single, cantilever-bound AFM probe costs about $40. Depending on the intended use, the pitch of a pen array can be deliberately set between 100 and 200 μm, corresponding to tip densities of 10,000/cm² and 2,500/cm², respectively, and the density can be as high as 111,110/cm² (9,007,700 tips in a 4-inch wafer) with a pitch of 30-μm, for example.

The method can include the steps of providing a substrate wafer (e.g., silicon) from which the tips will be formed; adhering an elastomeric backing layer to the wafer to form a structure; and etching the wafer material to form tips attached to the backing layer. Preferably, a mask pattern is formed over the wafer prior to etching, to form pre-tip regions.

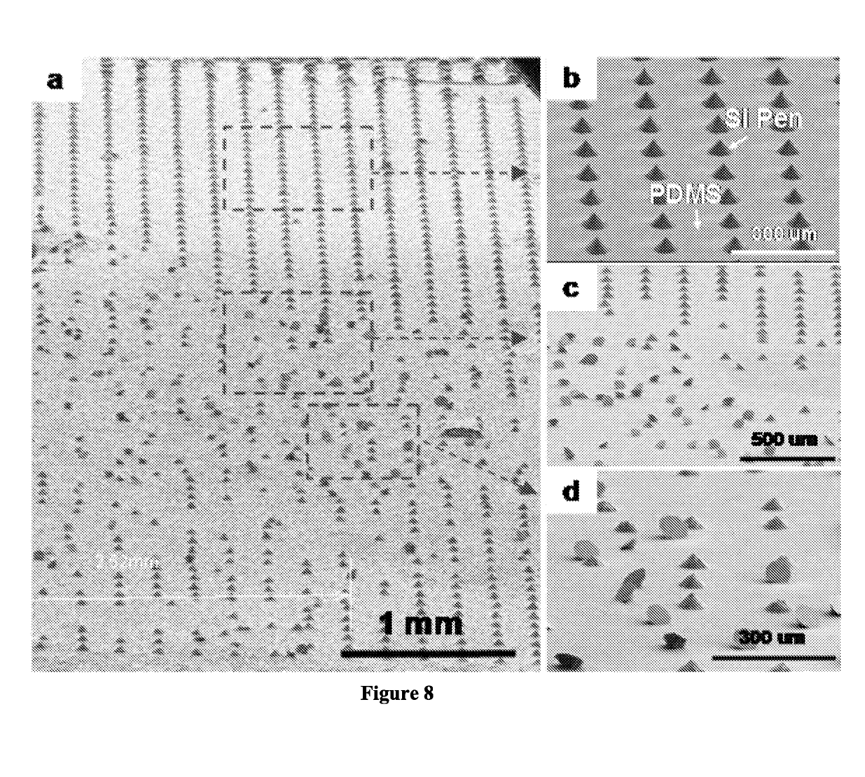

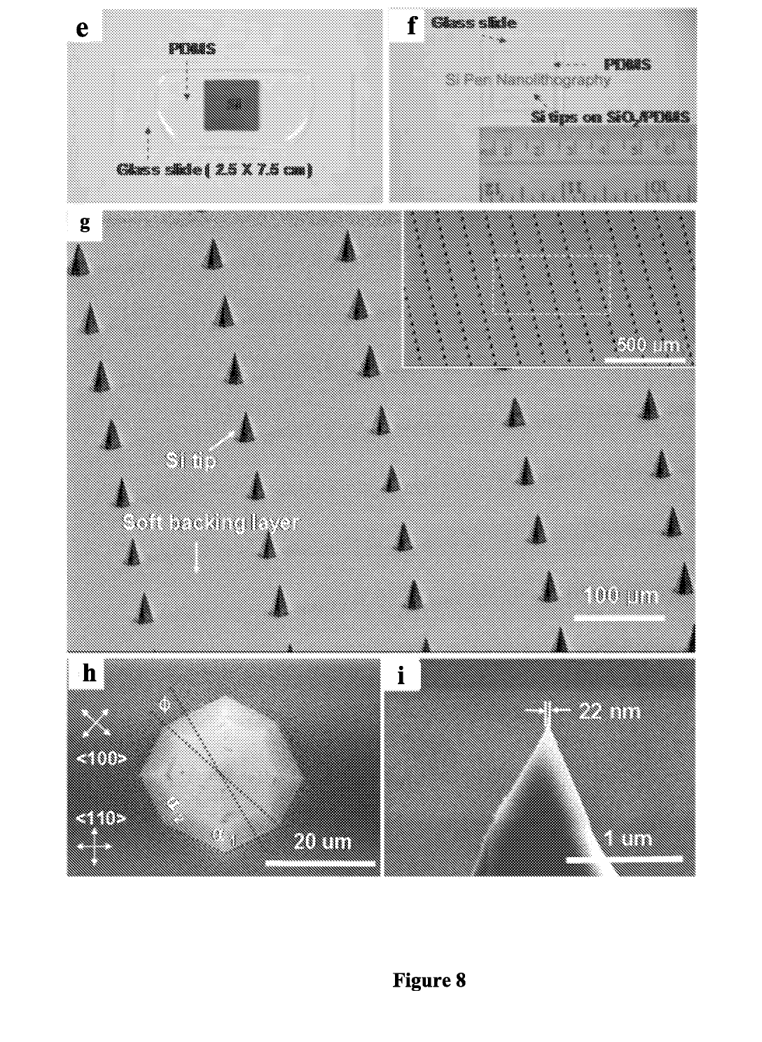

As an example, to make the pen arrays, a Si wafer (e.g., 1×1 cm piece of a 50 μm-thick (100)), optionally with a layer of silicon dioxide (SiO₂) (e.g., 1 μm thick) on each side of the wafer, was placed onto uncured elastomer. The top layer of SiO₂ can serve as an etching mask material, while the SiO₂ layer of the wafer in contact with the backing layer can increase adhesion between the two surfaces, so that the tips do not fall off a certain PDMS elastomeric backing material once the wafer has been etched (FIG. 8). Following an optional curing of elastomer of the backing layer, an array of square SiO₂ masks over silicon (e.g., pre-tip regions) are prepared from the top SiO₂ layer along the <110> axis of the wafer by conventional photolithography and a subsequent buffered hydrofluoric acid (HF) etch. The tips are prepared by etching the Si of the pre-tip regions and Si between pre-tip regions in an etching solution, e.g., 40% (w/v) aqueous potassium hydroxide (KOH) solution that etches the (311) and the (100) planes of the wafer at rates of 88 and 50 μm/hr, respectively. In one preferred embodiment, during the etching, the Si wafer is embedded in the elastomer or backing layer (e.g., PDMS) so that the sides of the wafer are not exposed to the etching solution, thereby protecting the (110) crystal face exposed on the sides that would etch faster than the (100) face on the surface. In other embodiments, the sides of the wafer can be protected from etchant by any other suitable methods and materials, as would be recognized by the skilled artisan. The sidewall etching rate, R_{w}/cos θ (θ is a slope of sidewall), must exceed the surface etching rate, R_{f} in order to form sharp Si tips. Thus the anisotropy ratio η_{c} and the condition for self-sharpening points is expressed as η=R_{f}/R_{w}≦1/cos θ=η_{c}, which indicates that faster etching rate for sidewall than that of floor is required to form a sharp tip. For (311) sidewall and (100) floor, the experimental η=R₍₁₀₀₎/R₍₃₁₁₎ was measured as 0.56 in 40 wt % KOH at 70° C., while theoretical η_{c} is 3.33. This parameter can be changed to altering the weight % of the KOH and/or the temperature at which the etching occurs. Other etching solutions that etch silicon anisotropically include ethylenediamine/pyrocathecol/water and tretramethylammonium hydroxide.

Analysis of the resulting tip arrays reveals that this fabrication protocol does indeed achieve massively parallel Si pen arrays with tip radii of about 22 nm (FIG. 8E-8I). The massively parallel Si pen array is immobilized onto a glass slide (FIG. 8E), which is a rigid support for the arrays, allows handling of the fragile pen array without damage, and is a platform for mounting the arrays onto the AFM. In a preferred embodiment, the elastomeric backing and rigid support together are transparent (FIG. 8F), which enables the visual leveling alignment of the tips onto a surface. A scanning electron microscope (SEM) image of the tips with 160 μm in pitch shows that the tips are remarkably uniform with bottom width 30±0.6 μm, corresponding to a tip height of 47±0.9 μm, and that they adhere well to the elastomer surface (FIG. 8G). It was found by SEM that the surface intersection angles, α1, α2, and the rotation of the intersection of the planes to the <100> plane of the wafer, φ, are 127.2, 143.3, and 18.3° (FIG. 8H), respectively, which demonstrates that the sidewall of the tips is (311) plane because the value of angles correspond perfectly to theoretical value of those for (311) of 126.9, 143.1, and 18.4°, respectively. Importantly, the Si tip radius of the arrays is found to be 22±3 nm (FIG. 8I), demonstrating that self-sharpening has been achieved under the etching conditions of 40% KOH in H₂O. The tip radius can be reduced to 5 nm by changing the etching conditions, e.g., changing the KOH concentration and solution temperature during etching. This etching protocol, with a SiO₂ etching mask and homogeneous KOH etching provides a tip yield >99%. Since the wafer used in this experiment has a thickness variation of 10% (50±5 μm, NOVA Electronic Materials Ltd., TX), the tip height can vary up to 10%.

In one exemplary embodiment, Hard Spring Lithography tip arrays were formed using Si wafers (NOVA Electronic Materials; resistivity 1-10 Ω·cm, (100) orientation, 50±5 μm thick) with a 10,000-Å (±5%) SiO₂ layer on each side were used for fabricating the tip arrays. The wafers were cleaned in acetone and ethanol, and then rinsed with water before use. In preparing the elastomer base, PDMS and a curing agent (Sylgard 184 Silicone) were mixed in a 20:1 ratio (W/W), and then degassed under vacuum (10⁻³ torr) for 30 minutes. Oxygen-plasma-treated (30 W at a pressure of 100 mTorr) wafers were then placed on drop-coated PDMS on clean glass slides, followed by curing at 75° C. for 1 h. Before curing, the bubbles that can form at the interface between the wafer and the uncured PDMS must be removed with additional degassing. To create HSL arrays, an array of squares must be defined on the surface of the silicon wafer to act as etch masks. These squares must be between 120 and 140 μm on edge (depending on the thickness of the silicon wafer) and the edges of the squares and aligned along the Si layers <110> direction. This array of squares is created by photolithography then transferred into the silica layer to form a hard mask for wet etching. The photolithography proceeds by treating with oxygen plasma for 1 minute at 30 W, then spin coating photoresist (Shipley; S1805 positive photoresist) at 500 r.p.m. for 10 s followed by 4,000 r.p.m. for 60 s onto the wafer/PDMS/glass slide. After spin-coating, the photoresist was baked at 105° C. for 90 s due to the thermal insulation of the PDMS layer (on a conventional substrate this photoresist is usually baked for only 60 s). The photoresist/wafer/PDMS/glass slide was exposed (UV light source) through a photomask defining the etch mask and subsequently developed (15 s, Shipley; Micoposit MF-319 Developer and washed with water). The sample edge was passivated with PDMS to prevent etching in from the sides. The exposed SiO₂ was selectively etched in isotropic buffered hydrofluoric acid (Transene, 9% HF, BUFFER-HF Improved) etchant for 9 min in a polystyrene petri dish and then washed with water. To remove the photoresist, the wafer was cleaned in acetone, ethanol, and subsequently dried with flowing nitrogen. The wafer was then cleaned with oxygen plasma (1 min at 30 W at a pressure of 100 mTorr). Oxygen plasma cleaning prior to Si etching was found to improve the uniformity of the tips. Samples were immediately transferred into 40 wt % KOH (333 g KOH in 500 ml DI water) (KOH from Sigma-Aldrich; 99.99% metal basis, semiconductor grade, product no. 306568) at 75° C. and held in the centre of the etchant in a Teflon holder. The solution was continuously stirred to reduce the effect of micro-masking by hydrogen bubbles generated by the reaction at the Si surface. After 60-65 min, the sample was removed from the etchant, was rinsed in water, rinsed in ethanol, and then dried in air. As the etching rate of Si(100) in 40 wt % KOH at 75° C. is about 50 μm·h⁻¹, the minimum required thickness of SiO₂ was found to be 250 nm for an experimentally viable fabrication procedure, which motivated our choice for a 1 μm thick SiO₂layer.

Method of Coating the Tip Array with Graphene

In one embodiment of the disclosure, a micro probe having at least one tip is coated with a graphene film by immersing the at least one tip in a fluid in which a graphene film is floating on a surface thereof. The at least one tip can be immersed beneath the floating graphene film and then the graphene film can be brought into contact with the tip to thereby coat the tip. For example, the fluid can be evaporated to lower the graphene film into contact with the at least one tip. Alternatively, the at least one tip can be raised into contact with the graphene film. In various embodiments in which the micro probe includes a plurality of tips, all or a subset of tips can be immersed in the fluid to coat the immersed tips and immersed portions of the first side of the tip substrate layer with the graphene.

Optionally, prior to coating the tips can be cleaned or pre-treated. In one embodiment, the tips are oxygen plasma treated.

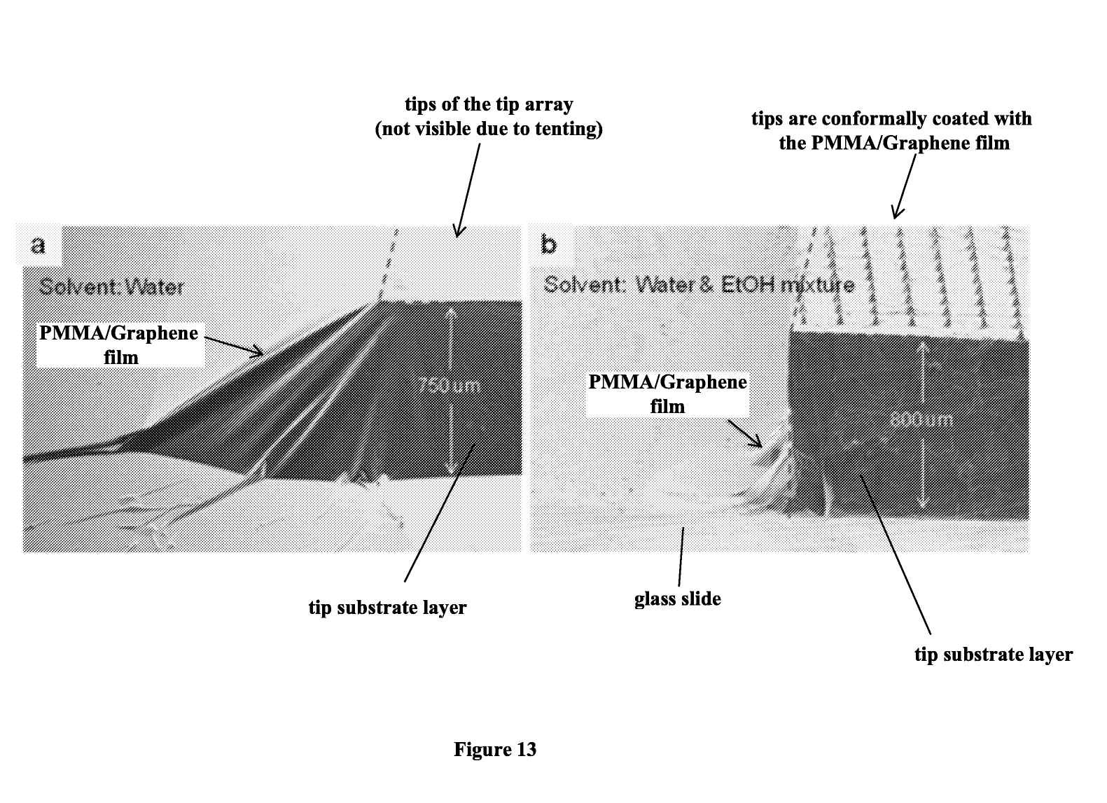

The fluid can comprise water and a surfactant to lower the surface tension of water. It has been advantageously found that a tenting phenomenon in which the graphene film tents over and does not conform to the at least one tip can be avoided when the surface tension of the fluid (such as water) is reduced. As illustrated in FIG. 13A, when coating in water having no surfactant a significant tenting phenomenon is observed, such that the graphene layer covers across the tip ends and does not conform to the tips. The tips of the tip array are not visible in FIG. 13A as a result of the tenting of the graphene film. By comparison, as illustrated in FIG. 13B, when a surfactant is added to the fluid to reduce the surface tension of the fluid, the tenting phenomenon is eliminated. In FIG. 13B, the graphene film conformed to the tips and the tips are, therefore visible in the image. Any suitable surfactant that is compatible and non-destructive to graphene and the tip material, and optionally a backing support layer (e.g. polymethylmethacrylate (PMMA)), can be provided with the fluid for floating graphene film. In one embodiment for use with water, the surfactant is ethanol.

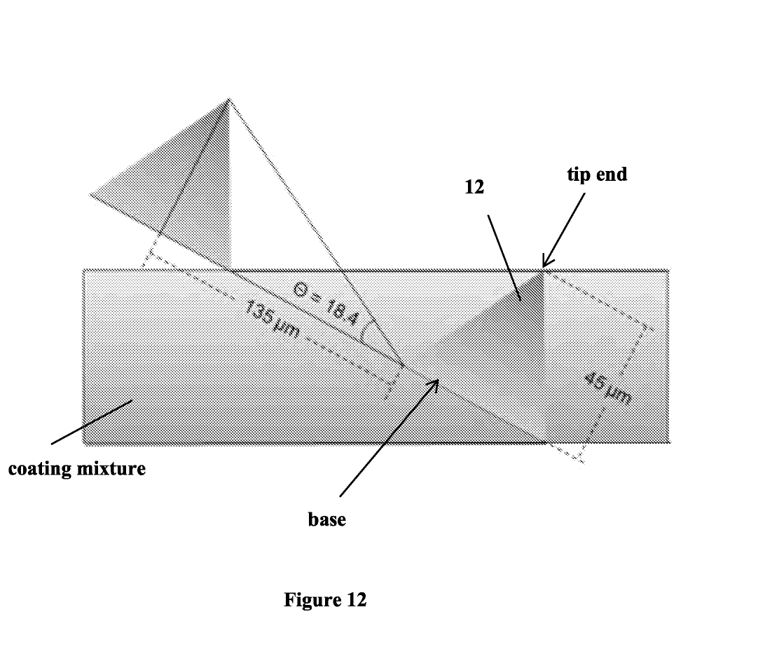

When immersed in the fluid, the tip or tip array can be angled relative to the surface of the fluid (and, thus, the floating graphene film), as measured from a plane parallel to the base of the tip. It has advantageously been determined that tilting the tip or tip array improves conformance of the graphene film to the tip or tip array. Referring to FIG. 12, tilting was advantageously found to maximize the coating coverage. Furthermore, in embodiments in which a tip array having a plurality of tips is coated, tilting of the tip array can allow for row by row coating of the tips with the graphene film as the graphene film is brought into contact with the tip array. The angling of the tip array also guides the graphene film across the tip array as the successive rows are coated. The degree of tiling can be dependent upon by the tip-to-tip distances, tip bottom diameter, and the tip height (also referred to herein as tip thickness), and suitable degrees can be determined through routine experimentation. For example, the tip or tip array can be tilted at least about 10° from the base of the tip, at least about 18°, at least about 20°, at least about 30°, or at least about 40° relative to the surface of the fluid. The angle optionally can be in a range of about 10° to about 80°, about 20° to about 70°, about 15° to about 60°, about 30° to about 60°, about 40° to about 80°, about 20° to about 40°, about 10° to about 30°, about 15° to about 45°, or about 25° to about 35°. Other suitable tilting angles include, about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 52, 54, 56, 58, 60, 62, 64, 66, 68, 70, 72, 74, 76, 78, or 80°.

The graphene film can include one or more layers of graphene as noted above. As used herein “graphene” refers to graphene as well as chemically- and electrochemically-modified graphene (e.g. covalent or non-covalent modifications). The graphene film can further include a support or backing layer when provided in the fluid. For example, the support layer can be PMMA. In embodiments in which the graphene film is provided with a support layer, the support layer can be washed away after the graphene film is coated on the at least one tip. For example, when PMMA is used a support layer, acetone can be used to remove the PMMA layer after the tip is coated.

The graphene film provided in the fluid optionally can be larger in size than the tip or tip array to be coated. The portion of the graphene sheet extending beyond the tip or the tip array in such an arrangement can be coated on a glass slide or cantilever supporting the tip or tip array. Such excess coating can advantageously be used as electrical contact points to electrically connect the graphene film and thereby the tip or tip array to a voltage source. This, in turn, can allow for a simple means of providing electro- or thermal-patterning functionality to the tips.

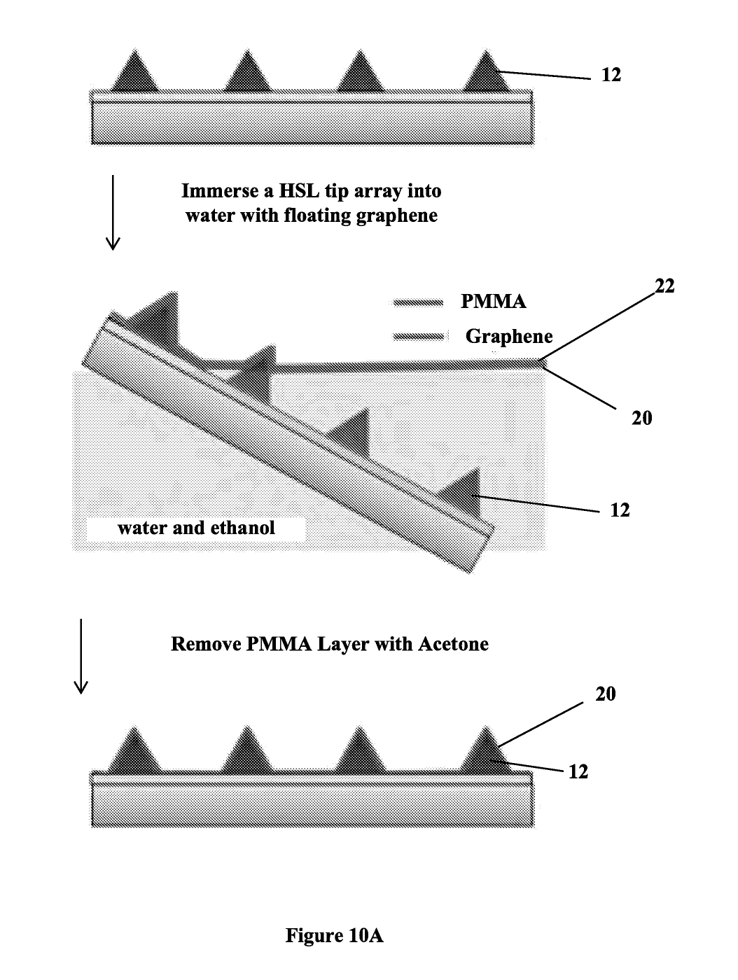

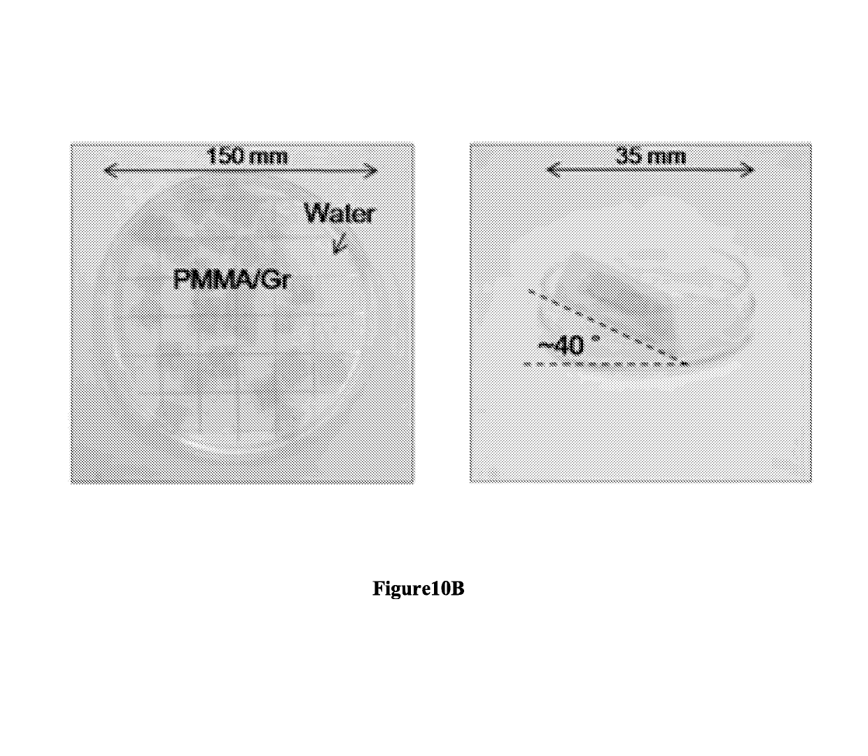

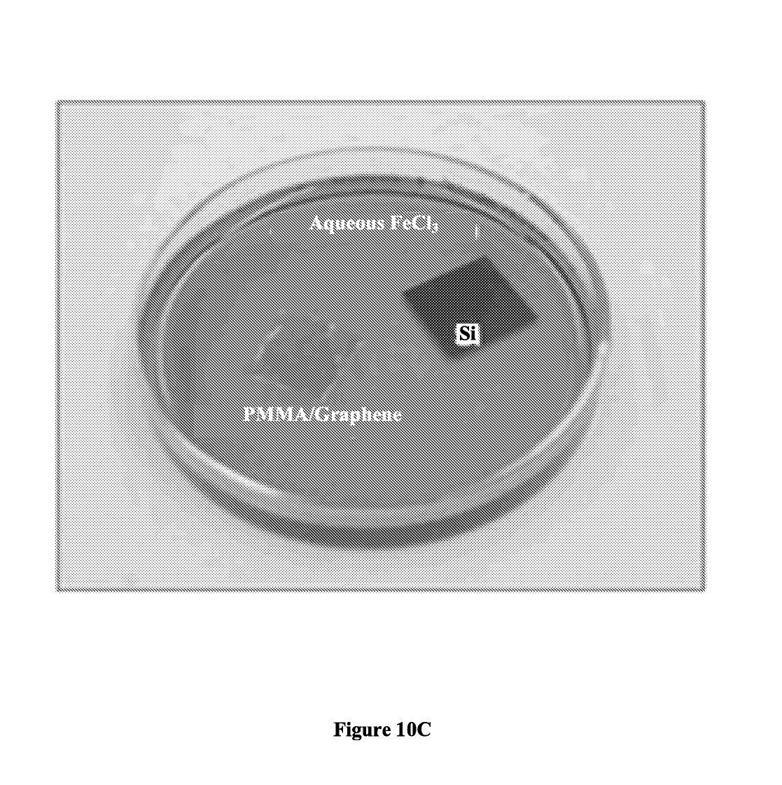

As proof of concept, as illustrated in FIG. 10, Hard Spring Lithography tip arrays were conformally coated with a multilayer film of graphene 20. In a typical experiment, 1×1 cm² HSL tip arrays with 4,490 tips and a tip-to-tip pitch of 150 μm were fabricated as described in paragraph 128 above. Referring to FIG. 10C, large-area graphene films grown by chemical vapor deposition (CVD) on Ni films (Graphene Laboratories Inc.) were used, and a thin poly(methylmethacrylate) (PMMA) 22 (about 70 nm) layer was spin coated on the graphene, acting as a supporting layer for the graphene upon the separation of the graphene from the Ni film. The PMMA/graphene was separated from the Ni film by etching away the Ni with a 1M FeCl₃ solution, and the PMMA/graphene was washed in DI water.

Following etching of the Ni film, the separated PMMA/graphene film was transferred onto a HSL tip array (1×1 cm²) having silicon tips that had been pre-treated with oxygen plasma. The transfer took place while the PMMA/graphene layer was floating on a mixture of water and ethanol (1:2 V/V). The HSL tip array was submerged in the liquid and held at an angle of about 40° with respect to the surface. The solvent was then allowed to evaporate, which caused the PMMA/graphene to fall onto the tip array and coat it conformally.

Tilting the array during the solvent evaporation process significantly improved the coverage of graphene onto the tip array (FIG. 12), while utilizing a mixture of the water and ethanol reduced the surface tension and improved the conformal coating (FIG. 13B). Subsequent washing with acetone was used to remove the PMMA. The graphene-coated, glass-supported tip arrays remained transparent (FIG. 1d), which allowed for optical leveling of the tips with respect to a surface.

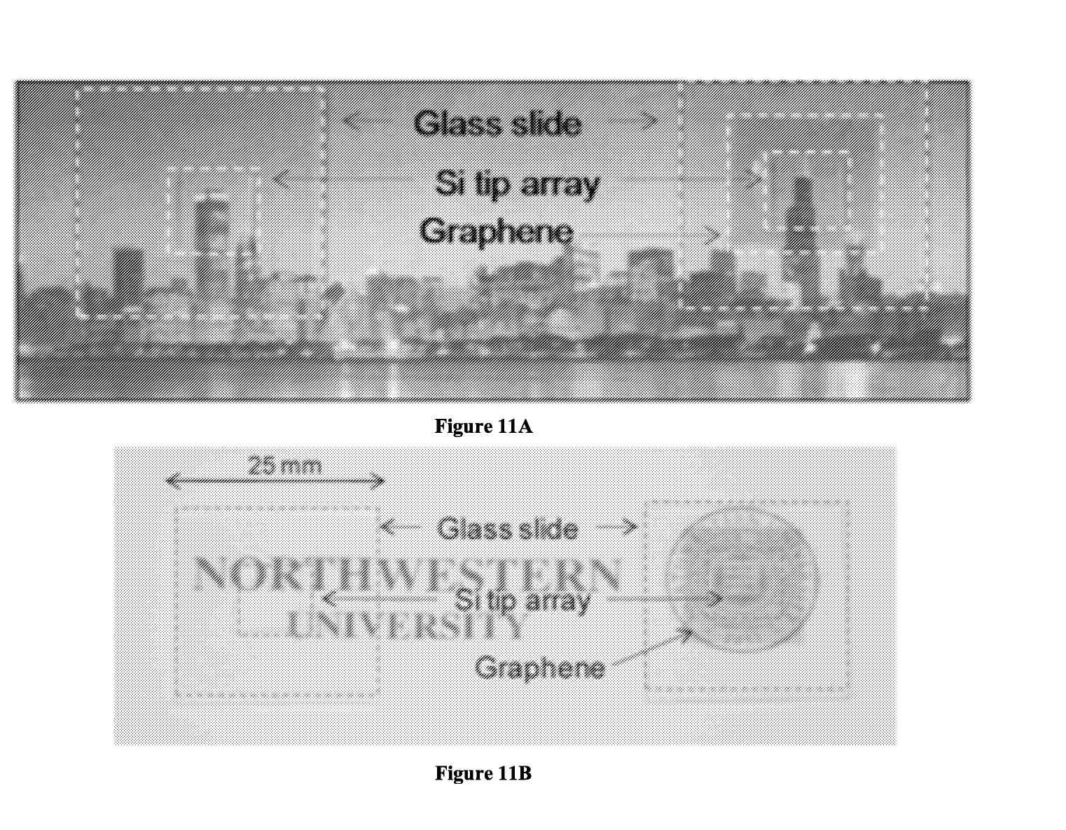

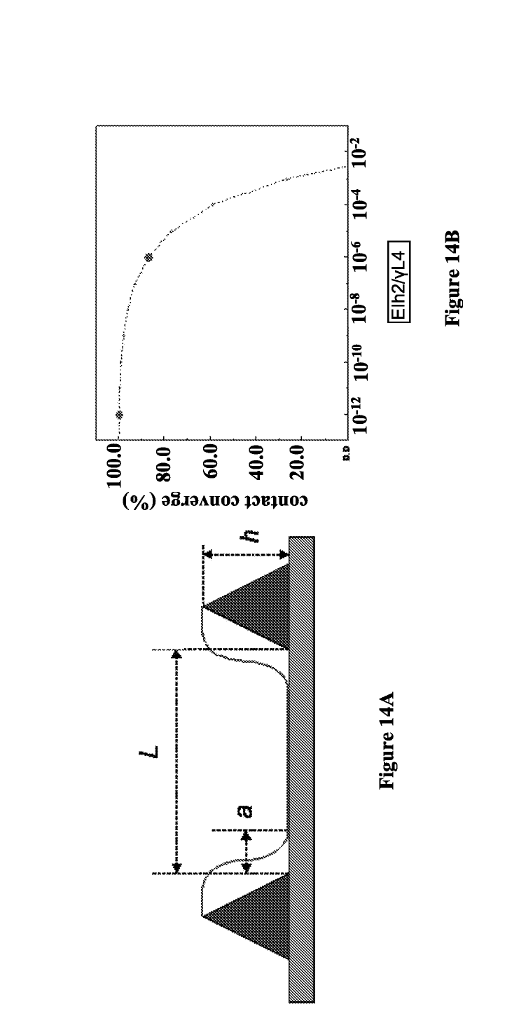

Due to the high adhesion energy of graphene relative to its bending energy, the graphene established conformal coverage of the tip surface. FIG. 14 illustrates a model demonstrating the ability of graphene to conform to a tip based on studies of graphene sagging, using a beam bending model. Kim et al., Stretchable, transparent graphene interconnects for arrays of microscale inorganic light emitting diodes on rubber substrates, 11 Nano. Lett. 3881-86 (2011). The model illustrated in FIG. 14A for a tip has an even smaller uncoated length a as compared to the previous study because of the shape of the tip. Thus, the contact coverage in the previous study, defined by A=(L-2a)/L−1-2[18 EIh²/γL⁴]^{1/4} can be expected to be even higher than the estimated values shown in FIG. 14B. The graphene-coated, glass-supported tip arrays remain transparent (FIG. 11), which allowed for optical leveling of the tips with respect to a surface.

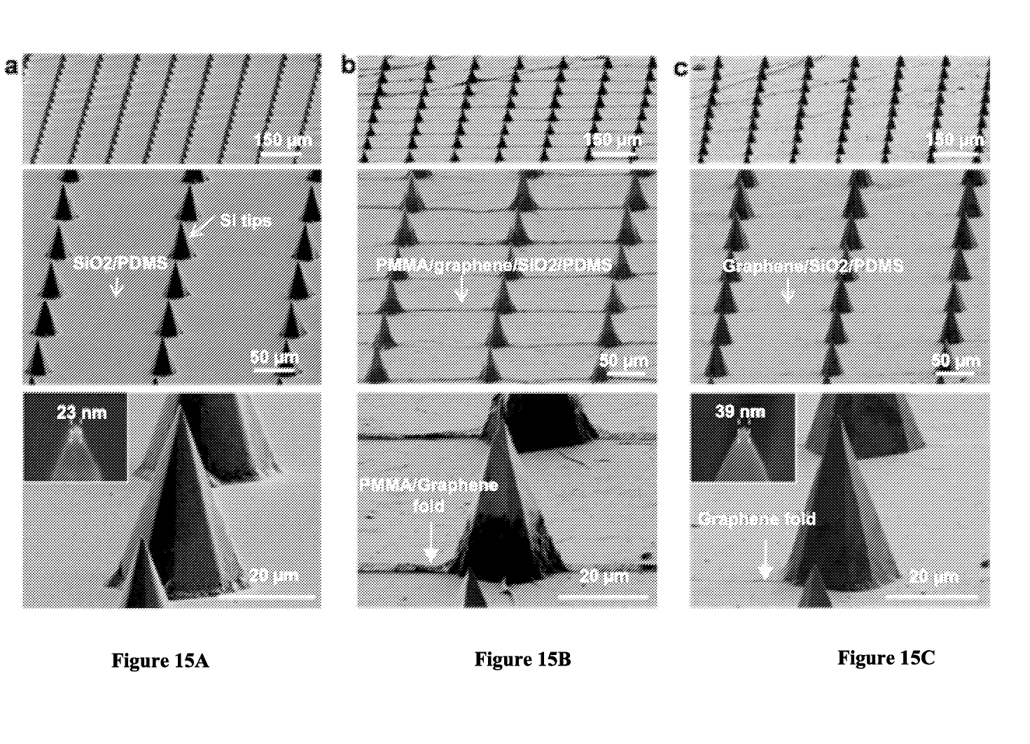

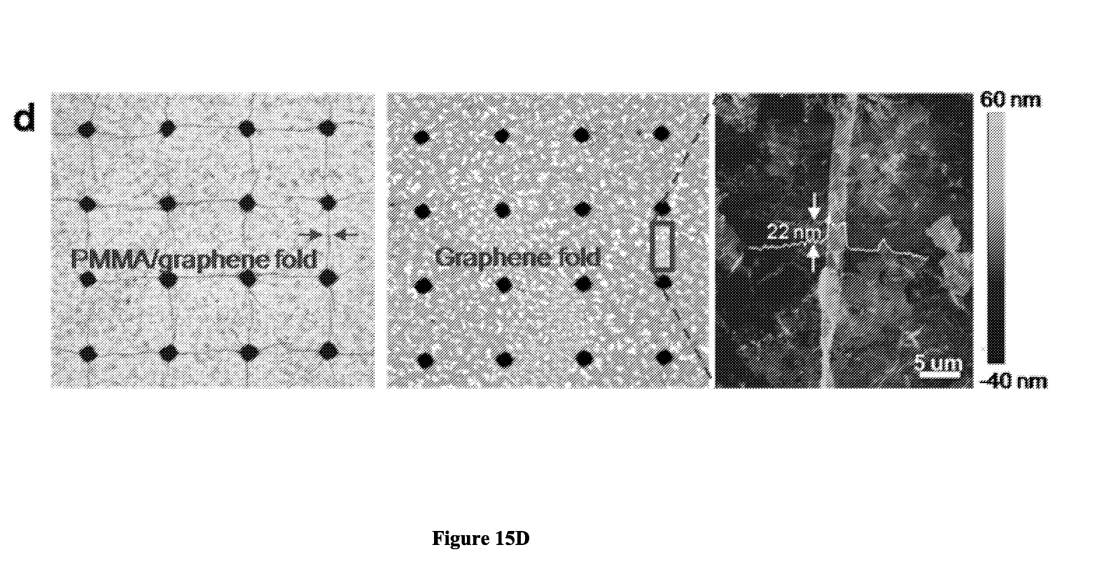

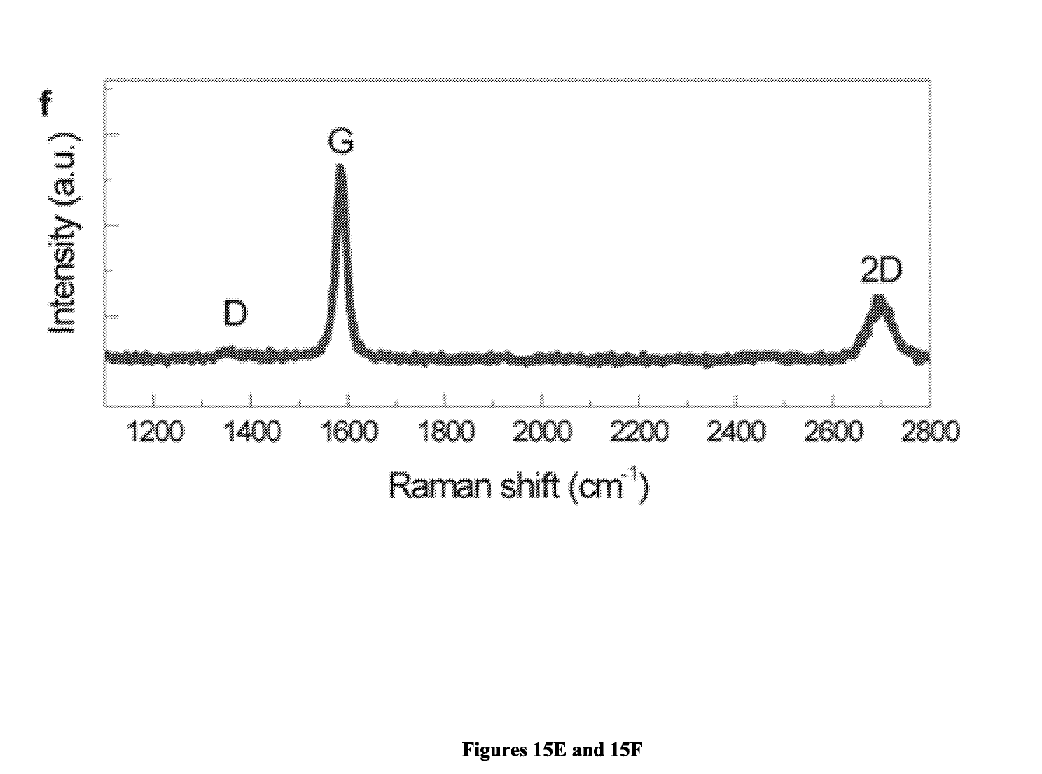

Graphene can advantageously conform to the complex surface topography of the tip array. In particular, the adhesion of graphene to a tip of a tip array is stronger than its bending rigidity, so it will preferentially coat the surface. Referring to FIGS. 15c and 15d, this feature is evidenced in the lack of suspended graphene sheets for coated tips. This effect can be estimated through the ratio of the bending energy to the adhesion energy EIh²/γL⁴ where EI is the bending rigidity, h is the height of the Si tips, L is the pitch, and γ is the work of adhesion between graphene and SiO₂ (per unit area). Since the initial adhesion will be dominated by the thick PMMA supporting layer, we estimate EI=10⁻¹³ for 100 nm thick PMMA³, h=40 μm, L=150 μm, and γ=0.31 J/m² to find EIh²/γL⁴ about 10⁻⁶, indicating that the film is expected to sag and conform to the surface (Sagging of graphene onto SiO₂ occurs when EIh²/γL⁴<0.001). On removing the PMMA, the graphene layer is expected to become less rigid (EIh²/γL⁴ about 10⁻¹²), and thus completely conform to the surface. The percent of the tip array surface covered by graphene is given by 1-2[18EIh²/γL⁴]^{1/4} and is calculated to be 99 and 86% for graphene and PMMA (70 nm)/graphene, respectively. These results show that, after removal of the PMMA, the graphene is expected to nearly perfectly coat the tip array. The exceptionally high adhesion between the graphene and the surface of the tip also prevents the graphene from being detached from the tip array. It is also worth noting that the ability of graphene to fold on the surface of the graphene-coated micro probe can advantageously make the graphene film mechanically stable when deformed during writing.

Low flexural rigidity also leads to surface wrinkles when a layer experiences small compressive strain during the coating of a flat surface. On further compression that can arise from coating an uneven surface, the wrinkles become unstable and new morphologies emerge, namely folds. Folds are observed between tips. This repetitive fold formation between the tips finally generates a network of folds that completely connect tip to tip, thus indicating complete coverage of even PMMA/graphene. Once the PMMA layer is removed, the flexural rigidity decreases and the graphene experiences more mechanical sagging to the surface. Indeed, as the network of folds formed by PMMA/graphene can be clearly seen, the graphene fold network can only be imaged by AFM and is not clearly observable under an optical microscope. This excellent flexibility of graphene, which allows it to conform to the surface, leads to ultra-strong adhesion to the tip surface, owing to the graphene's interaction with the surface being more liquid-like than solid-like. Furthermore, the folds make the graphene layers more stable and resistant to mechanical stretching by making the layers more expandable, thus more coherently coupling the graphene to the tips during writing.

### Electrical Properties of the Graphene Coated Tips

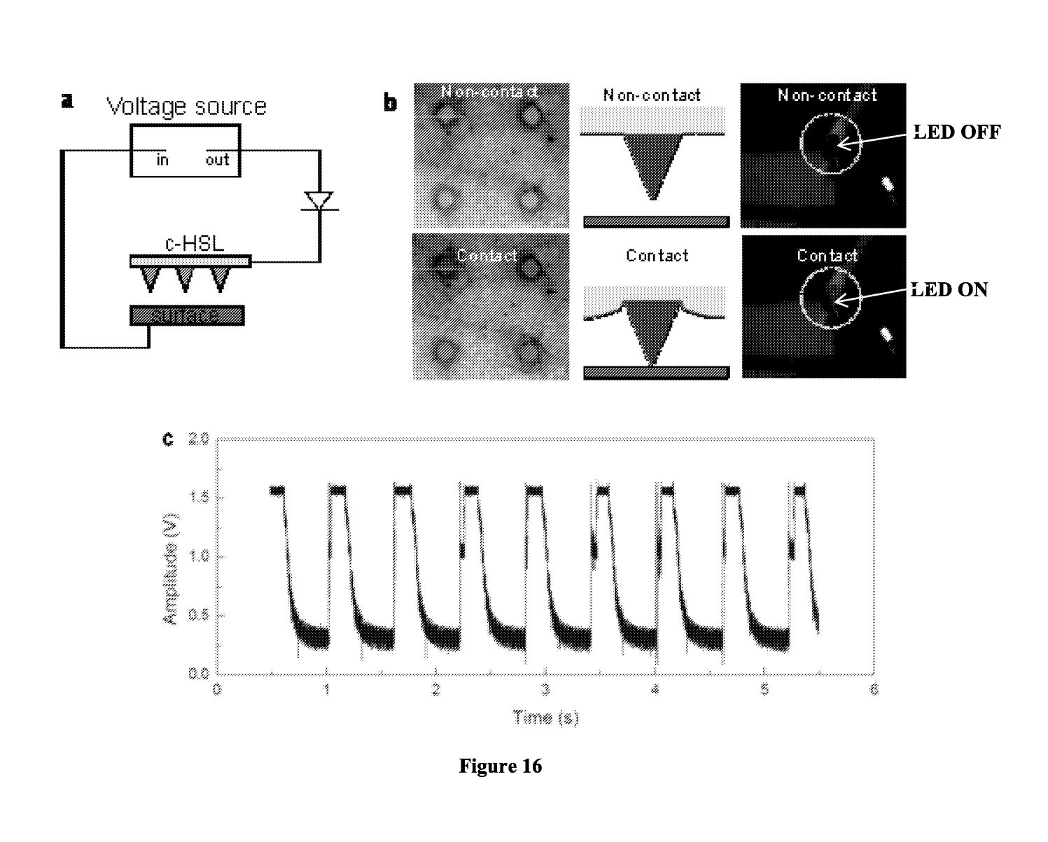

Referring to FIG. 16, the electrical performance of the graphene-coated HSL tip arrays was visually demonstrated using a light-emitting diode (LED). A LED containing circuit was setup such that when a graphene-coated HSL tip array was brought into contact with a highly-doped conductive Si surface the circuit was completed and the LED turned on. FIG. 16A illustrates a schematic diagram of an LED circuit used to verify contact with the surface. When in contact with the surface, the graphene layers on a tip array are expected to be mechanically deformed because of the spring-like PDMS layer, but the graphene-coated HSL-LED circuit was demonstrated to successfully operate for several hundred cycles of bringing the tips in and out of contact with the surface. This is because graphene is a stretchable and foldable electrode which can accommodate large levels of strain without damage to the electrical contact. Indeed, the voltage-time response of the graphene-coated HSL-LED circuit shows switching between a low and high voltage state as the graphene-coated HSL array comes into contact with the surface. FIG. 16B is an optical image of non-contact and contact of the tip with a highly doped Si surface and corresponding LED operation. FIG. 16C illustrates the electrical response of the tip-surface circuit.

### Evaluation of the Graphene Coating

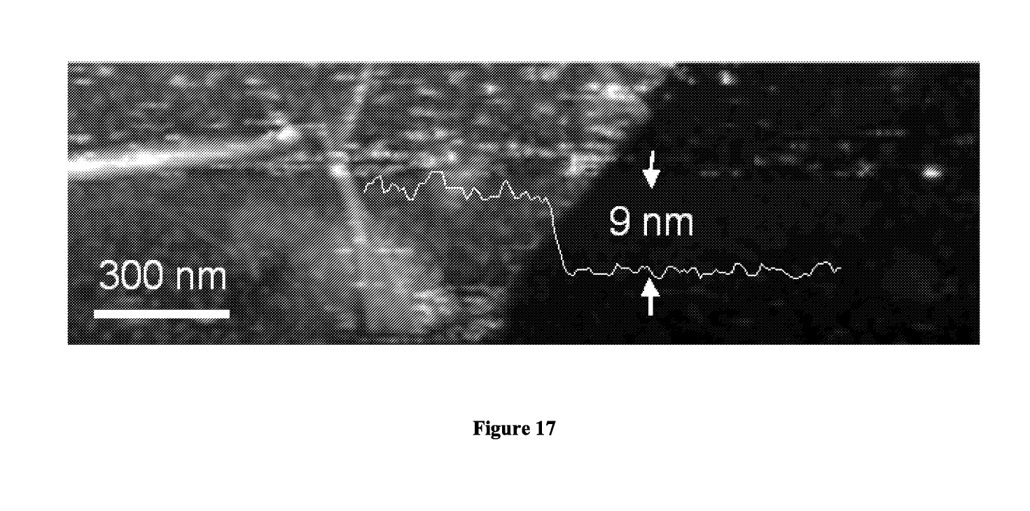

To evaluate the uniform and conformal graphene-coating of HSL tip arrays, scanning electron microscopy (SEM) and Raman spectroscopy were performed. Prior to graphene coating, the HSL tip array exhibited a smooth and uniform elastomer surface (FIG. 15A). After coating with PMMA/graphene, folds and creases were visible on the surface of the elastomer (FIG. 15B). When the PMMA was removed, the surface appeared cleaner, but folds remained visible, providing evidence for the presence of graphene (FIG. 15C). There was no significant change in the tip height throughout the coating process, but the tip diameter increased from 23±3 to 40±5 nm after graphene coating, an increase commensurate with the measured about 9 nm thickness of the 10-20 layer graphene film (FIG. 17). Optical microscopy confirmed the presence of PMMA/graphene on the surface of the HSL array, as one could easily see a network of folds that formed a regular lattice with vertices defined by the tips (FIG. 15D). Note that “tenting” is not observed and the folding provides additional flexibility when the PDMS supporting the tips is compressed during writing. Once the PMMA was removed in acetone, the folds were still present, but could only be visualized by atomic force microscopy (FIG. 15D). Raman spectroscopy (532-nm excitation) was used to provide direct evidence for the presence of graphene at the tips of the probes in the HSL array. Raman mapping of the Si band (499 to 546 cm⁻¹) clearly depicts the form of a single Si tip resting on a flat SiO₂ surface (FIG. 15E top). Mapping of the graphene G-band (1569 to 1614 cm⁻¹) in the same region shows the triangular shape of the tip as well as a flat supporting backing layer (FIG. 15E bottom). The colocalization of the Si and graphene bands provides evidence for the conformal coating of graphene layers onto the HSL tip array. Furthermore, a spectrum taken on the tip shows a broad 2D band, and more intense G band, I(G)>I(2D), which is characteristic of multiple graphene layers^{21,22} (FIG. 15F).

Patterning with the Coated Micro Probes

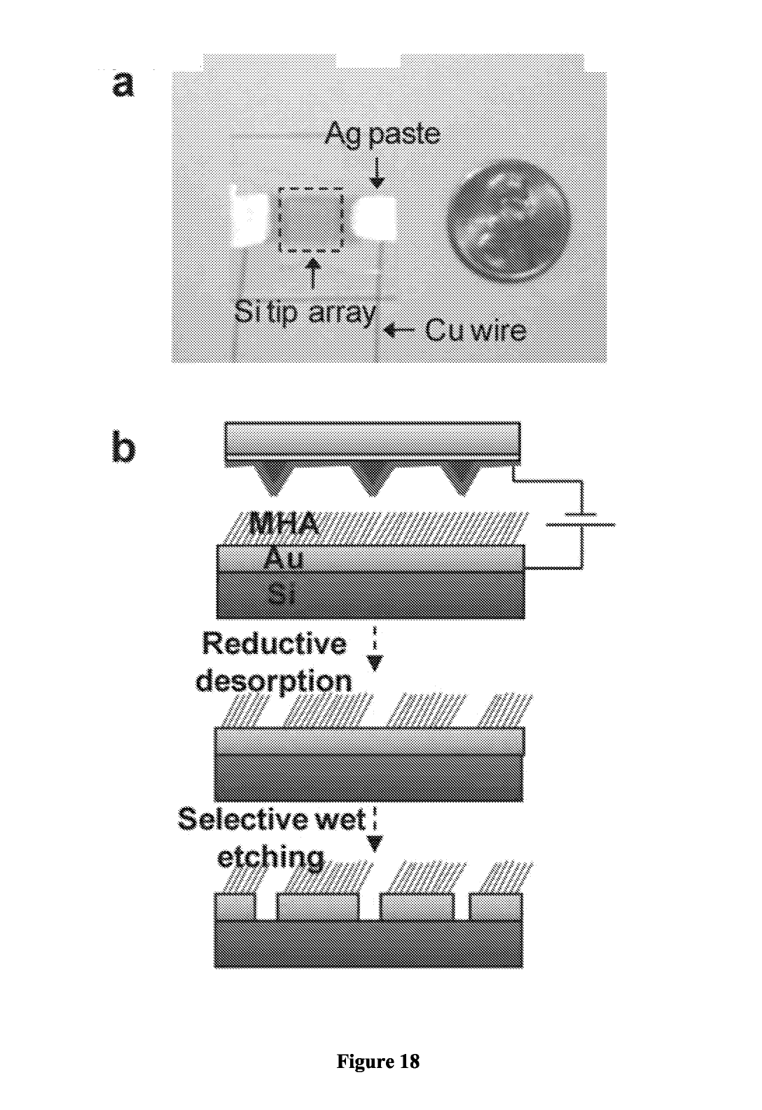

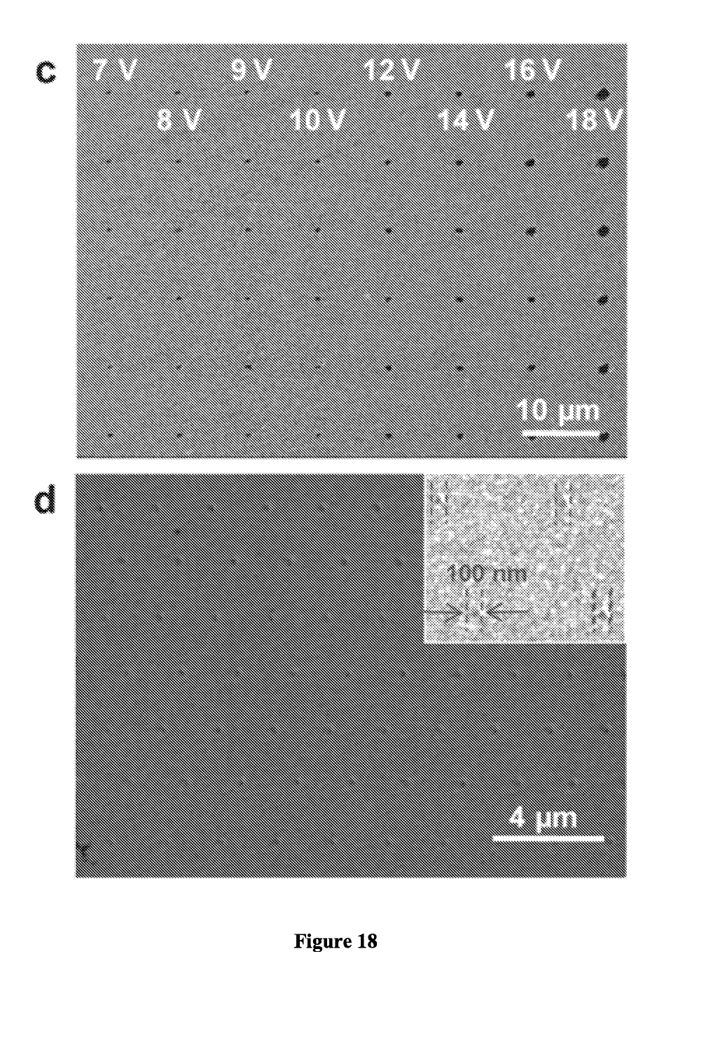

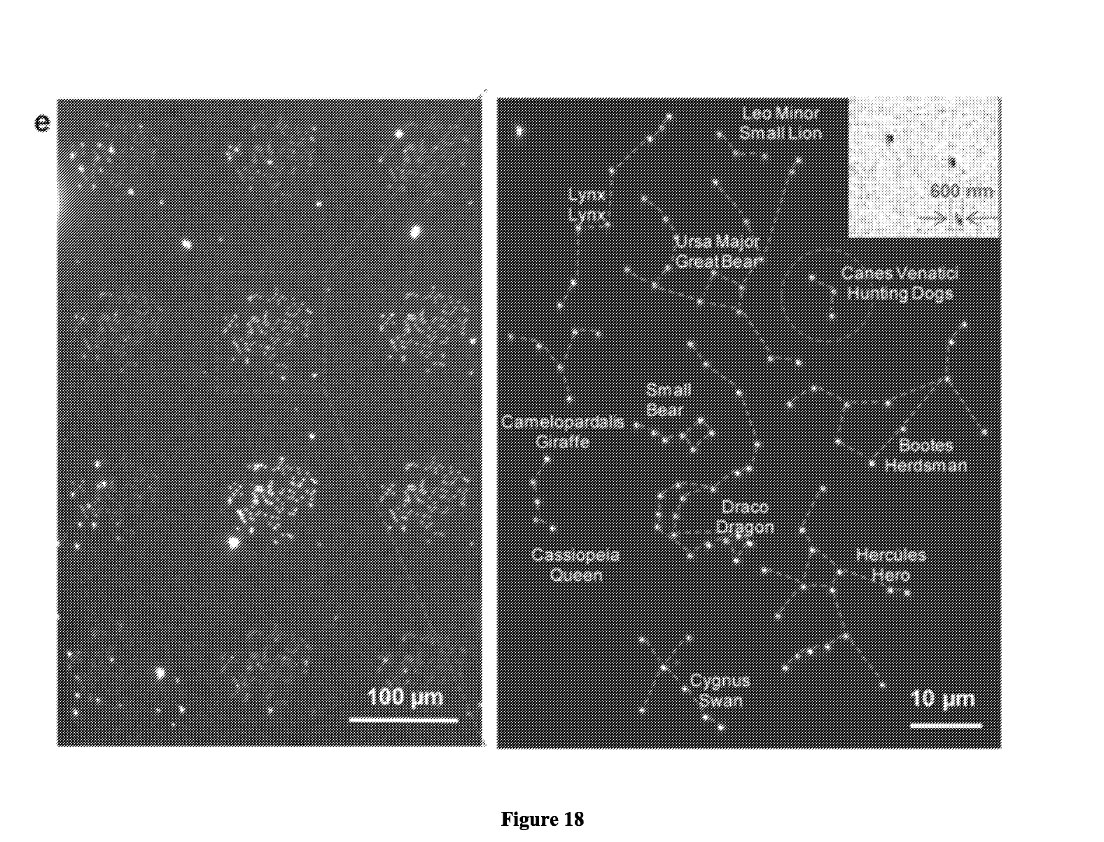

The graphene coating of the micro probe can transform the micro probe from a technique limited to DPN and nanografting to one capable of lithographic methods that require probes with high electrical conductivity. For example, electrical contact can be readily made with regions of the graphene film extending beyond the tip or tip array (FIG. 18a). Electrical contact was verified by measuring a current that flows through the tips and into the substrate when the tip array is in contact with the surface (FIG. 16).

The ability of a graphene-coated micro probe to conduct electricity, in principle, allows one to use an electric field and a variety of lithography methods, such as polymer pen lithography, gel pen lithography, hard tip spring lithography, and beam pen lithography to electrochemically desorb an electrically sensitive substrate, such as for example, alkanethiolate self-assembled monolayer (SAM) from an Au surface.

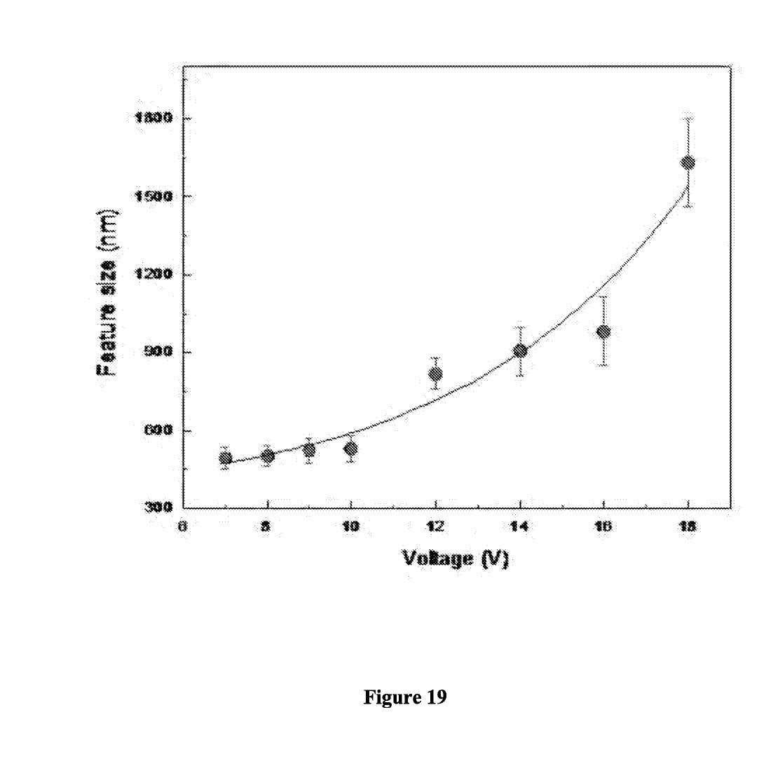

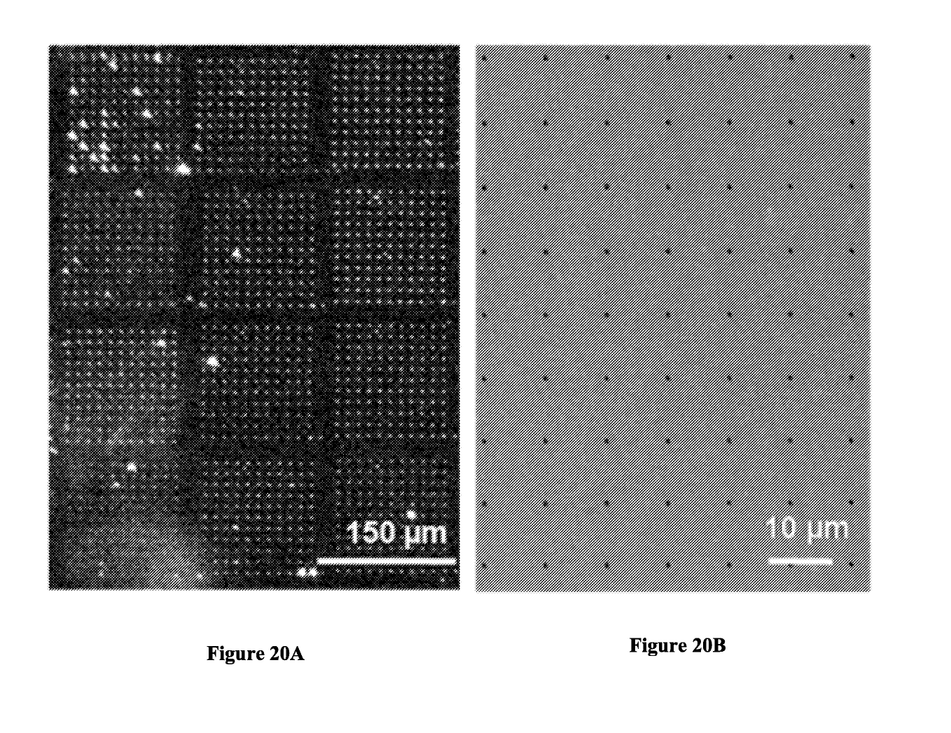

To evaluate the electrochemical desorption patterning using the coated micro probes, SAMs were prepared by soaking an Au-coated silicon wafer in an ethanol solution of 16-mercaptohexadecanoic acid (MHA, 1 mM) for 1 hour followed by copious rinsing with ethanol and drying under N₂. A negative bias voltage was applied to a graphene-coated HSL tip arrays with respect to the SAM-modified Au surface (FIG. 18b). To investigate the effect of tip voltage on feature size, the tip array was used to pattern a square lattice of points with a constant dwell time of 10 s while the tip bias voltage was varied from 7 to 18 V (FIG. 18c). Following patterning, the surface was chemically etched to remove the Au in patterned regions where there was no longer a protective SAM. Recessed areas, which correspond to patterned spots, are observed, and the average feature diameter exhibits an exponential dependence on reductive potential (FIG. 19). These observations are consistent with a kinetic model for the reductive desorption of an alkanethiol SAM. To evaluate the ability of this method to generate smaller features, the tip-surface contact time was reduced to 5 s with a voltage of 5 V. Features made in this process exhibit an average feature diameter of 98±7 nm (FIG. 18d). The ability to generate arbitrary patterns with graphene-coated HSL tip arrays was demonstrated by reproducing a dot array (FIG. 20) depicting a portion of the constellations in the northern hemisphere. In this proof-of-concept experiment, the resulting etched Au pattern generated by each of the 4,490 tips in the 1×1 cm² arrayis an accurate miniaturized duplication (80×100 μm²) of the bit map image with an average dot diameter of 591±62 nm (FIG. 18e).

### Thermal Patterning

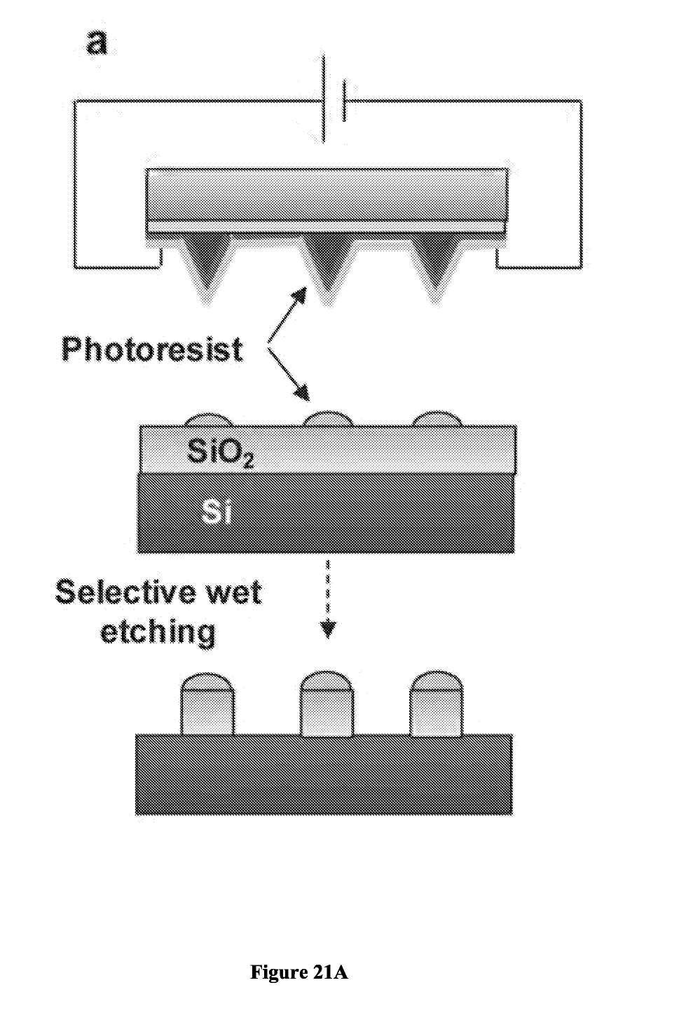

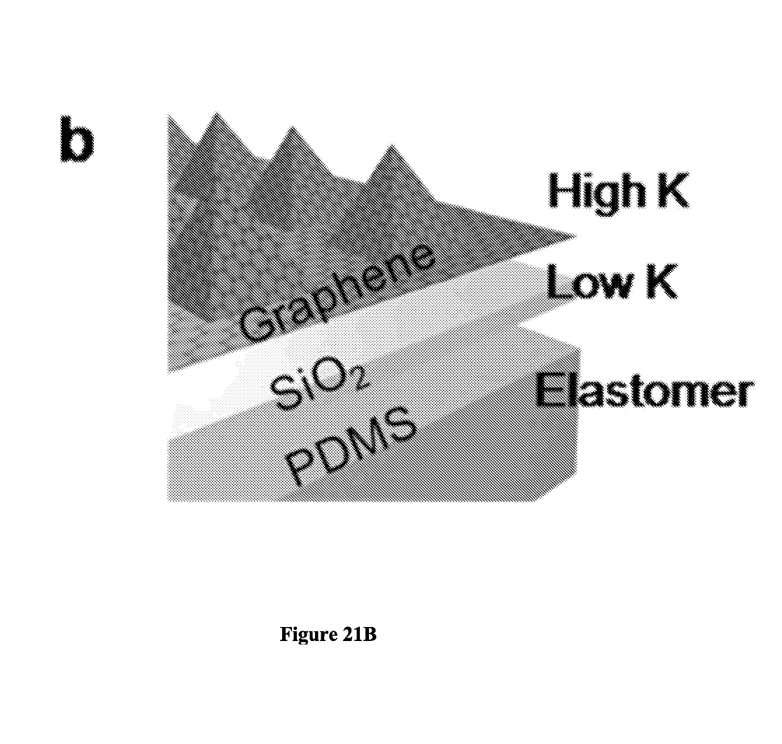

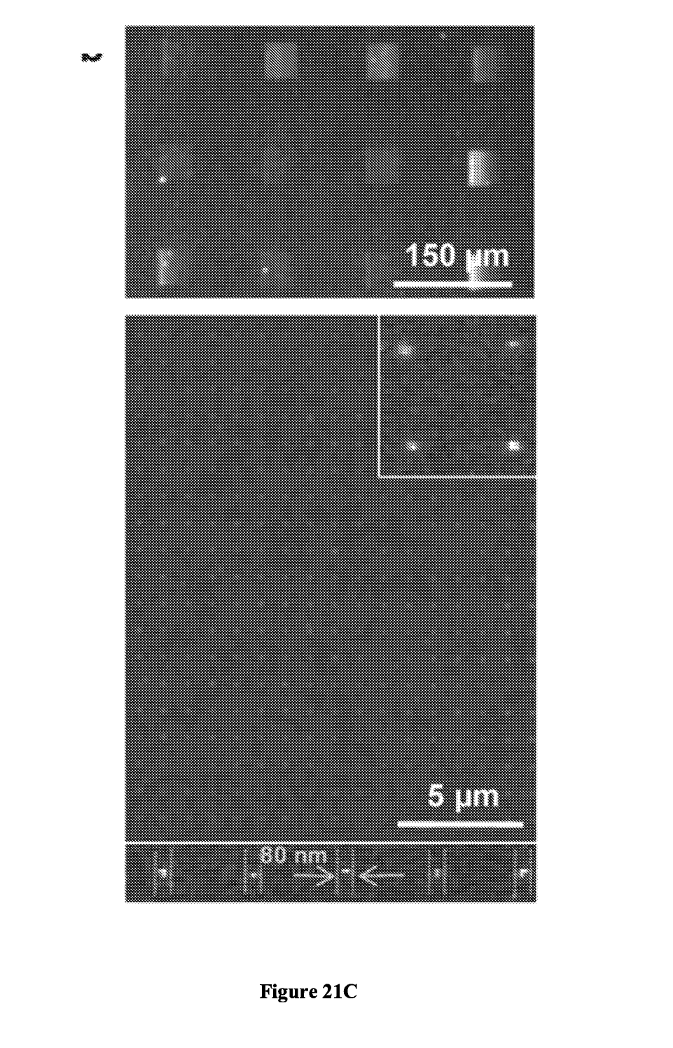

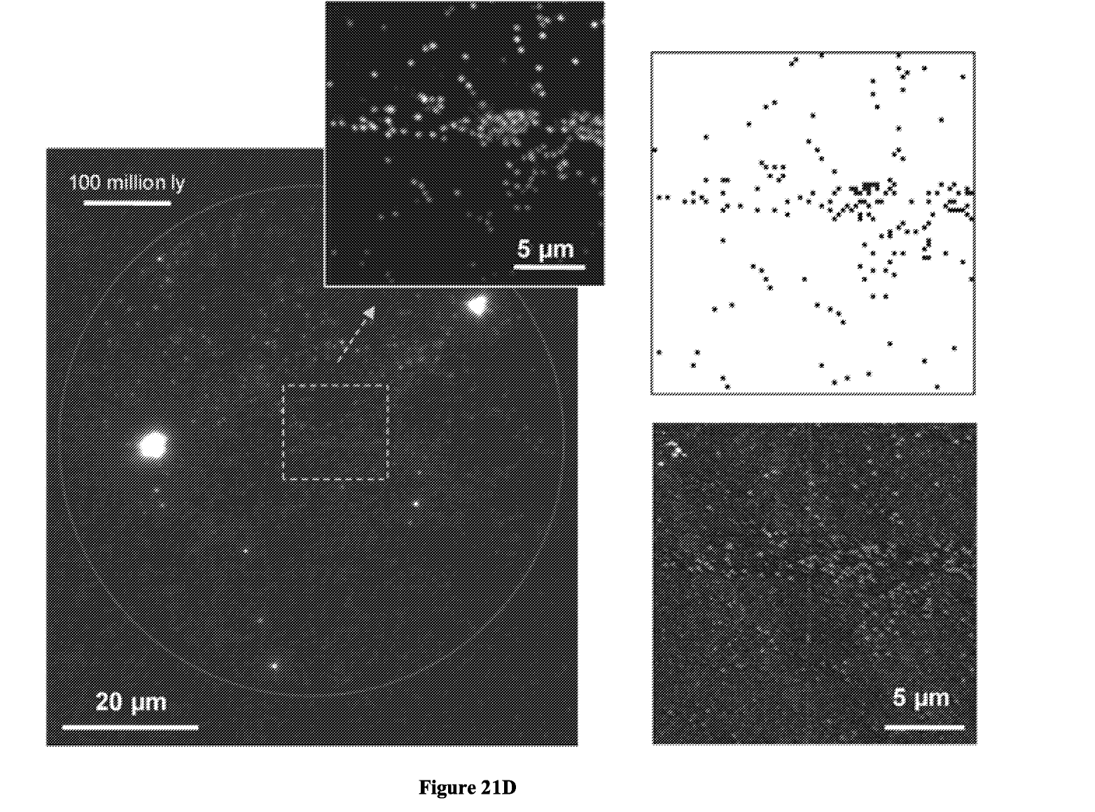

The presence of a conducting graphene layer coating, not only on the tips but also on the tip substrate layer of the tip array or the cantilever can allow for the application of a potential and drive an electrical current across the array, which can be used to locally heat the tip or tips through resistive heating. This heating effect was demonstrated by applying a polymer mask using graphene-coated HSL arrays via thermal-DPN (FIG. 21A). For example, in one exemplary embodiment, a photoresist (Shipley, S1805) was coated onto the tip array by drop casting, followed by solvent evaporation for 30 min at room-temperature. This resist was chosen because of its relatively low glass transition temperature (about 60° C.) and widespread use in semiconductor processing. Since the photoresist is a glass at room temperature, when the tip array was pressed against a silicon surface, no material was transferred to the surface. In contrast, when it was pressed against the surface while 15 mW of electrical power is applied to the tip array, the resist uniformly transferred to the substrate.

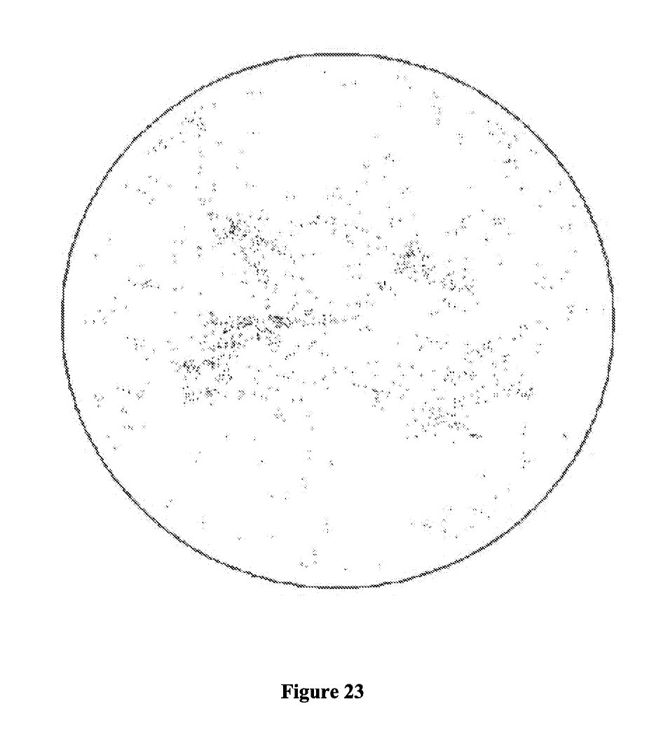

As proof-of-concept, using a graphene-coated HSL array consisting of 4,490 tips, dot patterns were created on Si wafers coated with 15 nm of SiO₂. The pattern covers a 1 cm² area and consists of over 11 million dot features, with each tip responsible for making 2,601 dots (based upon a contact time of 1 s and a relative humidity of 30%). Importantly, the polymer pattern can be transferred into the SiO₂ substrate by etching with ammonium fluoride (20% NH₄F, Time Etch, Transene) (FIG. 21C). The resulting average feature size was determined by SEM to be 80±9 nm, and the arbitrary patterning capability of this technique was further demonstrated by generating 4,490 duplicates of a pattern depicting constellations (FIGS. 21D and FIG. 23). The average feature diameter was determined by AFM to be 170±20 nm.

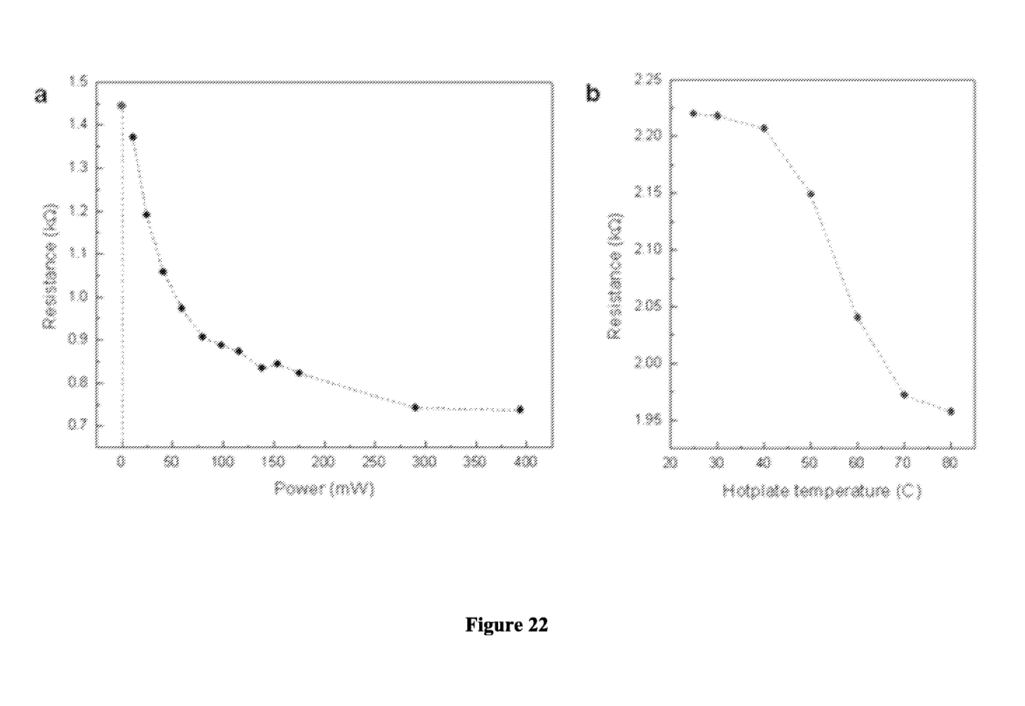

Since a relatively low applied power was necessary to achieve thermal transport, measurements of the thermal coefficient of resistance were performed to estimate the average temperature of the graphene film. To examine how the electrical resistance of the graphene film changes with temperature, the resistance of the graphene was measured while the temperature of the graphene-coated HSL tip array was adjusted on a hot plate. This provides a measure of the temperature coefficient of resistance (TCR) κ which was determined to be 3×10⁻³/K (FIG. 22), in good agreement with previous reports. The temperature in the graphene film was then estimated by recording the change in resistance ΔR of the graphene resistor as a function of applied power (FIG. 22). For example, when 24 mW of power was applied to a 1 cm² graphene-coated HSL tip array, ΔR/R=−0.18, which corresponds to ΔT=58° C. when converted using κ. This large temperature change in response to modest applied power is attributed to the graphene resistor being sandwiched between thermally insulating SiO₂/PDMS and photoresist layers, localizing the heat generation to the graphene.

### Patterning Compositions

For ink-based patterning, patterning compositions suitable for use in the disclosed methods include both homogeneous and heterogeneous compositions, the latter referring to a composition having more than one component, for example combinations of any one or more of the components described herein. The patterning composition is coated on the tip array. The term “coating,” as used herein when referring to the patterning composition, refers both to coating of the tip array as well adsorption and absorption by the tip array of the patterning composition. Upon coating of the tip array with the patterning composition, the patterning composition can be patterned on a substrate surface using the tip array.

Patterning compositions can be liquids, solids, semi-solids, and the like. Patterning compositions suitable for use include, but are not limited to, molecular solutions, polymer solutions, pastes, gels, creams, glues, resins, epoxies, adhesives, metal films, particulates, solders, etchants, and combinations thereof.

Patterning compositions can include materials such as, but not limited to, monolayer-forming species, thin film-forming species, oils, colloids, metals, metal complexes, metal oxides, ceramics, organic species (e.g., moieties comprising a carbon-carbon bond, such as small molecules, polymers, polymer precursors, proteins, antibodies, and the like), polymers (e.g., both non-biological polymers and biological polymers such as single and double stranded DNA, RNA, and the like), polymer precursors, dendrimers, nanoparticles, and combinations thereof. In some embodiments, one or more components of a patterning composition includes a functional group suitable for associating with a substrate, for example, by forming a chemical bond, by an ionic interaction, by a Van der Waals interaction, by an electrostatic interaction, by magnetism, by adhesion, and combinations thereof.

The composition can be formulated to control its viscosity, via routine methods without undue experimentation. Parameters that can control ink viscosity include, but are not limited to, solvent composition, solvent concentration, thickener composition, thickener concentration, particles size of a component, the molecular weight of a polymeric component, the degree of cross-linking of a polymeric component, the free volume (i.e., porosity) of a component, the swellability of a component, ionic interactions between ink components (e.g., solvent-thickener interactions), and combinations thereof.

In some embodiments, the patterning composition comprises an additive, such as a solvent, a thickening agent, an ionic species (e.g., a cation, an anion, a zwitterion, etc.), a carrier matrix (e.g., polyethylene glycol or agarose), the concentration of which can be selected to adjust one or more of the viscosity, the dielectric constant, the conductivity, the tonicity, the density, and the like.

Suitable thickening agents include, but are not limited to, metal salts of carboxyalkylcellulose derivatives (e.g., sodium carboxymethylcellulose), alkylcellulose derivatives (e.g., methylcellulose and ethylcellulose), partially oxidized alkylcellulose derivatives (e.g., hydroxyethylcellulose, hydroxypropylcellulose and hydroxypropylmethylcellulose), starches, polyacrylamide gels, homopolymers of poly-N-vinylpyrrolidone, poly(alkyl ethers) (e.g., polyethylene oxide, polyethylene glycol, and polypropylene oxide), agar, agarose, xanthan gums, gelatin, dendrimers, colloidal silicon dioxide, lipids (e.g., fats, oils, steroids, waxes, glycerides of fatty acids, such as oleic, linoleic, linolenic, and arachidonic acid, and lipid bilayers such as from phosphocholine) and combinations thereof. In some embodiments, a thickener is present in a concentration of about 0.5% to about 25%, about 1% to about 20%, or about 5% to about 15% by weight of a patterning composition.

Suitable solvents for a patterning composition include, but are not limited to, water, C1-C8 alcohols (e.g., methanol, ethanol, propanol and butanol), C6-C12 straight chain, branched and cyclic hydrocarbons (e.g., hexane and cyclohexane), C6-C14 aryl and aralkyl hydrocarbons (e.g., benzene and toluene), C3-C10 alkyl ketones (e.g., acetone), C3-C10 esters (e.g., ethyl acetate), C4-C10 alkyl ethers, and combinations thereof. In some embodiments, a solvent is present in a concentration of about 1% to about 99%, about 5% to about 95%, about 10% to about 90%, about 15% to about 95%, about 25% to about 95%, about 50% to about 95%, or about 75% to about 95% by weight of a patterning composition.

Patterning compositions can comprise an etchant. As used herein, an “etchant” refers to a component that can react with a surface to remove a portion of the surface. Thus, an etchant is used to form a subtractive feature by reacting with a surface and forming at least one of a volatile and/or soluble material that can be removed from the substrate, or a residue, particulate, or fragment that can be removed from the substrate by, for example, a rinsing or cleaning method. In some embodiments, an etchant is present in a concentration of about 0.5% to about 95%, about 1% to about 90%, about 2% to about 85%, about 0.5% to about 10%, or about 1% to about 10% by weight of the patterning composition.

Etchants suitable for use in the methods disclosed herein include, but are not limited to, an acidic etchant, a basic etchant, a fluoride-based etchant, and combinations thereof. Acidic etchants suitable for use with the present invention include, but are not limited to, sulfuric acid, trifluoromethanesulfonic acid, fluorosulfonic acid, trifluoroacetic acid, hydrofluoric acid, hydrochloric acid, carborane acid, and combinations thereof. Basic etchants suitable for use with the present invention include, but are not limited to, sodium hydroxide, potassium hydroxide, ammonium hydroxide, tetraalkylammonium hydroxide ammonia, ethanolamine, ethylenediamine, and combinations thereof. Fluoride-based etchants suitable for use with the present invention include, but are not limited to, ammonium fluoride, lithium fluoride, sodium fluoride, potassium fluoride, rubidium fluoride, cesium fluoride, francium fluoride, antimony fluoride, calcium fluoride, ammonium tetrafluoroborate, potassium tetrafluoroborate, and combinations thereof.

The patterning composition can include a reactive component. As used herein, a “reactive component” refers to a compound or species that has a chemical interaction with a substrate. In some embodiments, a reactive component in the ink penetrates or diffuses into the substrate. In some embodiments, a reactive component transforms, binds, or promotes binding to exposed functional groups on the surface of the substrate. Reactive components can include, but are not limited to, ions, free radicals, metals, acids, bases, metal salts, organic reagents, and combinations thereof. Reactive components further include, without limitation, monolayer-forming species such as thiols, hydroxides, amines, silanols, siloxanes, and the like, and other monolayer-forming species known to a person or ordinary skill in the art. The reactive component can be present in a concentration of about 0.001% to about 100%, about 0.001% to about 50%, about 0.001% to about 25%, about 0.001% to about 10%, about 0.001% to about 5%, about 0.001% to about 2%, about 0.001% to about 1%, about 0.001% to about 0.5%, about 0.001% to about 0.05%, about 0.01% to about 10%, about 0.01% to about 5%, about 0.01% to about 2%, about 0.01% to about 1%, about 10% to about 100%, about 50% to about 99%, about 70% to about 95%, about 80% to about 99%, about 0.001%, about 0.005%, about 0.01%, about 0.1%, about 0.5%, about 1%, about 2%, or about 5% weight of the patterning composition.

The patterning composition can comprise a conductive and/or semi-conductive component. As used herein, a “conductive component” refers to a compound or species that can transfer or move electrical charge. Conductive and semi-conductive components include, but are not limited to, a metal, a nanoparticle, a polymer, a cream solder, a resin, and combinations thereof. In some embodiments, a conductive component is present in a concentration of about 1% to about 100%, about 1% to about 10%, about 5% to about 100%, about 25% to about 100%, about 50% to about 100%, about 75% to about 99%, about 2%, about 5%, about 90%, about 95% by weight of the patterning composition.

Metals suitable for use in a patterning composition include, but are not limited to, a transition metal, aluminum, silicon, phosphorous, gallium, germanium, indium, tin, antimony, lead, bismuth, alloys thereof, and combinations thereof.

The patterning composition can comprise a semi-conductive polymer. Semi-conductive polymers suitable for use with the present invention include, but are not limited to, a polyaniline, a poly(3,4-ethylenedioxythiophene)-poly(styrenesulfonate), a polypyrrole, an arylene vinylene polymer, a polyphenylenevinylene, a polyacetylene, a polythiophene, a polyimidazole, and combinations thereof.

The patterning composition can include an insulating component. As used herein, an “insulating component” refers to a compound or species that is resistant to the movement or transfer of electrical charge. In some embodiments, an insulating component has a dielectric constant of about 1.5 to about 8 about 1.7 to about 5, about 1.8 to about 4, about 1.9 to about 3, about 2 to about 2.7, about 2.1 to about 2.5, about 8 to about 90, about 15 to about 85, about 20 to about 80, about 25 to about 75, or about 30 to about 70. Insulating components suitable for use in the methods disclosed herein include, but are not limited to, a polymer, a metal oxide, a metal carbide, a metal nitride, monomeric precursors thereof, particles thereof, and combinations thereof. Suitable polymers include, but are not limited to, a polydimethylsiloxane, a silsesquioxane, a polyethylene, a polypropylene, a polyimide, and combinations thereof. In some embodiments, for example, an insulating component is present in a concentration of about 1% to about 95%, about 1% to about 80%, about 1% to about 50%, about 1% to about 20%, about 1% to about 10%, about 20% to about 95%, about 20% to about 90%, about 40% to about 80%, about 1%, about 5%, about 10%, about 90%, or about 95% by weight of the patterning composition.

The patterning composition can include a masking component. As used herein, a “masking component” refers to a compound or species that upon reacting forms a surface feature resistant to a species capable of reacting with the surrounding surface. Masking components suitable for use with the present invention include materials commonly employed in traditional photolithography methods as “resists” (e.g., photoresists, chemical resists, self-assembled monolayers, etc.). Masking components suitable for use in the disclosed methods include, but are not limited to, a polymer such as a polyvinylpyrollidone, poly(epichlorohydrin-co-ethyleneoxide), a polystyrene, a poly(styrene-co-butadiene), a poly(4-vinylpyridine-co-styrene), an amine terminated poly(styrene-co-butadiene), a poly(acrylonitrile-co-butadiene), a styrene-butadiene-styrene block copolymer, a styrene-ethylene-butylene block linear copolymer, a polystyrene-block-poly(ethylene-ran-butylene)-block-polystyrene, a poly(styrene-co-maleic anhydride), a polystyrene-block-poly(ethylene-ran-butylene)-block-polystyrene-graft-mal-eic anhydride, a polystyrene-block-polyisoprene-block-polystyrene, a polystyrene-block-poly(ethylene-ran-butylene)-block-polystyrene, a polynorbornene, a dicarboxy terminated poly(acrylonitrile-co-butadiene-co-acrylic acid), a dicarboxy terminated poly(acrylonitrile-co-butadiene), a polyethyleneimine, a poly(carbonate urethane), a poly(acrylonitrile-co-butadiene-co-styrene), a poly(vinylchloride), a poly(acrylic acid), a poly(methylmethacrylate), a poly(methyl methacrylate-co-methacrylic acid), a polyisoprene, a poly(1,4-butylene terephthalate), a polypropylene, a poly(vinyl alcohol), a poly(1,4-phenylene sulfide), a polylimonene, a poly(vinylalcohol-co-ethylene), a poly[N,N′-(1,3-phenylene)isophthalamide], a poly(1,4-phenylene ether-ether-sulfone), a poly(ethyleneoxide), a poly[butylene terephthalate-co-poly(alkylene glycol)terephthalate], a poly(ethylene glycol) diacrylate, a poly(4-vinylpyridine), a poly(DL-lactide), a poly(3,3′,4,4′-benzophenonetetracarboxylic dianhydride-co-4,4′-oxydianiline/1,3-phenylenediamine), an agarose, a polyvinylidene fluoride homopolymer, a styrene butadiene copolymer, a phenolic resin, a ketone resin, a 4,5-difluoro-2,2-bis(trifluoromethyl)-1,3-dioxane, a salt thereof, and combinations thereof. In some embodiments, a masking component is present in a concentration of about 1% to about 10%, about 1% to about 5%, or about 2% by weight of the patterning composition.

The patterning composition can include a conductive component and a reactive component. For example, a reactive component can promote at least one of: penetration of a conductive component into a surface, reaction between the conductive component and a surface, adhesion between a conductive feature and a surface, promoting electrical contact between a conductive feature and a surface, and combinations thereof. Surface features formed by reacting this patterning composition include conductive features selected from the group consisting of: additive non-penetrating, additive penetrating, subtractive penetrating, and conformal penetrating surface features.

The patterning composition can comprise an etchant and a conductive component, for example, suitable for producing a subtractive surface feature having a conductive feature inset therein.

The patterning composition can comprise an insulating component and a reactive component. For example, a reactive component can promote at least one of: penetration of an insulating component into a surface, reaction between the insulating component and a surface, adhesion between an insulating feature and a surface, promoting electrical contact between an insulating feature and a surface, and combinations thereof. Surface features formed by reacting this patterning composition include insulating features selected from the group consisting of: additive non-penetrating, additive penetrating, subtractive penetrating, and conformal penetrating surface features.

The patterning composition can comprise an etchant and an insulating component, for example, suitable for producing a subtractive surface feature having an insulating feature inset therein.

The patterning composition can comprise a conductive component and a masking component, for example, suitable for producing electrically conductive masking features on a surface.

Other contemplated components of a patterning composition suitable for use with the disclosed methods include thiols, 1,9-nonanedithiol solution, silane, silazanes, alkynes cystamine, N-Fmoc protected amino thiols, biomolecules, DNA, proteins, antibodies, collagen, peptides, biotin, and carbon nanotubes.

For a description of patterning compounds and patterning compositions, and their preparation and use, see Xia and Whitesides, Angew. Chem. Int. Ed., 37, 550-575 (1998) and references cited therein; Bishop et al., Curr. Opinion Colloid & Interface Sci., 1, 127-136 (1996); Calvert, J. Vac. Sci. Technol. B, 11, 2155-2163 (1993); Ulman, Chem. Rev., 96:1533 (1996) (alkanethiols on gold); Dubois et al., Annu. Rev. Phys. Chem., 43:437 (1992) (alkanethiols on gold); Ulman, An Introduction to Ultrathin Organic Films: From Langmuir-Blodgett to Self-Assembly (Academic, Boston, 1991) (alkanethiols on gold); Whitesides, Proceedings of the Robert A. Welch Foundation 39th Conference On Chemical Research Nanophase Chemistry, Houston, Tex., pages 109-121 (1995) (alkanethiols attached to gold); Mucic et al. Chem. Commun. 555-557 (1996) (describes a method of attaching 3′ thiol DNA to gold surfaces); U.S. Pat. No. 5,472,881 (binding of oligonucleotide-phosphorothiolates to gold surfaces); Burwell, Chemical Technology, 4, 370-377 (1974) and Matteucci and Caruthers, J. Am. Chem. Soc., 103, 3185-3191 (1981) (binding of oligonucleotides-alkylsiloxanes to silica and glass surfaces); Grabar et al., Anal. Chem., 67, 735-743 (binding of aminoalkylsiloxanes and for similar binding of mercaptoalkylsiloxanes); Nuzzo et al., J. Am. Chem. Soc., 109, 2358 (1987) (disulfides on gold); Allara and Nuzzo, Langmuir, 1, 45 (1985) (carboxylic acids on aluminum); Allara and Tompkins, J. Colloid Interfate Sci., 49, 410-421 (1974) (carboxylic acids on copper); Iler, The Chemistry Of Silica, Chapter 6, (Wiley 1979) (carboxylic acids on silica); Timmons and Zisman, J. Phys. Chem., 69, 984-990 (1965) (carboxylic acids on platinum); Soriaga and Hubbard, J. Am. Chem. Soc., 104, 3937 (1982) (aromatic ring compounds on platinum); Hubbard, Acc. Chem. Res., 13, 177 (1980) (sulfolanes, sulfoxides and other functionalized solvents on platinum); Hickman et al., J. Am. Chem. Soc., 111, 7271 (1989) (isonitriles on platinum); Maoz and Sagiv, Langmuir, 3, 1045 (1987) (silanes on silica); Maoz and Sagiv, Langmuir, 3, 1034 (1987) (silanes on silica); Wasserman et al., Langmuir, 5, 1074 (1989) (silanes on silica); Eltekova and Eltekov, Langmuir, 3, 951 (1987) (aromatic carboxylic acids, aldehydes, alcohols and methoxy groups on titanium dioxide and silica); and Lec et al., J. Phys. Chem., 92, 2597 (1988) (rigid phosphates on metals); Lo et al., J. Am. Chem. Soc., 118, 11295-11296 (1996) (attachment of pyrroles to superconductors); Chen et al., J. Am. Chem. Soc., 117, 6374-5 (1995) (attachment of amines and thiols to superconductors); Chen et al., Langmuir, 12, 2622-2624 (1996) (attachment of thiols to superconductors); McDevitt et al., U.S. Pat. No. 5,846,909 (attachment of amines and thiols to superconductors); Xu et al., Langmuir, 14, 6505-6511 (1998) (attachment of amines to superconductors); Mirkin et al., Adv. Mater. (Weinheim, Ger.), 9, 167-173 (1997) (attachment of amines to superconductors); Hovis et al., J. Phys. Chem. B, 102, 6873-6879 (1998) (attachment of olefins and dienes to silicon); Hovis et al., Surf. Sci., 402-404, 1-7 (1998) (attachment of olefins and dienes to silicon); Hovis et al., J. Phys. Chem. B, 101, 9581-9585 (1997) (attachment of olefins and dienes to silicon); Hamers et al., J. Phys. Chem. B, 101, 1489-1492 (1997) (attachment of olefins and dienes to silicon); Hamers et al., U.S. Pat. No. 5,908,692 (attachment of olefins and dienes to silicon); Ellison et al., J. Phys. Chem. B, 103, 6243-6251 (1999) (attachment of isothiocyanates to silicon); Ellison et al., J. Phys. Chem. B, 102, 8510-8518 (1998) (attachment of azoalkanes to silicon); Ohno et al., Mol. Cryst. Liq. Cryst. Sci. Technol., Sect. A, 295, 487-490 (1997) (attachment of thiols to GaAs); Reuter et al., Mater. Res. Soc. Symp. Proc., 380, 119-24 (1995) (attachment of thiols to GaAs); Bain, Adv. Mater. (Weinheim, Fed. Repub. Ger.), 4, 591-4 (1992) (attachment of thiols to GaAs); Sheen et al., J. Am. Chem. Soc., 114, 1514-15 (1992) (attachment of thiols to GaAs); Nakagawa et al., Jpn. J. Appl. Phys., Part 1, 30, 3759-62 (1991) (attachment of thiols to GaAs); Lunt et al., J. Appl. Phys., 70, 7449-67 (1991) (attachment of thiols to GaAs); Lunt et al., J. Vac. Sci. Technol., B, 9, 2333-6 (1991) (attachment of thiols to GaAs); Yamamoto et al., Langmuir ACS ASAP, web release number Ia990467r (attachment of thiols to InP); Gu et al., J. Phys. Chem. B, 102, 9015-9028 (1998) (attachment of thiols to InP); Menzel et al., Adv. Mater. (Weinheim, Ger.), 11, 131-134 (1999) (attachment of disulfides to gold); Yonezawa et al., Chem. Mater., 11, 33-35 (1999) (attachment of disulfides to gold); Porter et al., Langmuir, 14, 7378-7386 (1998) (attachment of disulfides to gold); Son et al., J. Phys. Chem., 98, 8488-93 (1994) (attachment of nitriles to gold and silver); Steiner et al., Langmuir, 8, 2771-7 (1992) (attachment of nitriles to gold and copper); Solomun et al., J. Phys. Chem., 95, 10041-9 (1991) (attachment of nitriles to gold); Solomun et al., Ber. Bunsen-Ges. Phys. Chem., 95, 95-8 (1991) (attachment of nitriles to gold); Henderson et al., Inorg. Chim. Acta, 242, 115-24 (1996) (attachment of isonitriles to gold); Huc et al., J. Phys. Chem. B, 103, 10489-10495 (1999) (attachment of isonitriles to gold); Hickman et al., Langmuir, 8, 357-9 (1992) (attachment of isonitriles to platinum); Steiner et al., Langmuir, 8, 90-4 (1992) (attachment of amines and phospines to gold and attachment of amines to copper); Mayya et al., J. Phys. Chem. B, 101, 9790-9793 (1997) (attachment of amines to gold and silver); Chen et al., Langmuir, 15, 1075-1082 (1999) (attachment of carboxylates to gold); Tao, J. Am. Chem. Soc., 115, 4350-4358 (1993) (attachment of carboxylates to copper and silver); Laibinis et al., J. Am. Chem. Soc., 114, 1990-5 (1992) (attachment of thiols to silver and copper); Laibinis et al., Langmuir, 7, 3167-73 (1991) (attachment of thiols to silver); Fenter et al., Langmuir, 7, 2013-16 (1991) (attachment of thiols to silver); Chang et al., Am. Chem. Soc., 116, 6792-805 (1994) (attachment of thiols to silver); Li et al., J. Phys. Chem., 98, 11751-5 (1994) (attachment of thiols to silver); Li et al., Report, 24 pp (1994) (attachment of thiols to silver); Tarlov et al., U.S. Pat. No. 5,942,397 (attachment of thiols to silver and copper); Waldeck, et al., PCT application WO/99/48682 (attachment of thiols to silver and copper); Gui et al., Langmuir, 7, 955-63 (1991) (attachment of thiols to silver); Walczak et al., J. Am. Chem. Soc., 113, 2370-8 (1991) (attachment of thiols to silver); Sangiorgi et al., Gazz. Chim. Ital., 111, 99-102 (1981) (attachment of amines to copper); Magallon et al., Book of Abstracts, 215th ACS National Meeting, Dallas, Mar. 29-Apr. 2, 1998, COLL-048 (attachment of amines to copper); Patil et al., Langmuir, 14, 2707-2711 (1998) (attachment of amines to silver); Sastry et al., J. Phys. Chem. B, 101, 4954-4958 (1997) (attachment of amines to silver); Bansal et al., J. Phys. Chem. B. 102, 4058-4060 (1998) (attachment of alkyl lithium to silicon); Bansal et al., J. Phys. Chem. B, 102, 1067-1070 (1998) (attachment of alkyl lithium to silicon); Chidsey, Book of Abstracts, 214th ACS National Meeting, Las Vegas, Nev., Sep. 7-11, 1997, I&EC-027 (attachment of alkyl lithium to silicon); Song, J. H., Thesis, University of California at San Diego (1998) (attachment of alkyl lithium to silicon dioxide); Meyer et al., J. Am. Chem. Soc., 110, 4914-18 (1988) (attachment of amines to semiconductors); Brazdil et al. J. Phys. Chem., 85, 1005-14 (1981) (attachment of amines to semiconductors); James et al., Langmuir, 14, 741-744 (1998) (attachment of proteins and peptides to glass); Bernard et al., Langmuir, 14, 2225-2229 (1998) (attachment of proteins to glass, polystyrene, gold, silver and silicon wafers); Pereira et al., J. Mater. Chem., 10, 259 (2000) (attachment of silazanes to SiO₂); Pereira et al., J. Mater. Chem., 10, 259 (2000) (attachment of silazanes to SiO₂); Dammel, Diazonaphthoquinone Based Resists (1st ed., SPIE Optical Engineering Press, Bellingham, Wash., 1993) (attachment of silazanes to SiO₂); Anwander et al., J. Phys. Chem. B, 104, 3532 (2000) (attachment of silazanes to SiO₂); Slavov et al., J. Phys. Chem., 104, 983 (2000) (attachment of silazanes to SiO₂).

### Substrates to be Patterned

Any suitable substrates can be patterned, depending on the patterning methods used. For example, for beam pen lithography any photosensitive substrate or substrate layer can be patterned. For electrochemical deposition and suitable electro-sensitive substrate or substrate layer can be used. For thermal deposition, a thermal sensitive substrate can be used or a thermal sensitive ink composition can be deposited on any substrate.

Substrates can include, but are not limited to, metals, alloys, composites, crystalline materials, amorphous materials, conductors, semiconductors, optics, fibers, inorganic materials, glasses, ceramics (e.g., metal oxides, metal nitrides, metal silicides, and combinations thereof), zeolites, polymers, plastics, organic materials, minerals, biomaterials, living tissue, bone, films thereof, thin films thereof, laminates thereof, foils thereof, composites thereof, and combinations thereof. A substrate can comprise a semiconductor such as, but not limited to: crystalline silicon, polycrystalline silicon, amorphous silicon, p-doped silicon, n-doped silicon, silicon oxide, silicon germanium, germanium, gallium arsenide, gallium arsenide phosphide, indium tin oxide, and combinations thereof. A substrate can comprise a glass such as, but not limited to, undoped silica glass (SiO₂), fluorinated silica glass, borosilicate glass, borophosphorosilicate glass, organosilicate glass, porous organosilicate glass, and combinations thereof. The substrate can be a non-planar substrate, such as pyrolytic carbon, reinforced carbon-carbon composite, a carbon phenolic resin, and the like, and combinations thereof. A substrate can comprise a ceramic such as, but not limited to, silicon carbide, hydrogenated silicon carbide, silicon nitride, silicon carbonitride, silicon oxynitride, silicon oxycarbide, high-temperature reusable surface insulation, fibrous refractory composite insulation tiles, toughened unipiece fibrous insulation, low-temperature reusable surface insulation, advanced reusable surface insulation, and combinations thereof. A substrate can comprise a flexible material, such as, but not limited to: a plastic, a metal, a composite thereof, a laminate thereof, a thin film thereof, a foil thereof, and combinations thereof.

The substrate can comprise a compressible material. The compressible material can be layered on top of a substrate as described herein. Examples of compressible materials include, but are not limited to, polymers, metals (e.g., soft metals), foils, films, or the like. Non-limiting examples of a compressible layer include polymethylmethacrylate (PMMA), polydimethylsiloxane (PDMS), nitrocellulose, and combinations thereof.

The substrate can comprise a material that can be desorbed upon application of electrical energy. Non-limiting examples of such a material include 16-mercaptohexadecanoic acid (MHA) and octadecanethiol (ODT), alkane thiols, and phosphonic acids.

### Wear Resistance

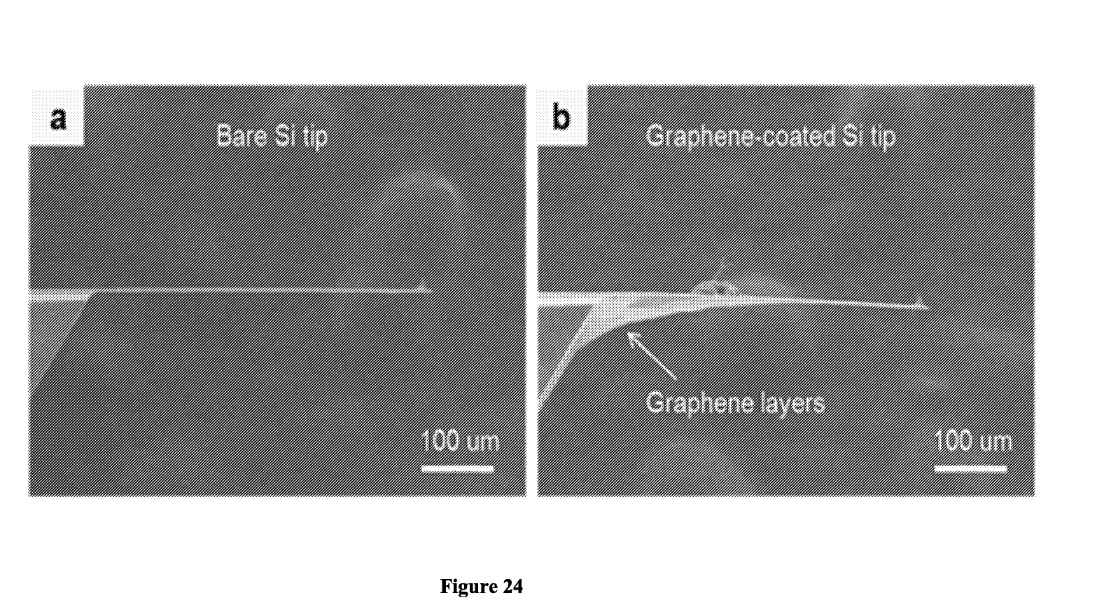

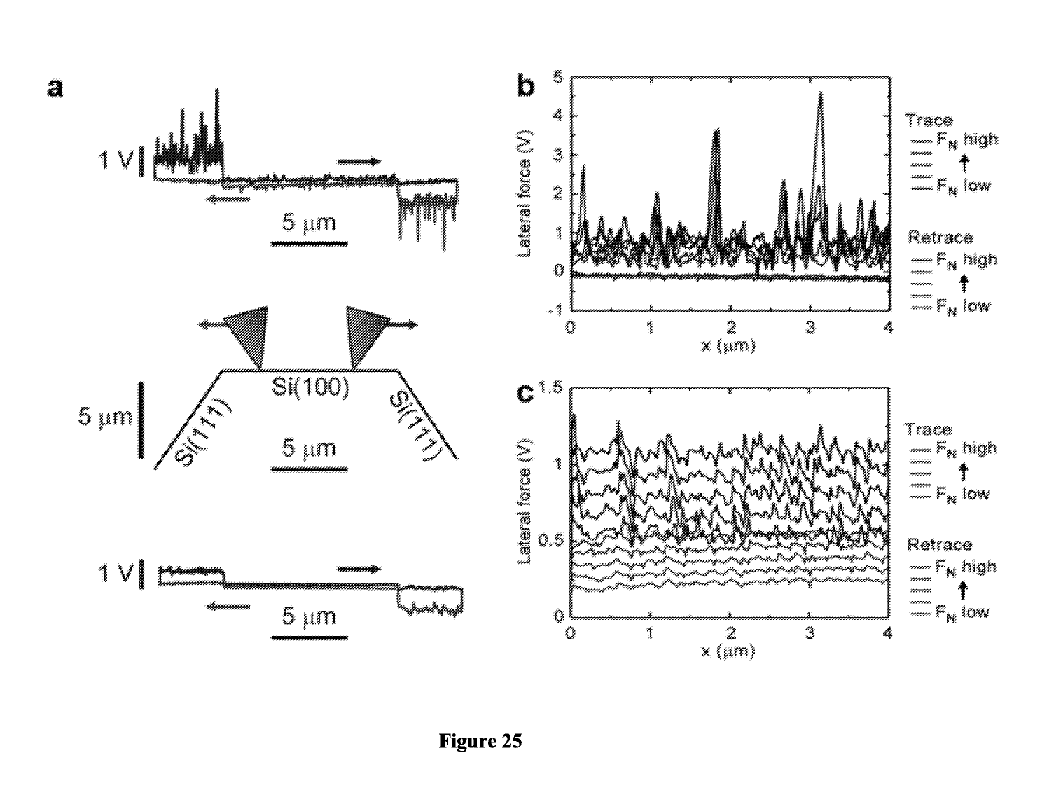

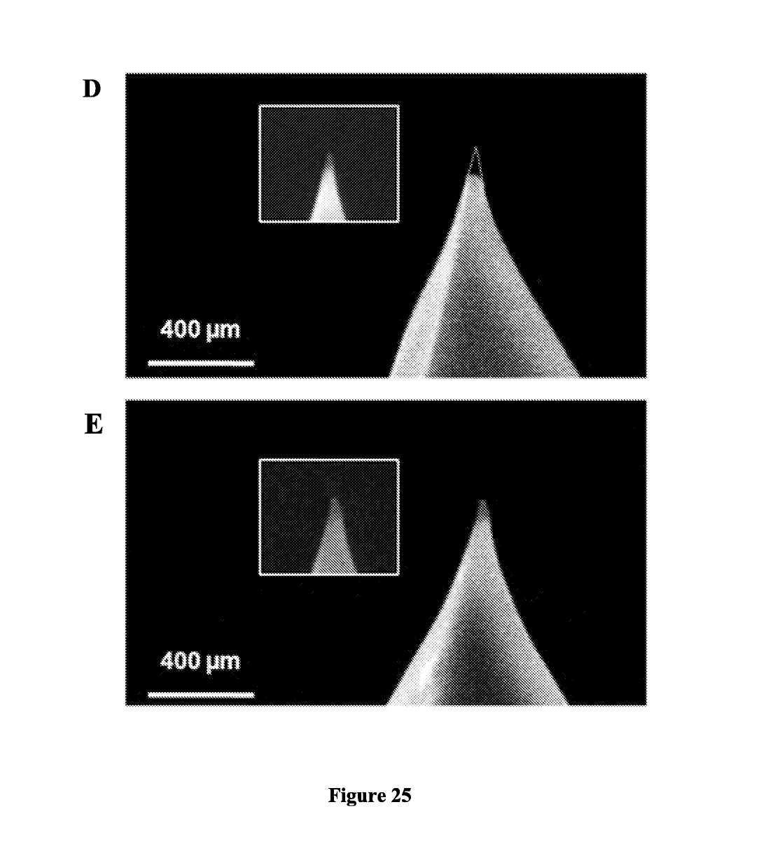

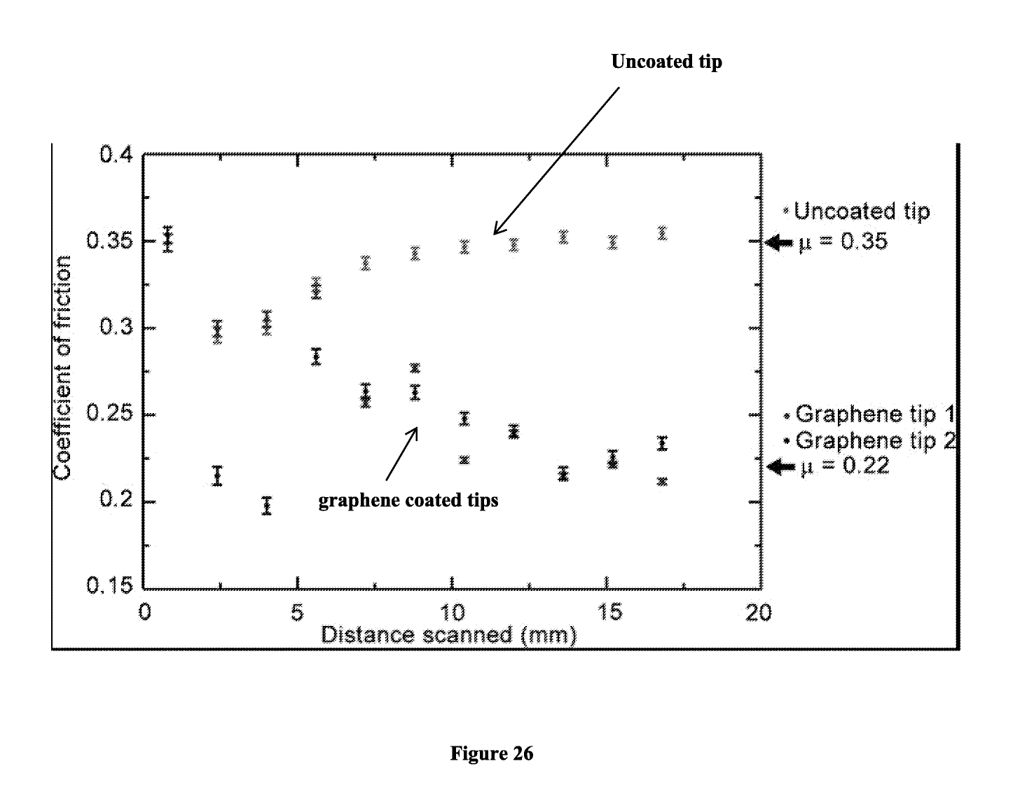

To test the improved wear resistance imparted to a micro probe by the graphene film coating, the tip-sample friction was quantitatively measured using friction force microscopy (FFM). Since a cantilever is needed to quantitatively evaluate tip-sample friction, conventional contact mode atomic force probes (PPP-CONT—Nanoworld AG) were coated with graphene using the same protocol implemented for preparing the graphene-coated HSL tip arrays (FIG. 24). The coefficient of friction between the tip and the surface was estimated using a wedge calibration technique. Graphene-coated and uncoated probes were scanned across the flat surface of a Si(100) wafer and angled Si(111) planes that were exposed by anisotropic etching (topography—FIG. 25a). Measurement on surfaces with different, but known, angles is necessary to remove the influence of imperfect alignment of the tip. Therefore, the lateral force on both probes was measured in three distinct topographical regions (FIG. 25a). A qualitative difference between the probes is immediately apparent as many peaks corresponding to stick-slip events are visible in the lateral force data for the uncoated probe while the lateral force measured with the graphene-coated probe displays no stick-slip events and is markedly smoother (compare top and bottom scans in FIG. 25a). This measurement was repeated for a series of normal forces ranging from 100 to 300 nN (FIGS. 25b and 25c). By examining how the offset and width of each friction loop changes with applied load, the coefficient of friction was determined for an uncoated probe on the Si(111) face to be 0.35, in agreement with previous reports. In contrast, the two measured graphene-coated probes exhibited coefficients of friction of 0.22 and 0.23, showing an approximately 35% reduction from the uncoated probe (FIG. 26). It is worth emphasizing that these measurements depend highly on dynamic conditions such as relative humidity, tip wear, and the condition of the surface. In addition, the measured coefficients of friction in all experiments required scanning a distance of 10 mm to stabilize, which we attribute to changing conditions on the tip and surface.

To supplement the aforementioned measurements of tip-sample friction, and also directly visualize tip-wear, a less destructive systematic measurement of friction was performed in conjunction with SEM analysis of tip wear. To create a baseline for wear studies, SEM imaging of six uncoated and four graphene-coated probes was performed (FIGS. 25d and 25e). The probes were then calibrated by measuring force-distance curves followed by thermal tuning to determine the spring constant and deflection sensitivities. They were then scanned in contact mode on a smooth Si(100) surface over a distance of 500 μm at 1 μm/s with 50 nN of applied force. The lateral deflection d of each AFM probe per unit normal force (the sum of adhesion force and applied normal force) was used to estimate the friction experienced by each probe. A 40% reduction in lateral deflection for graphene coated probes (d=0.91±0.05 mV/nN) was observed, as compared with uncoated ones (d=1.5±0.2 mV/nN). This result is consistent with the wedge calibration results presented above. Following scanning, the probes were imaged again in the SEM. The graphene coated tip exhibited barely any wear while the uncoated probe was blunted considerably (FIGS. 25d and 25e). Therefore, these results suggest that the reduction in tip-sample friction from graphene coating could improve the wear performance of atomic force microscope probes.

### EXAMPLES

Graphene transfer onto a HSL tip array. 10-20 layer graphene grown on Ni/Si surfaces (Graphene Laboratories Inc.) was used for all experiments. The as-grown graphene film on a 4-inch Ni/Si wafer was spin-coated with PMMA polymer (MicroChem Corp., 495 A2) at 500 r.p.m. for 10 s with a ramping speed of 100 r.p.m./s followed by 5,000 r.p.m., 60 s with a ramping speed of 1000 r.p.m./s). The sample was allowed to harden at room-temperature for 24 hours. The PMMA thickness measured by AFM was about 70 nm. The wafer was then cut into 1 cm×1 cm pieces and immersed into an aqueous iron chloride solution (Sigma-Aldrich; Reagent Grade, 97%, catalog no. 157740, CAS no. 0007705-08-0) at a concentration of 1 M (50 g of FeCl₃ and 308 ml of DI water) for 24 hours at room temperature. The separated PMMA/Graphene layer was rinsed with DI water, and then transferred onto a HSL tip array that had been oxygen-plasma treated for 2 min at about 100 mTorr with 30 W. The transfer process took place by submerging the HSL tip array in an ethanol/water mixture (2:1) and resting it at a tilt of about 40° with respect to the liquid surface. The fluid was then allowed to evaporate over the course of about 48 hrs. Tilting the array during this process helped to coat the array in a row-by-row fashion, and thus significantly enhanced the coverage of graphene on the tip array. Finally, the graphene-coated HSL array was soaked in acetone for 2 hours and then rinsed in ethanol to remove the PMMA.

Electrically conductive HSL for pattering. SAMs of MHA were prepared on electron-beam evaporated Au thin films (25 nm Au on 5 nm Ti) by immersing the substrate in a solution of 1 mM MHA in ethanol (0.12 g of MHA and 40 mL of ethanol) for 1 h, followed by rinsing with ethanol, rinsing with de-ionized water, and drying with nitrogen. A graphene-coated HSL tip array was mounted in a XE-150 scanning probe platform (Park Systems) and attached to a source meter (Keithley, 2400-C Source Meter) to provide a voltage bias. The graphene-coated HSL array was held at a bias voltage between −5 V and −20 V while the surface was grounded. To perform lithography, the tip array was brought into contact with the MHA SAM in a series of points to selectively desorb portions of the MHA SAM surface under ambient conditions (about 30% humidity, 23° C.). To make the patterned features easier to visualize, gold wet etching was performed to remove the gold no longer protected by the MHA SAM. The resulting recessed features were characterized with optical microscopy (Zeiss) and SEM (Hitachi S4800). (FIG. 18)

Thermally conductive HSL for pattering. To generate patterns with thermal-DPN, photoresist (Shipley 1805) was drop-coated onto a graphene-coated HSL tip array. The photoresist was allowed to dry at room-temperature for 30 min. The graphene-coated HSL tip array wass electrically contacted by silver paste on opposing sides of the array and connected to a voltage supply (BK PRECISION Corp., Triple Output DC Power Supply). The actual voltage (FLUKE, 179 True RMS Multimeter) and current (Agilent, 34401A 6½ Digit Multimeter) were monitored to calculate the resistance of the graphene during heating. By applying a voltage across the graphene, the resistance was observed to decrease as local resistive heating occured. Typically, an applied power of 23 mW was used for a 1×1 cm² tip array. Photoresist was thermally transferred to a PVD-grown SiO₂ (15 nm)/Si surface (about 30% humidity, 23° C.). The patterned sample was etched in ammonium fluoride (20% NH₄F, Time Etch, Transene) to transfer the photoresist patterns onto SiO₂. The resulting features were characterized with optical microscopy (Zeiss), SEM (Hitachi S4800), and AFM (Bruker Dimension Icon). (FIG. 21)

Friction Force Microscopy. Quantitative friction force microscopy was performed in a Bruker Dimension Icon atomic force microscope. Both uncoated and graphene-coated probes (PPP-CONT—Nanoworld AG) were mounted in the probe holder with special care to keep the cantilever parallel to the probe holder. Next, the deflection sensitivity (200 nm/V typical) of the probes was found by taking three force-distance curves and finding the average slope of the approach line. These force-distance curves were also used to calculate the average tip-sample adhesion force. Next, the spring constant (0.3 N/m typical) was found through thermal calibration. The probes were then scanned across the flat surface of a Si(100) wafer with square pyramidal holes prepared by KOH etching to produce Si(111) faces at a known angle. Scan regions were 20×1 μm² at a resolution of 2048×8 pixels and scanned at 4 μm/s. Proportional gain was set to 0 with integral gain of 5 to remove the possibility of under damped feedback reducing the tip-sample friction. This region was rescanned while sweeping the applied force from about 100 to about 300 nN. The change of the width and offset of each friction loop with respect to applied force was used to extract the coefficient of friction following Varenberg et al. 2003. The process of varying the applied force was repeated ten times for each probe to examine change in the tip-sample friction as the probe continued to scan the surface. Experiments were performed at room temperature (22° C.) in low ambient humidity (RH about 33%).

The foregoing describes and exemplifies the invention but is not intended to limit the invention defined by the claims which follow. All of the methods disclosed and claimed herein can be made and executed without undue experimentation in light of the present disclosure. In particular, while methods of patterning and making the coated micro probes are exemplified herein with reference to hard spring lithography tip arrays, it should be understood that such methods are application to any suitable micro probe having a tip, such as those described herein. While materials and methods of this invention have been described in terms of specific embodiments, it will be apparent to those of skill in the art that variations may be applied to the materials and/or methods and in the steps or in the sequence of steps of the methods described herein without departing from the concept, spirit, and scope of the invention. More specifically, it will be apparent that certain agents which are both chemically and physiologically related may be substituted for the agents described herein while the same or similar results would be achieved.

All patents, publications and references cited herein are hereby fully incorporated by reference. In case of conflict between the present disclosure and incorporated patents, publications, and references, the present disclosure should control.

### REFERENCES

1. Piner, R. D., Zhu, J., Xu, F., Hong, S. H., & Mirkin, C. A. “Dip-Pen” nanolithography. Science 283, 661-663 (1999).
2. Salaita, K., Wang, Y. & Mirkin, C. A. Applications of dip-pen nanolithography. Nat. Nanotech. 2, 145-155 (2007).
3. Braunschweig, A. B., Huo, F., & Mirkin, C. A. Molecular printing. Nat. Chem. 1, 353-358 (2009).
4. Snow, E. S. & Campbell, P. M. Fabrication of Si nanostructures with an atomic force microscope. Appl. Phys. Lett. 64, 1932-1934 (1994).
5. Snow, E. S. & Campbell, P. M. AFM fabrication of sub-10-nanometer metal-oxide devices with in situ control of electrical properties. Science 270, 1639-1641 (1995).
6. Kim, Y. & Lieber, C. M. Machining oxide thin films with an atomic force microscope: pattern and object formation on the nanometer scale. Science 257, 375-377 (1992).
7. Xu, S. Laibinis, P. E., & Liu, G.-y. Fabrication of Nanometer Scale Patterns within Self-Assembled Monolayers by Nanografting. Langmuir 15, 7244-7251 (1999).
8. Bhaskaran, H. et al. Ultralow nanoscale wear through atom-by-atom attrition in silicon-containing diamond-like carbon. Nat. Nanotech. 5, 181-185 (2010).
9. Mamin, H. J. & Rugar, D. Thermomechanical writing with an atomic force microscope tip. Appl. Phys. Lett. 61, 1003-1005 (1992).
10. Pires, D. et al. Nanoscale three-dimensional patterning of molecular resists by scanning probes. Science 328, 732-735 (2010).
11. Salaita, K. et al. Massively parallel dip-pen nanolithography with 55000-pen two-dimensional arrays. Angew. Chem. Int. Ed. 45, 7220-7223 (2006).
12. Vettiger, P. et al. The ‘Millipede’—more than one thousand tips for future AFM data storage. IBM J. Res. Dev. 44, 323-340 (2000).
13. Huo, F., Zheng, Z., Zheng, G., Giam, L. R., Zhang, H. & Mirkin, C. A. Polymer pen lithography. Science 321, 1658-1660 (2008).
14. Giam, L. R., Massich, M. D., Hao, L., Wong, L., Mader, C. C. & Mirkin, C. A. Scanning probe-enabled nanocombinatorics define the relationship between fibronectin feature size and stem cell fate. Proc. Natl. Acad. Sci. USA 109, 4377-4382 (2012).
15. Shim, W., Braunschweig, A. B., Liao, X., Chai, J., Lim, J., Zheng, G. & Mirkin, C. A. Hard-tip, soft-spring lithography. Nature 469, 516-520 (2011).
16. Liu, J. et al. Preventing nanoscale wear of atomic force microscopy tips through the use of monolithic ultrananocrystalline diamond probes. Small 6, 1140-1149 (2010).
17. Vasko, S. E. et al. Serial and parallel Si, Ge, and SiGe direct-write with scanning probes and conducting stamps. Nano. Lett. 11, 2386-2389 (2011).
18. Geim, A. K. Graphene: status and prospect. Science 324, 1530-1534 (2009).
19. Wen, Y. et al. Multilayer graphene-coated atomic force microscopy tips for molecular junctions. Adv. Mater. DOI: 10.1002/adma.201200579 (2012).
20. Koenig, S. P., Boddeti, N. G., Dunn, M. L. & Bunch, J. S. Ultrastrong adhesion of graphene membranes. Nat. Nanotech. 6, 543-546 (2011).
21. Shih, C. et al. Bi- and trilayer graphene solutions. Nat. Nanotech. 6, 439-445 (2011).
22. Kim, K. et al. Large-scale pattern growth of graphene films for stretchable transparent electrodes. Nature 457, 706-710 (2009).
23. Jang, J., Maspoch, D., Fujigaya, T. & Mirkin, C. A. A “Molecular Eraser” for dip-pen nanolithography. Small 3, 600-605 (2007).
24. Zhang, Y., Salaita, K., Lim, J., Lee, K., & Mirkin, C. A. A massively parallel electrochemical approach to the miniaturization of organic micro- and nanostructures on surfaces. Langmuir 20, 962-968 (2004).
25. Morton, S. L., Degertekin, F. L. & Khuri-Yakub, B. T. In situ ultrasonic measurement of photoresist glass transition temperature. Appl. Phys. Lett. 72, 2457-2459 (1998).
26. Shao, Q., Liu, G., Teweldebrhan, D. & Balandin, A. A. High-temperature quenching of electrical resistance in graphene interconnects. Appl. Phys. Lett. 92, 202108 (1992).
27. Filleter, T. et al. Friction and dissipation in epitaxial graphene films, Phys. Rev. Lett. 102, 086102 (2009).
28. Varenberg, M., Etsion, I., & Halperin, G. An improved wedge calibration method for lateral force in atomic force microscopy. Rev. Adv. Mater. Sci. 74, 3362-3367 (2003).
29. Schwarz, U. Quantitative analysis of lateral force microscopy experiments. Rev. Sci. Instrum. 67, 2560-2567 (1996).
30. Bhushan, B. & Sundararajan, S. Micro/nanoscale friction and wear mechanisms of thin films using atomic force and friction force microscopy. Acta Materialia. 46, 3793-3804 (1998).
31. Kim, R. et al. Stretchable, transparent graphene interconnects for arrays of microscale inorganic light emitting diodes on rubber substrates. Nano. Lett. 11, 3881-3886 (2011).
32. Koenig, S. P., Boddeti, N. G., Dunn, M. L. & Bunch, J. S. Ultrastrong adhesion of graphene membranes. Nature Nanotech. 6, 543-546 (2011).
33. Kopesky, E. T. et al. Toughened poly(methyl methacrylate) nanocomposites by incorporating polyhedral oligomeric silsesquioxanes. Polymer 47, 299-309 (2006).
34. Kim, K. et al. Large-scale pattern growth of graphene films for stretchable transparent electrodes. Nature 457, 706-710 (2009).

1. A coated micro tip, comprising:
a micro tip having a base and an oppositely disposed tip end having a radius of curvature of less than about 1 μm; and
a graphene film coated on the tip.

2. (canceled)

3. A micro probe, comprising:
the micro tip of claim 1 disposed on a micro cantilever arm.

4. A tip array micro probe comprising:
a tip substrate layer comprising a first surface and an oppositely disposed second surface, the tip substrate layer comprising an elastomer;
a plurality of tips according to claim 1 fixed to the first surface, the tips each comprising a tip end disposed opposite the first surface; and
wherein the graphene film is further coated on the first surface.

5. The micro probe of claim 4, wherein the plurality of tips comprise an elastomer.

6. (canceled)

7. The tip or micro probe of claim 4, wherein the one or more tips and/or the tip substrate layer are at least translucent.

8. (canceled)

9. The micro probe of claim 4, further comprising a radiation blocking layer comprising a radiation opaque material coated on the plurality of tips and the first surface and a plurality of apertures defined in the blocking layer exposing the tip ends of the tips, the graphene film being coated on the blocking layer.

10. The micro probe of claim 4, further comprising a radiation blocking layer comprising a radiation opaque material coated on the graphene film and a plurality of apertures defined in the blocking layer exposing a portion of the graphene film disposed at the tip ends of the tips.

11. (canceled)

12. (canceled)

13. (canceled)

14. The tip of claim 1, wherein the graphene film comprises 1 to 500 layers of graphene.

15. The tip of claim 1, wherein the graphene film has a thickness in a range of about 1 nm to about 500 nm.

16. The tip of claim 1, wherein the graphene film conformally coats the at least one tip or plurality of tips.

17. A method of electrochemically patterning using at least one tip in accordance with claim 1, comprising:
applying a voltage across the graphene coating on the at least one tip; and
contacting an electrochemically sensitive substrate with the at least one tip to electrochemically desorb the contacted portion of the electrochemically sensitive substrate.

18. The method of claim 17, wherein the electrochemically sensitive substrate comprises an alkanethiolate self-assembled monolayer disposed on a gold substrate, and the method comprises contacting the micro probe to the alkanethiolate self-assembled monolayer, thereby removing the contacted portion of the alkanethiolate self-assembled monolayer, and optionally etching the gold substrate to remove portions of the gold substrate in which the alkanethiolate self-assembled monolayer was removed.

19. (canceled)

20. A method of thermal patterning using at least one tip in accordance with claim 1, comprising:
applying an electrical current across the graphene coating on the at least one tip to resistively heat at least one tip and thereby heat an ink disposed on the at least one tip; and
contacting a substrate with the heated tip to apply the ink to the substrate.

21. (canceled)

22. (canceled)

23. A method of making one or more graphene coated micro tips, each tip having a base and an oppositely disposed tip end having a radius of curvature of less than about 1 μm, the method comprising:
immersing one or more tips in a fluid comprising a graphene film floating on a surface of the fluid over the one or more tips;
disposing the immersed tips at an angle of at least 10° relative to the graphene film floating on the surface of the fluid as measured from a plane parallel to the base of the tip; and
coating the one or more tips with the graphene film by gradually bringing the graphene film into contact with the one or more tips while maintaining the relative angle between the floating portion of the film and the one or more tips during coating.

24. The method of claim 23, comprising evaporating the fluid to gradually lower the graphene film onto the one or more tips.

25. The method of claim 23, comprising raising the one or more tips through the fluid and into contact with the graphene film to thereby coat the one or more tips with the graphene film.

26. The method of claim 23, wherein the graphene film comprises a graphene film layer coated on a polymethylmethacrylate (PMMA) layer.

27. The method of claim 26, further comprising removing the PMMA layer from the one or more coated tips.

28. (canceled)

29. The method of claim 23, wherein the relative angle between tip or tips and floating graphene film is in a range of about 10° to 50°.

30. (canceled)

31. The method of claim 23, wherein the coating fluid comprises a mixture of water and a surfactant or a mixture of water and ethanol.

32. (canceled)

33. (canceled)

34. (canceled)

35. The method of claim 23, further comprising, before coating the one or more tips with the graphene film, coating a blocking layer on the one or more tips and forming an aperture in the blocking layer at the tip ends of the tips by removing a portion of the blocking layer to expose the tip ends, wherein coating the one or more tips with the graphene film comprises coating the blocking layer and exposed tip ends with the graphene film.

36. The method of claim 23, further comprising, after coating the one or more tips with the graphene film, coating a blocking layer on the graphene film and forming an aperture in the blocking layer at the tip ends of the tips by removing a portion of the blocking layer.

37. (canceled)

38. The method of claim 23, wherein the one or more tips are disposed on a micro cantilever or a tip substrate layer, and coating the one or more tips with the graphene film further comprises coating the one or more tips and a portion of the micro cantilever or the tip substrate layer adjacent the one or more tips.

39. The method of claim 23, further comprising forming an electrical contact on the micro probe using the graphene film.
